(19) United States
(12) Patent Application Publication
(10) Pub. No.: US 2009/0254392 A1
(43) Pub. Date: Oct. 8, 2009

(54) METHOD AND SYSTEM FOR ENTERPRISE NETWORK ACCESS CONTROL AND MANAGEMENT FOR GOVERNMENT AND CORPORATE ENTITIES

(76) Inventor: Van S. Zander, Chesapeake, VA (US)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/295,045

(22) PCT Filed: Mar. 29, 2007
(86) PCT No.: PCT/US07/07811

§ 371 Date: Oct. 11, 2008

Related U.S. Application Data
(60) Provisional application No. 60/787,155, filed on Mar. 30, 2006.

(51) Int. Cl. G06Q 10/00; G06Q 50/00

(52) U.S. Cl. 705/7

(57) ABSTRACT

A method, system, computer program product, and devices for enterprise network access control and management for Government and Corporate entities, including interagency identity management; connectors and controls; an interagency directory services transformation service; a user/duty position resolving service; role-based encryption key management; role-based business process modeling; and proximity-based access control enabled by user-role-track association.

### CROSS REFERENCE TO RELATED DOCUMENTS

The present invention claims benefit of priority to U.S. Provisional Patent Application Ser. No. 60/787,155 to Van ZANDER, entitled “Method and System for Enterprise Network Access Control and Management for Government and Corporate Entities,” filed Mar. 30, 2006, the entire disclosure of which is hereby incorporated by reference herein.

### BACKGROUND OF THE INVENTION

1. Field of the Invention

The present invention generally relates to enterprise identity management processing, and more particularly to a method and system for enterprise network access control and management for Government and Corporate entities.

2. Discussion of the Background

There is a need for enterprise based configuration management and Identity Management that will effectively link city, state, federal, and other organizations. This ‘federation’ is possible using many approaches, but the problem is that these organizations may choose to participate in the federated enterprise at various degrees. That is, some may be very involved, while others have only minimal involvement. Most of these organizations also have chosen closed networks as a manner of providing an additional layer of security. This further compounds the problem that exists in forming federations. With closed networks and varying participation, it is difficult to quickly establish semi-permeable security relationships during routine and emergency situations.

### SUMMARY OF THE INVENTION

Therefore, there is a need for a method and system that addresses the above and other problems. The above and other problems are addressed by the exemplary embodiments of the present invention, which provide a relational database with a web-based user interface as the access and internal database controls (e.g., provided by Open Database Connectivity (ODBC)) for maintenance. The Joint Subscription Proxy Agent/Services & Alerts Manager (J-SPASAM) engine uniquely solves the problem of rapidly changing architectures by maintaining four complex registries (e.g., users, hardware, organizations, and network resources) and their associated access control policy. The unique approach to maintaining these data relationships and the data content itself is provided by a scalable database architecture and supporting code to allow a user-friendly access control environment. This daunting task of managing the access control of a scalable enterprise is achieved by the providing controls to the Information Management Officer. This delegative approach uniquely solves the previous problem of managing large and changing enterprise architectures. Information Management Officers have the responsibility of providing the right information to the right person at the right time. The exemplary embodiments of the present invention provide these individuals (e.g., operating with the aid of the exemplary embodiments as a collective) with the controls and information about the physical architecture they need to accomplish this task.

Accordingly, in exemplary aspects of the present invention there is provided a method, system, computer program product, and devices for enterprise network access control and management for Government and Corporate entities, the system comprising at least one of means for interagency identity management, including least one of means for providing attributes definition, including least one of means for providing occupation parameters, means for providing translation between agencies, including least one of Army, Navy, USAF, USCG, and Department of Labor agencies, means for providing duty positions including least one of standard duty title code translation for allowing duty titles to be codified and/or translated, and means for providing nationality, seniority, location, and associations, including least one of department, agency, unit, and billet parameters, means for providing policy enforcement of IIME attributes, including on the fly policy enforcement, means for providing a resource map, including recognition of relations and flexibly managing the relations on an enterprise scale; means for providing connectors and controls, including least one of means for providing interagency management control, including least one of batches means, corporate history recorder means, and corporate learning means, means for providing a track injector, including from military location providers association of tracks with units versus “Tillman”, a subscription by proxy means, a publish by proxy means, and an enterprise configuration by proxy means; means for providing an interagency directory services transformation service; means for providing a user/duty position resolving service; means for providing role-based encryption key management; means for providing role-based business process modeling; and means for providing proximity-based access control enabled by a user-role-track association.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary diagram of building blocks for trust, according to exemplary embodiments of the present invention;

FIG. 2 illustrates an exemplary diagram of integration of information domains, according to exemplary embodiments of the present invention;

FIG. 3 illustrates an exemplary diagram of the Essence of Enterprise Access Control, according to exemplary embodiments of the present invention;

FIG. 4 illustrates an exemplary diagram of the types of users and the guard function, according to exemplary embodiments of the present invention;

FIG. 5 illustrates an exemplary diagram of the active directory assertions, according to exemplary embodiments of the present invention;

FIG. 6 illustrates an exemplary diagram of the flexible policy coding of operational, technical, and strategic characterizations of a billet, according to exemplary embodiments of the present invention;

FIG. 7 illustrates an exemplary diagram of the Military Occupational Specialty characterization of a billet, according to exemplary embodiments of the present invention;

FIG. 8 illustrates an exemplary diagram of the three-letter standard duty title codes, according to exemplary embodiments of the present invention;

FIG. 9 illustrates an exemplary diagram of the security patterns and data elements (e.g., pages) included on the exemplary engine, according to exemplary embodiments of the invention;

FIG. 10 illustrates an exemplary diagram of the types of authentication and the methods of providing it, according to exemplary embodiments of the present invention;

FIG. 11 illustrates an exemplary diagram of tool classifications, according to exemplary embodiments of the present invention;

FIG. 12 illustrates an exemplary diagram of the rules governing the use and the types of Communities of Interest, according to exemplary embodiments of the present invention;

FIG. 13 illustrates an exemplary diagram of the enterprise functions, according to exemplary embodiments of the present invention;

FIG. 14 illustrates an exemplary diagram of the exemplary engine and engine function, according to exemplary embodiments of the present invention;

FIG. 15 illustrates an exemplary diagram of how the exemplary engine uses join tables and subscriptions, according to exemplary embodiments of the present invention;

FIG. 16 illustrates an exemplary diagram of the population of the network, according to exemplary embodiments of the present invention;

FIG. 17 illustrates an exemplary table of the contents of the “tools” table, according to exemplary embodiments of the present invention;

FIG. 18 illustrates an exemplary table of the contents of the “batches” table, according to exemplary embodiments of the present invention;

FIG. 19 illustrates an exemplary table of the contents of the “batches_alerts” table, according to the exemplary embodiments of the present invention;

FIG. 20 illustrates an exemplary table of the contents of the “batches_alerts_users” table, according to the exemplary embodiments of the present invention;

FIG. 21 illustrates an exemplary table of the contents of the “batches_coi” (batches-communities of interest) table, according to the exemplary embodiments of the present invention;

FIG. 22 illustrates an exemplary table of the contents of the “batches_tools” table, according to the exemplary embodiments of the present invention;

FIG. 23 illustrates an exemplary table of the contents of the “batches_tools_users” table, according to the exemplary embodiments of the present invention;

FIG. 24 illustrates an exemplary table of the contents of the “batches_tools_policy” table, according to the exemplary embodiments of the present invention;

FIG. 25 illustrates an exemplary table of the contents of the “c2r” table, according to the exemplary embodiments of the present invention;

FIG. 26 illustrates an exemplary table of the contents of the “cas” table, according to the exemplary embodiments of the present invention;

FIG. 27 illustrates an exemplary table of the contents of the “coi” (community of interest) table, according to the exemplary embodiments of the present invention;

FIG. 28 illustrates an exemplary table of the contents of the “department” table, according to the exemplary embodiments of the present invention;

FIG. 29 illustrates an exemplary table of the contents of the “duty_titles” table, according to the exemplary embodiments of the present invention;

FIG. 30 illustrates an exemplary table of the contents of the “hardware” table, according to the exemplary embodiments of the present invention;

FIG. 31 illustrates an exemplary table of the contents of the “my_groups” table, according to the exemplary embodiments of the present invention;

FIG. 32 illustrates an exemplary table of the contents of the “my_subscriptions” table, according to the exemplary embodiments of the present invention;

FIG. 33 illustrates an exemplary table of the contents of the “groups” table, according to the exemplary embodiments of the present invention;

FIG. 34 illustrates an exemplary table of the contents of the “group_list” table, according to the exemplary embodiments of the present invention;

FIG. 35 illustrates an exemplary table of the contents of the “group_type” table, according to the exemplary embodiments of the present invention;

FIG. 36 illustrates an exemplary table of the contents of the “alerts” table that accommodates workflows, according to the exemplary embodiments of the present invention;

FIG. 37 illustrates an exemplary table of the contents of the “alert-users” table that accommodates workflows, according to the exemplary embodiments of the present invention;

FIG. 38 illustrates an exemplary table of the contents of the “billet-policy” table, according to the exemplary embodiments of the present invention;

FIG. 39 illustrates an exemplary table of the contents of the “coi-users” table, according to the exemplary embodiments of the present invention;

FIG. 40 illustrates an exemplary table of the contents of the “policy” table that accommodates policy on various tables, according to the exemplary embodiments of the present invention;

FIG. 41 illustrates an exemplary table of the contents of the “tools_users” table, according to the exemplary embodiments of the present invention;

FIG. 42 illustrates an exemplary table of the contents of the “usafmsa” (United States Army Force Management Support Agency) table, according to the exemplary embodiments of the present invention;

FIGS. 43a and 43b illustrate an exemplary table of the contents of the “users” table, according to the exemplary embodiments of the present invention;

FIGS. 44a and 44b illustrate an exemplary table of the contents of the “units” table, according to the exemplary embodiments of the present invention;

FIG. 45 illustrates an exemplary table of the contents of the “billet” table, according to the exemplary embodiments of the present invention;

FIG. 46 illustrates an exemplary table of the contents of the “billet_user” table, according to the exemplary embodiments of the present invention;

FIG. 47 illustrates an exemplary table of the contents of the “topics” table, according to the exemplary embodiments of the present invention;

FIG. 48 illustrates an exemplary table of the contents of the “subscriptions” table, according to the exemplary embodiments of the present invention;

FIG. 49 illustrates an exemplary table of the contents of the “billet_subscriptions” table, according to the exemplary embodiments of the present invention;

FIGS. 50a-50d illustrate an exemplary table of the contents of the “ako” table, according to the exemplary embodiments of the present invention;

FIG. 51 illustrates an exemplary table of the contents of the “Tracks” table, according to the exemplary embodiments of the present invention;

FIGS. 52a-52b illustrate an exemplary table of the contents of the “TASKS” table, according to the exemplary embodiments of the present invention;

FIGS. 53a-53b illustrate an exemplary table of the contents of the “TASK_STEPS” table, according to the exemplary embodiments of the present invention;

FIG. 54 illustrates an exemplary table of the contents of the “INTERPRET_TRANS” table, according to the exemplary embodiments of the present invention;

FIG. 55 illustrates an exemplary table of the contents of the “TRANSFORMATION” table, according to the exemplary embodiments of the present invention;

FIGS. 56a-56b illustrate an exemplary table of the contents of the “TRANS_POLICY” table, according to the exemplary embodiments of the present invention;

FIG. 57 illustrates an exemplary table of the contents of the “POLICY_INFO” table, according to the exemplary embodiments of the present invention;

FIGS. 58a-58e illustrate the logical construct of the web pages and the graphical user interface;

FIG. 59 illustrates the logical architecture of the hardware, operating systems, networking systems, and database systems that comprise the exemplary engine;

FIG. 60 illustrates the Overall System View (OV-6) depicting logical deployment of the invention across various interagency networks and the J-SPASAM to J-SPASAM ‘dead-drop’ federation;

FIG. 61 illustrates an exemplary table of the contents of the “Honeycomb” table, according to the exemplary embodiments of the present invention;

FIG. 62 illustrates an exemplary table of the contents of the “RANK_TITLES” table, according to the exemplary embodiments of the present invention;

FIGS. 63a-63i depict an exemplary flow diagram describing programmatic processes embodying the role-based workflow capability, according to the exemplary embodiments of the present invention;

FIG. 64 illustrates an exemplary diagram of policy specificity in describing the algorithm for policy decision, according to exemplary embodiments of the present invention;

FIG. 65 illustrates an exemplary table of the contents of the CAPALERT table, according to the exemplary embodiments of the present invention;

FIGS. 66a-66b illustrate an exemplary table of the contents of the CAPINFO table, according to the exemplary embodiments of the present invention;

FIG. 67 illustrates an exemplary table of the contents of the CAPRESOURCE table, according to the exemplary embodiments of the present invention;

FIG. 68 illustrates an exemplary table of the contents of the POLYGON table, according to the exemplary embodiments of the present invention; and

FIG. 69 illustrates an exemplary relational diagram of the tables used in Common Alerting Protocol (CAP) Message handling, according to the exemplary embodiments of the present invention;

### DETAILED DESCRIPTION OF THE PREFERRED EMBODIMENTS

The present invention includes the recognition that a reason people may want to be able to transverse network security barriers is to effectively perform the duties of their job. In fact, duty descriptions or roles are the most prevalent reason for granting access to a network resource. This fact formed the basis for creating Role Based Access Control (RBAC). RBAC is a concept that has contributed to the development of standards for conveying roles. While RBAC addresses the important issue of granting access based on duties, it has its limitations as well. For one, within interagency communications there is no common definition of attributes that describe these roles or the characteristics of an entity—employed to establish “federated trust”. This lack of common role definition has resulted in each separate entity or organization establishing their own codified method of identifying these attributes. Thus, RBAC taking place between agencies (e.g., interagency RBAC) becomes complicated and impossible without a translation service.

The arena of Federated Identity Management is currently addressed by other software products that are deployed throughout an enterprise at each domain controller. In such federations, assertions are typically made in a ‘point-to-point’ manner. Extensive coordination and configuration efforts must be made to relate the attributes from one organization to another. This is unsatisfactory in dynamic environments, such as interagency, emergency management, or military operations—where constitution of the enterprise is relative to each participant and this enterprise must necessarily expand and contract rapidly to facilitate information sharing.

The exemplary embodiments of the present invention, advantageously, address the ‘need to share’—which falls into the realm of enterprise access control. Enabling this increased ‘sharing’ required providing enterprise users with a universal mechanism to identify other participants in the federation. The human reality is: people in such situations identify each other based on their respective positions, or roles (e.g., referred to as ‘billet’ to avoid confusion with ‘membergroup’ based roles provided by directory services), within the federation—not their ‘username’. The problem is analogous to ‘finding the chief of a responding fire house’ by looking in a phone book.

There is a need for certain duty positions within a collective group (e.g., enterprise) to work together habitually. These select individuals form a ‘community of interest’—as they share a common purpose. The term Mission-Centric Community of Interest is applicable to the ad hoc or temporary community that is formed—particularly in emergency or military operations. Defining the membership of this group is difficult, if not impossible, without referencing the duty-positions of the group elements—as that is the sole reason they are a member.

The exemplary engine of the exemplary embodiments provides a novel, enterprise-wide, ‘role resolving’ and brokering service. This brokering process is initiated by accepting and associating an identity assertion—probably from other conventional identity providers that are dependent on a directory services (e.g., LDAP or ActiveDirectory™) methodology. This unique ability to associate and effectively manage the ‘billet—user association’ enables many capabilities including: pro-active sharing by ‘finding’ users based on duty position, pre-planning information architectures, identity transformation, mission-centric communities of interest, creation of role-based encryption keys, role-based business process modeling, and role-based service oriented architecture orchestration.

The deployment of this service can be compared to an on-line credit reporting service that financial institutions might use. The online website can be hosted on a clustered server architecture, probably from multiple sites—but appears to the user as a single website address. The site collects information from various sources and provides data to financial institutions via web services. Yet, people can access the site and manage configuration settings via a web browser.

Directory Services, most often provided by a Lightweight Directory Access Protocol (LDAP), have been adapted to provide Role Based Access Control by embedding attributes to the user. Unfortunately, this approach fails when one of several conditions exist. First, LDAP directory services fail when the enterprise is rapidly changing (e.g., during civil emergency management or military operations). In a dynamic environment, new organizations, each with their own domain, must be added to or removed from the federation quickly and easily. However, since LDAP is providing access control, the ability to do this quickly is limited. The second problem with LDAP is that the attributes that describe the users and their associations may not be synchronized. That is, one organization may characterize users one way, while another may define their attributes in another way. Thus, organizations cannot effectively communicate because they do not understand each other's methods of defining attributes. Finally, when the federation becomes large (e.g., usually beyond 10,000 entities) and users and role management becomes unwieldy, LDAP cannot effectively handle the RBAC employed for maintaining the federated trust. Directory Services and LDAP are useful for providing attribute information regarding entities such as users and network resources. However, they have not proven effective in providing federated access control.

In addition to these general problems, the directory services (e.g., LDAP) approach has also failed to provide RBAC on an individual user level. LDAP methods have attempted to provide RBAC through usernames and e-mail accounts (e.g., mayor@city.us or watchcommander@unit.division.army.mil). This has typically failed because this approach cannot overlay true personal attributes to the account without specifically modifying permission in the LDAP. For example, attributes could be included in the username to further specify that particular user, but the end result is very long user names. Security is another problem with LDAP directory services as well. It is considered a security violation to allow others to use the same account (e.g., when an individual serving as a watch officer is replaced at the end of a work shift). Further, preferences and personal files or attributes are either lost or carried to the next person.

A person's duty position within an organization may be referred to as a ‘billet’. The definition of this billet is imperative to describing the activities and information needs the occupier of that position inherits when so assigned. Their ‘role’ within an organization can be defined when the duty description is understood. These terms (e.g., duty position, billet, and role) are often used interchangeably. However, directory services based ‘roles’ convey group membership (e.g., such as ‘administrators’, or ‘authorized to sign’) for the purpose of resource provisioning and do not adequately associate users with the organizational structure.

Another attribute that is largely overlooked in enterprise identity management is location. That is, when managing access, systems are not effectively granting access to resources based on the physical proximity of users and resources. During activities that require command and control (C2), it is critical for the federation's involved parties to be aware of the current location and status of assets. Given the geographic location of a resource or entities requesting those resources, the size and ‘shape’ of the enterprise is relative to both the user and the resource. Providing Proximity Based Access Control (PBAC) throughout the ‘relative enterprise’ is critical to providing the rapid sharing of information, managing bandwidth, and troubleshooting the physical infrastructure. As of now, an effective system of ‘real-time’ PBAC does not exist.

In today's world and in federations specifically, the ‘need to share’ information has become exceedingly important. In fact, the military has studied the ‘need to share’ to such an extent that it has coined these activities as Network Centric Operations. Unfortunately, satisfying this need to share among the organizations in a federation is complicated by the need to provide network security. However, these two requirements are not mutually exclusive. In fact, contrary to an engrained security-minded establishment, security is enhanced by providing role based and proximity based access control and defining a flexible architecture of decision points and enforcement points based on the conveyance of these attributes.

Sharing information proactively has gained it's own moniker—‘smart push’. This implies that someone controlling information within an organization finds it desirable to provide access to or give the information to someone else. This decision is based on the assumption that the receiver would benefit in the conduct of their job responsibilities. Finding these intended recipients has eluded the network because until now there is no mechanism to resolve the organization structure and the association of the users that occupy these duty positions.

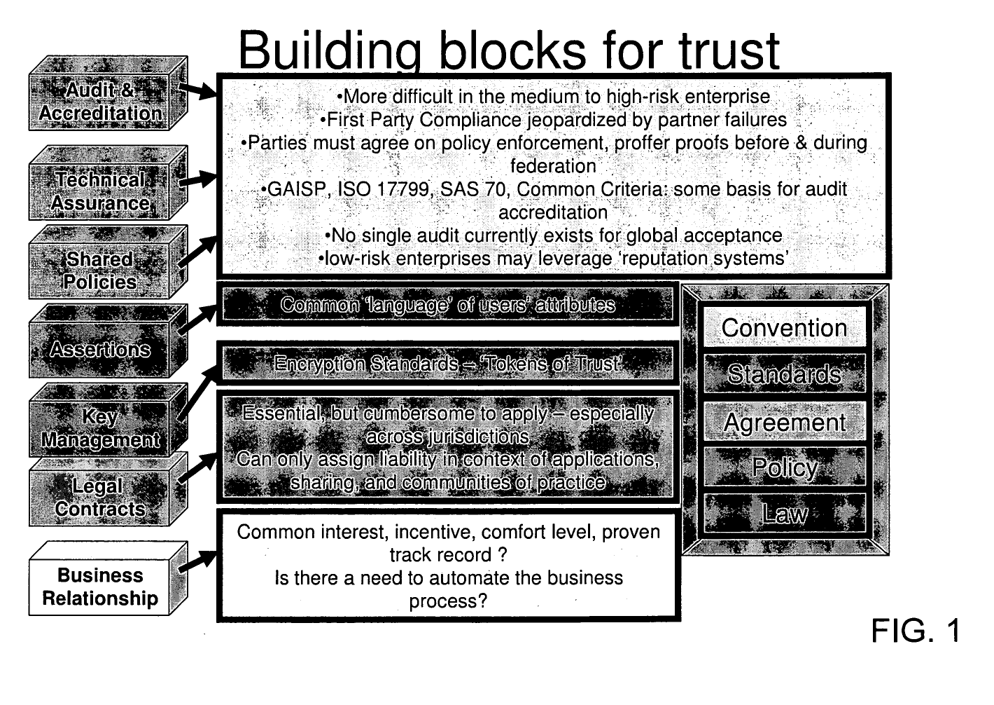

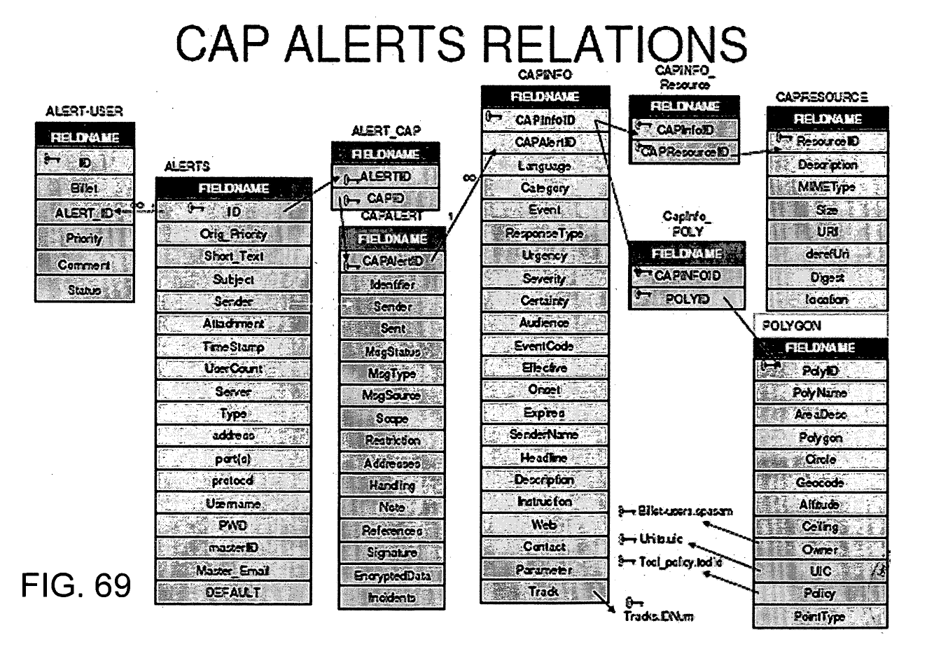

Referring now to the drawings, wherein like reference numerals designate identical or corresponding parts throughout the several views, and more particularly to FIGS. 1-69 thereof, there is illustrated an exemplary method and system for enterprise network access control and management for Government and Corporate entities, according to exemplary embodiments.

Assisting Information Management.

The present invention includes recognition that there is a need for a dynamic information architecture. The exemplary embodiments of the present invention address the above and other needs by providing an on-line system that assembles and assists a large, diverse community made up of various entities, such government, military, corporate, and civil agencies on the federal, state and local levels and allows them to communicate more easily with more increased security. In the course of their human interaction, people need to talk to other people, and over time, their attributes (e.g., duty positions) change and machines need to adapt quickly to those changes. The problem is that the rapid configuration change needs to be managed and users must be assured that the right data gets to the right person. As of now, this has not been done. The exemplary solution is an engine or database that exists on the network at the global level (e.g., for all suitable machines on the network) in which trust between users and organizations plays a major role (FIG. 60). The exemplary engine facilitates the building of this trust through authentication and a unique profiling capability. Once this trust is provided, information domains can be integrated and rapid changes and flexibility are possible. The exemplary system need not establish this trust alone, however. It allows for the human element as well through a field called information management.

Information Management is more of an operational rather than technical term. Those in this field are considered managers and decision-makers, while those in Information Technology (IT) typically hold occupations dealing with computers and the technology itself. But Information Management on the other hand, involves more of operational decision making. That is, Information Managers or Information Management Officers (IMOs) decide who needs access to what information. The goal of Information Management is to define who the right people (e.g., right positions and duties) are and what the right information is. Information Management allows the IT people to get the information from point to point, while the information managers manage the definition of authority. The exemplary system approaches the previously stated problem by providing a common tool and a common set of data so that the operational (e.g., Information Management) community can manage that information in terms that the IT community can quickly employ into terms that a computer can understand.

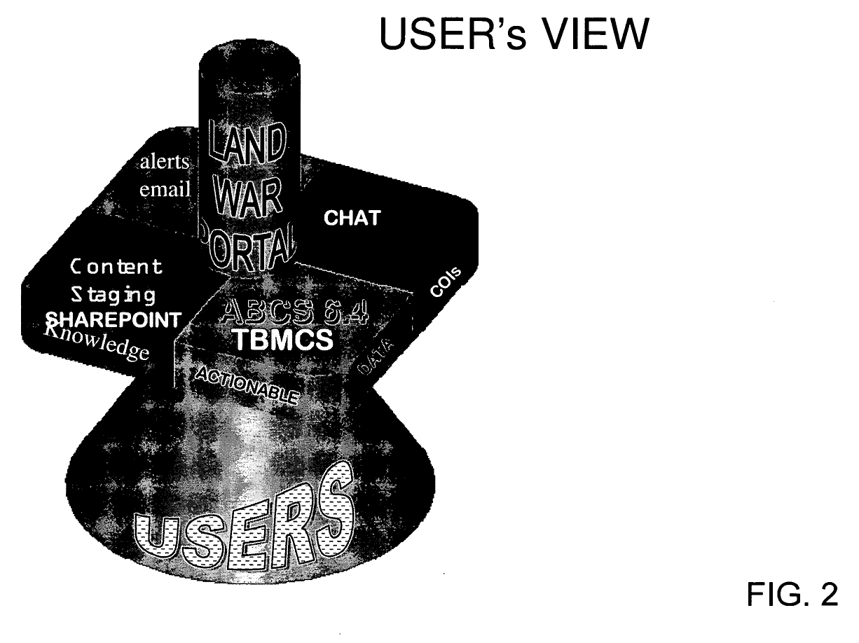

Integration of Information Domains (FIG. 2). Another part of the problem is that the common user, whether soldier, sailor or manager, has many tools at their disposal when performing their duties; trying to overcome natural disasters; or responding to terror events. However these tools, which can be categorized into four domains, are not currently integrated in such a way that facilitates problem-solving and decision-making. These four domains are:

Community of Interest (COI) Domain. This domain includes all the suitable tools and information from chat rooms, voice channels, other collaborative tools, and the like. This is real-time data. Here, users can draw many people in one place and communicate at the same time. This can take the form of a text chat, voice chat, video conferencing, and radio “nets” to name a few. The exemplary system need not be the chat room itself. Rather, it provides a directory service so that there is a road map to finding the right information for the right groups or communities of people to have a place where they can communicate their information back and forth amongst each other. Basically, the exemplary engine need not provide the space to communicate, but assists users in getting access to the space.

Actionable Data Domain. This domain includes the raw data transferred between industry specific applications that employ the raw data in order to work (e.g., in the accounting industry, a firm that uses point-of-sale needs a feed of data from cash registers). This data is real-time data, typically stored in and produced from different locations. The exemplary product can provide IT specialists with an address book that helps keep these connections viable. This is especially important in a dynamic environment like military operations or emergency management.

This collection of web-services is referred to as a Service Oriented Architecture (SOA)—and this complex management as ‘orchestration’. This product marries the defined access controls and preplanned architectures to the real-time actionable data domain to provide a new level of orchestration capability. This is accomplished through three distinct capabilities—Subscription by Proxy, Publish by Proxy, and Security Context Token (SCT) distribution.

Knowledge Domain. This domain is more art than science. It allows people to store documents in many types of forms. There are content staging portals that allow the knowledge domain to exist. There are fantastic search engines that exist in the domain. The content in this domain is not live. Rather, the information has been converted from data and processed by experts beyond information and is now considered knowledge. Someone has applied the data and put it in a form to share with others. This domain allows the exemplary system to provide negotiated access to shared and stored documents or websites or other portals so that users know where the right information is. As an example, the Center for Disease Control (CDC) might have their own portal including documents on various diseases and procedures for handling the diseases. Once the disease being dealt with is known, the portal can get people pointed to the right place very quickly. For other people to access this available knowledge, it must be categorized. Everyone categorizes data in their own way. The exemplary system puts together a network of people who are knowledgeable about these categorizations and allows these individuals to sort of ‘re-categorize’ the information that is pertinent to their interests.

Alerts and E-mail Domain. More and more, one needs to be able to contact others. This is a ‘near real-time’ domain. Soldiers, sailors, and managers are communicating not only on radios and telephones, but also with e-mails and alerts to get information back and forth and to notify people of what is going on. The exemplary system includes an alert-based system and connects into e-mail, short-text messaging on cell phones, and other alert protocol systems. More and more, people need to be able to contact others. Here, the portal can send someone an alert to communicate a quick piece of information or to respond to a request. Here, the exemplary engine constructs and negotiates an alert, to get someone a quick piece of information or respond to a request. Users need to have identifiers so that the messages can get to the right person. Currently, there is no way to do that quickly in user-friendly terms. The typical e-mail address is a great way to define how to get a person. The typical form of an e-mail address is “username@domainname”. The user must exist in the domain and the domain name allows the Domain Name Server (DNS) infrastructure to properly route a message or an alert to a machine that can get it to one of its users. The problem with the current system is that e-mail addresses do not necessarily reflect who the person is, or what their role is. For example, in the case of a natural disaster, someone from the National Guard may wish to e-mail the Mayor of Norfolk who happens to be John Doe. His e-mail address is jdoe@norfolk.gov, but just by looking at this address, the National Guardsman does not know that he is the mayor. The exemplary system can make this distinction.

The exemplary system integrates these four info domains into an environment that becomes seamless. It has a sort of “dashboard” that includes indicators from each of these four domains, controls and access points, and ways to get into these areas. These items are presented to the user and managed so that they can quickly and intuitively get into the areas they need.

The process involved in orchestrating these controls is defined through Business Process Modeling. The exemplary embodiments of the present invention employ a role-based workflow engine to allow every organization to define how these processes can be executed; which positions can provide control information and which can provide the authorization to execute the desired process. This role-based definition of a process allows dissimilar organizations across an enterprise to collectively manage the information architecture—quickly and flexibly.

In further defining the problem, different situations employ different segments and different uses within each of those domains so the exemplary system allows information managers the preconfigured capability and different filters or connections into these domains based on a given situation. The exemplary system integrates all the suitable domains such that a person can access what they need based on their attributes; that is, based on their identity and duty position. This preconfiguration is a unique aspect of the J-SPASAM engine and it takes place in two basic activities: the creation of groups and the creation of batches.

When users create groups, they pre-establish a collection of users with whom they want to communicate in either routine or emergency situations. A city Mayor may prove a valuable example of the importance and use of group creation. On a daily basis, the Mayor may want to communicate with all the suitable people with whom the city government has contracted work. In this situation, the Mayor would create a group of all the suitable people in charge of those contracts in order to monitor and track the progress of the work going on in the Mayor's city. In an emergency, the Mayor may need to coordinate efforts in the Mayor's city with those of other cities. Here, the Mayor may create a group of Mayors from all the suitable surrounding cities so that together they can meet the needs of their citizens. Since the Mayor pre-determined that the Mayor would need to communicate with these groups of people, contacting them can happen very quickly and easily. With a click of the mouse, the Mayor can reach out to all the suitable people in a group at one time.

Since the exemplary engine defines users based on their role or job, keeping groups up to date is facilitated. The group of Mayors example can help explain this feature. If the mayors in the group were defined by e-mail addresses rather than roles, each mayor can be represented in this group by his e-mail address. That is, John Doe, Mayor of Norfolk, can be represented by jdoe@norfolk.gov. The problem occurs when John Doe is no longer the mayor. In the e-mail based system, the group members would have to remove jdoe@norfolk.gov from their group and add the e-mail address of the new mayor. With the exemplary engine's role based definition of users, the mayors would be represented by a code that indicated that they were the mayors of their cities. Thus, whether John Doe or somebody else fills the role, the code for Mayor of Norfolk would always be a part of the group. Thus even when users are changing, groups remain functional and communication can still occur.

Creating batches is similar to creating groups in that it involves pre-planning. However, it is advantageous to note that groups form the foundation for batches. A batch is essentially a routine that is created by the Information Manager. With the collaboration of others in the organization, the Information Manager determines what information architectures may be employed to facilitate a given scenario, like a hurricane or a bomb threat, and determines which positions need access to which tools and which positions need to communicate with one another. A batch can do several things, including creating and sending alerts and e-mails, creating collaborative channels or chatrooms, advertising tools, modifying access and policy, and the like.

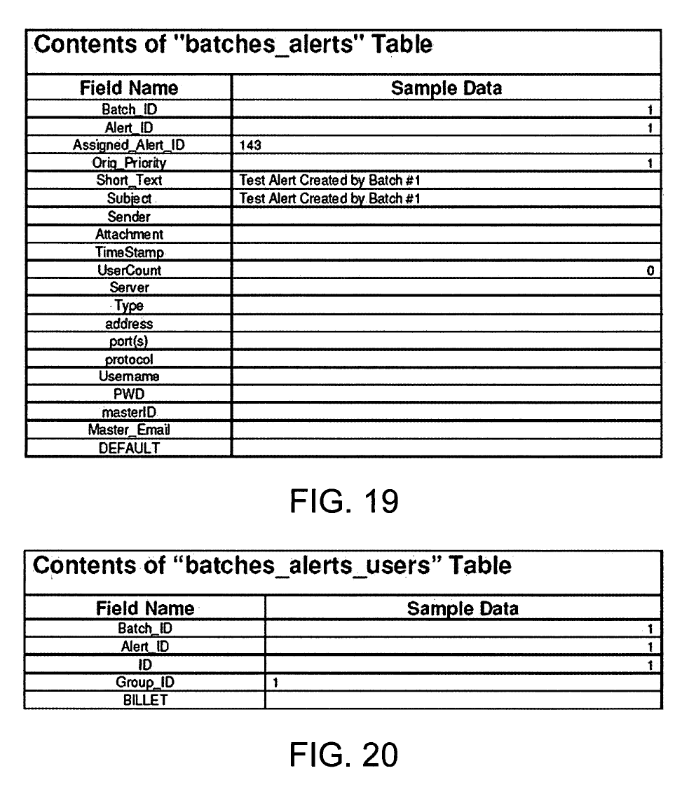

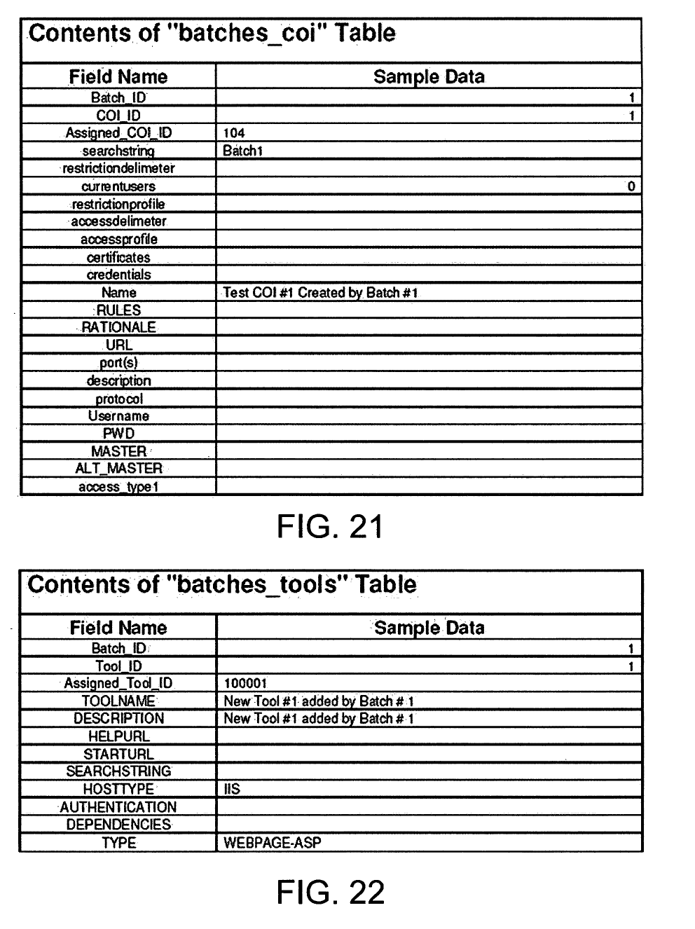

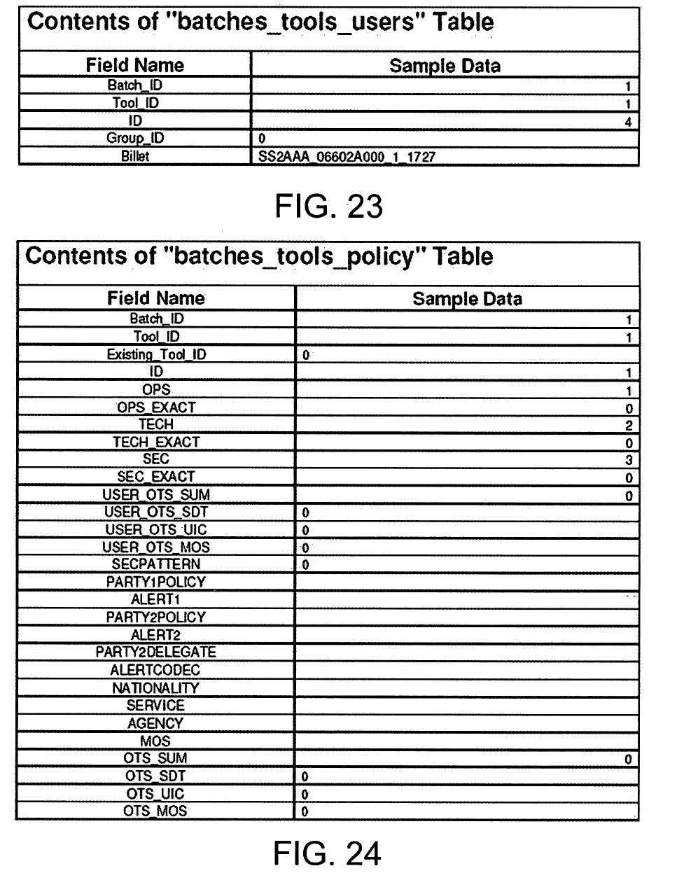

In further exemplary embodiments, FIG. 18 illustrates an exemplary table of the contents of the “batches” table which holds descriptive information for the overall process to be executed. FIG. 19 illustrates an exemplary table of the contents of the “batches_alerts” table which stores information to be dispatched by the J-SPASAM alerts system. FIG. 20 illustrates an exemplary table of the contents of the “batches_alerts_users” table. FIG. 21 illustrates an exemplary table of the contents of the “batches_coi” (batches-communities of interest) table which allows for pre-configured collaboration locations to be defined and once executed, ‘invite’ users to the enterprise resource. FIG. 22 illustrates an exemplary table of the contents of the “batches_tools” table which contains information regarding enterprise resources that should be ‘advertised’ when executed. FIG. 23 illustrates an exemplary table of the contents of the “batches_tools_users” table which defines the billets to whom a particular tool is advertised. FIG. 24 illustrates an exemplary table of the contents of the “batches_tools_policy” table which allows for access control policy to be modified when executed.

For example, the information manager for a coastal city's government would most likely create a batch for a hurricane. Prior to a hurricane, the information manager would determine the various methods of allowing users to access all of the suitable information domains. This batch would most likely include an alert going out to a “group” of local mayors. A Community of Interest, or chatroom, can be created for the mayors “group” and the head of a National Guard Unit would be invited to participate in the collaboration. Emergency management officials would then be given access to tools like radar or other weather tracking devices. These officials may not ordinarily have access to such tools, but would need them in the case of a hurricane. At this time, the new tools would appear on their “dashboards.” In addition to this advertising, the access “policy” may be temporarily modified to lessen or increase restrictions placed on a network resource.

The above are just a few examples of the components that might make up a ‘hurricane’ batch. The idea is that this batch “sits” on the J-SPASAM engine waiting to be invoked. Then, when news of a hurricane breaks, the information manager, governor, or other person of authority invokes the batch and the above components take effect. It is advantageous to note that the batch can be deactivated as well. Batches can exist until certain things occur, like after alerts have been sent or can be ended when the emergency situation no longer exists. When the information manager can quickly invoke or deactivate a batch and the users can quickly have access to each other and to needed tools, the emergency situation can be handled both effectively and efficiently.

These batches may also be invoked sequentially such that they build upon one another. As an example, when American Airlines Flight 77 was crashed into the Pentagon, it was initially unclear whether it was an act of terrorism (e.g., under the jurisdiction of law enforcement) or an accident (e.g., under the jurisdiction of local fire-rescue). Regardless, initial reaction required alerting duty-positions from various agencies of the incident and initiating a collaborative dialogue to ascertain the situation. Next, first responders were deployed to combat the particular situation. The 9/11 Commission Report indicated that a degree of confusion ensued until a chain of command was established—after the facts (e.g., collected from various agencies) revealed that was indeed part of a larger plot.

The exemplary embodiments of the present invention allow for the rapid, selective construction of an information architecture based on pre-defined ‘building blocks’. Because individuals continuously change positions within the various organizations involved, this pre-planning is only practical when based on roles. The exemplary system allows for batches to be invoked sequentially (e.g., first the incident alert, then choosing the appropriate the initial response phase, followed by a data collection phase, and then appropriate management according to the National Incident Management System). ‘Fine tuning’ the information architecture is then possible by managing the controls of the four information domains according to the situation.

Location Based Decision-making. There does not exist today an ability to quickly change access control or policy and keep a directory of where people and information sources are. Currently there is no ability to give a set of controls to the operational, Information Management community, or someone in a position of authority to determine which people get access to which information. Much of the basis of these types of decisions is location. The exemplary system is unique in that it allows for proximity-based location to be factored into the decision of whether or not to provide access.

For example, suppose a governor knows of a pending hurricane and knows his National Guard needs information. The counties closest to the coast clearly need information and assistance. A helicopter flying above, on the other hand, is a moving object with changing position; it is a dynamic source. The helicopter might be able to help in the endangered area. The exemplary system can proactively give the helicopter pilot access to pertinent information when they are in a certain area. For example, when the helicopter is within a certain distance of the impacted area, the helicopter can be subscribed to police car locations, alerts, or other pertinent information. In other words, sometimes the decisions for authority or access are based on proximity or location. This location is not based on address or zip code or on data, but rather on a three-dimensional location, latitude, longitude, and altitude, of both the resources and the locations of those units.

The exemplary system leverages the Common Alerting Protocol (CAP) messages utilized by various devices and organizations to define these three dimensional areas, participate bi-directionally in the alerts information domain, and define the ‘audience’ by role. In the example above, the National Weather Service may issue a CAP alert, defining probable impact areas. The governor can use this defined polygon to then send alerts specific to various duty positions within the defined areas, and pro-actively grant access to role specific information.

Federation and Trust (FIG. 1). A Federation is the joining of separate entities that can stand on their own individually. The National Guard is an example of this. They have their own organization. Similarly, cities and counties have their own computers, rules, and infrastructures. Similarly, corporations operate in their own way. When the exemplary system brings these three arenas together (e.g., military, municipality, and corporation) they become federated. The technical requirement for doing this is Enterprise Identity Management, and the basis for federation is trust. For example, a city manager trusts that a company they do business with is going to use his information carefully. That is, the city's information can be protected; the company can verify identity; and it can only give appropriate people access to city information. The building blocks of this trust are a business relationship, legal contracts, key management, and assertions.

For trust to exist, the entities should have a business relationship. There should be a common interest, an incentive to join together, a comfort level with the protection of information and knowledge that operations can work better together than separately. A proven track record can provide evidence of a good business relationship. It can show that the parties have abided by agreements into which they have previously entered. Before proceeding with Identity Management the parties should ask themselves if there is really a need for automation of their business structure. Federation through Enterprise Identity Management may not always be the best solution.

The exemplary embodiments of the present invention introduce a new mechanism to facilitate the creation of definitions for the terms for information sharing. Because the exemplary system enables the access control policy definition to be very specifically or broadly defined, the exemplary system mitigates the legal risks of sharing information by providing a means to limit and trace responsibility. By following the exemplary system's web-based, policy creation steps, an organization can define in specific terms: what information and by virtue of the role definition—why the information is being shared.

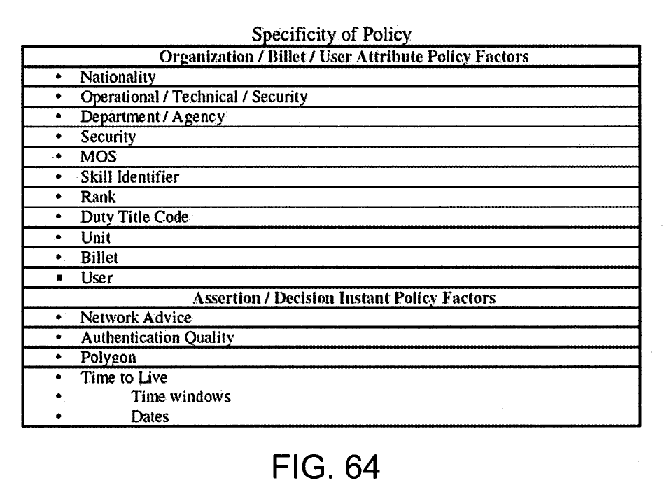

The policy definitions of the exemplary embodiments of the present invention further address the peculiarities of interagency information sharing by introducing a concept of ‘sliding scale of trust’. Trust, as discussed previously, is based on a reliance on the asserting party to participate in the federation according to agreements. Universal compliance with all agreements by all federation members is unrealistic due to many factors. However, the exemplary system's policy definition and adherence to standards defined in the eXtensible Access Control Markup Language (XACML) allows for enterprise resource managers to flexibly enforce this policy based on the given situation (FIG. 64). Now, a person in authority can create ‘exceptions’ to otherwise strict policy.

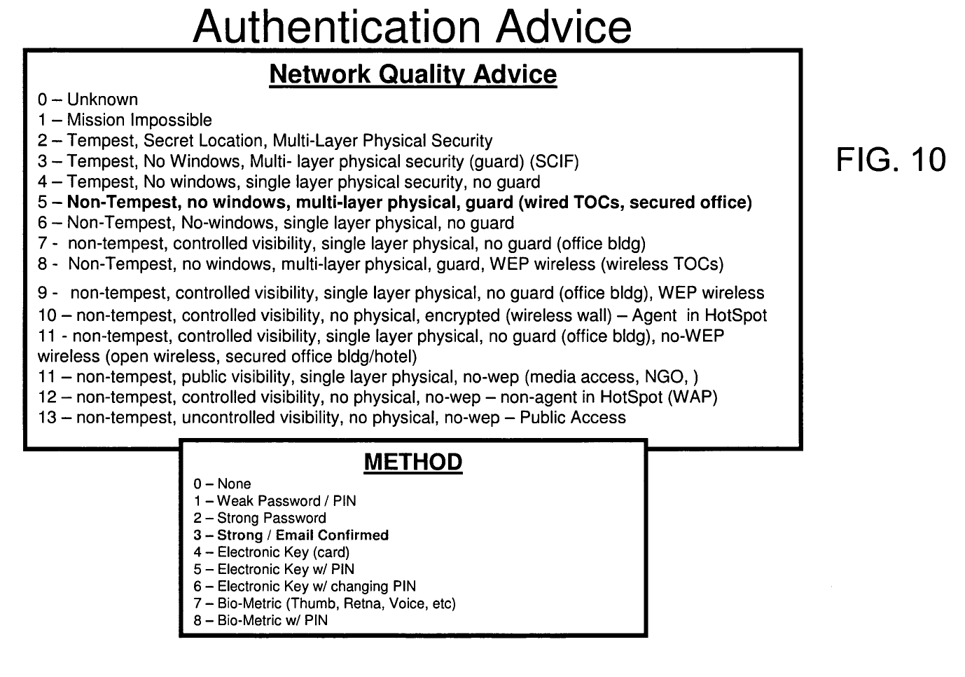

To illustrate, consider a hurricane situation where a particular person or organization desperately needs information—but the conditions have degraded. A resource provider may have a conventional requirement that incoming users be authenticated with a Common Access Card (CAC) from a secure facility (FIG. 10). After determining that the risks of not sharing information with the degraded organization out-weigh the risks of lowering security procedures, the provider may use this flexible policy engine to create an exception specifically for this organization to accommodate the situation.

Legal contracts also form the foundation of trust between entities. The legal contracts employed for federation may be cumbersome, but networks must be administered in such a way that protects the information of each party. The entities should agree on common algorithms, so that the information can be transferred securely, and may even be encrypted. This agreement ensures that only those trusted pieces of equipment are used and only the appropriate person gets the information needed.

One way to accomplish this is by passing tokens and exchanging certificates. This key management is a necessary element for trust. Public Key Infrastructure (PKI) is a great way to do this. With PKI, one portion of the key is transmitted and that transmitted portion matches another portion already on file. Once the match is established, the decryption can be done and users can be sure that they are speaking with the person they intended and there is not someone pretending to be the intended recipient of the information.

Emerging technology in data encryption algorithms enabled by multiple, simultaneous, key ‘splits’ is providing the foundation for encrypting data while at rest (e.g., in storage), in transit, and in processing. This composite infrastructure is referred to by some as ‘the Black Core’. The exemplary embodiments of the present invention enable the definition of these key splits based on the various billet, organization, or individual attributes as well as the key holder's membership in a role-based group (e.g., also called a community of interest). This COI-key definition feature is unique—while the actual key creation and encryption/decryption mechanisms are other techniques utilized by the exemplary engine.

Assertions are another advantageous part of establishing trust. Assertions are statements in which one confirms the attributes of a particular user, establish what is known about the user, and state that the assertions are valid for a certain period of time. The exemplary system has a unique method and a common language of attributes, which are allowed extensions of the Security Assertion Markup Language (SAML). This common language of SAML allows the exemplary system to describe the characteristics of a user based on his job and based on what is known about the authentication instance. XACML further allows the exemplary system to communicate policy, attributes, and provide access controls throughout the enterprise. Then, decisions can be made by the computers based on the will of what the humans in authority positions have conveyed. The exemplary system has bridged the computer-to-computer gap which allows the computers to record and codify the language of the attributes of users in the command and control (C2) domain. That is, even though one city may call its head “mayor” and another may call its head “director,” the exemplary system knows that these two people are at the same level and have the same decision-making authority in their organization and thus would be interpreted the same way. Advantageously, with this common language, one can make these assertions.

Essentially, the J-SPASAM engine is unique from other access control systems for several reasons, including providing the capability to define roles very specifically. The exemplary embodiments of the present invention provide the capability to translate occupations between civilian definitions and U.S. Army, U.S. Navy, U.S. Air Force, U.S. Marine Corps, and U.S. Coast Guard for the purpose of Role Definition. This occupation translation feature solves the problem of interoperability caused by codified occupation definition and “finding the right person.” Once these roles or positions are established, the exemplary system can form detailed profiles of users. The details or attributes of these profiles allow the exemplary system to establish policy or rules governing the associated users' access to network resources. The exemplary embodiments of the present invention provide the capability of codifying ‘authority’ according to the different roles with the Operational, Technical, Security (OTS) values in the schema. This feature solves the problem of access control within a broad command and control environment—caused by codified positions by applying a numerical matrix (e.g., OTS) to each duty position so that a computer can discern the intrinsic authority of a duty position.

These duty position profiles are: prescriptions for the occupation, seniority level (e.g., grade or rank) of the position holder as well as a codified definition of the duty title and the title itself. Thanks to the cross-organizational translation capability of the exemplary engine, these duty positions, ultimately custom defined from organization templates, can be interpreted—agnostic of the organization type. While some duty positions are unique to a specific industry (e.g., field artillery officer is unique to ground (e.g., Army, Marine Corps) military units), the exemplary engine maintains its ability to provide access control, billet resolving services, and conveying these attributes.

In addition, the present invention recognizes the relationship between a person, a duty-position (e.g., billet), an organization, network resources (e.g., hardware), platforms (e.g., conveyance), and assignment. For example, an organization does NOT own people, it owns its organization—which includes billets and equipment. People occupy billets within an organization. They may simultaneously serve in more than one billet and a billet may have more than one person in a single role. To perform their job, a duty position may be responsible for, or need access to equipment. A person (e.g., a pilot) can move from place to place using an airplane (e.g., equipment owned by the organization). The airplane can carry other equipment (e.g., radar, cargo, radios, etc). The owning organization may remain stationary (e.g., an airport) or it may re-locate (e.g., an Army Aviation unit). Further, the person and the equipment may be temporarily ‘loaned’ to another organization. The exemplary embodiments of the present invention solve the problem of providing access control for these complex relationships.

Access to information can be provided through Subscription By Proxy. By subscribing to information, an entity can receive updates whenever a ‘publisher’ posts changes or posts new information. The exemplary embodiments of the present invention solve the problem of complex configuration management within an information architecture by subscribing entities defined above to the appropriate data source (e.g., a publisher or data distribution service). The exemplary system serves as a broker for access to this information. Using the exemplary embodiments, an Information Manager can subscribe another user to various tools or data feeds based on that user's need for certain information. That user need not subscribe himself. The exemplary embodiments further address the problem of pre-configuring these information architectures. Because these architectures are based on duty positions, as defined above, they can be easily transposed to similar architectures.

As an example, during a hurricane a sheriff may need to be ‘subscribed’ to the current traffic conditions within their county, as well as the current location of traffic control points provided by the National Guard, and the location of convoys carrying sandbags that may be stuck in traffic. The exemplary embodiments of the present invention allow the traffic control monitoring organization to allow the sheriff to ‘subscribe’ to this traffic data, and the National Guard to allow the sheriff to ‘subscribe’ to location information of troops (e.g., which may be normally considered ‘sensitive’). This configuration can be pre-arranged and invoked only when the governor declares an emergency. Because it is role based, this configuration can be imposed on the sheriff that needs it (e.g., based on location). Further, this information architecture can be transposed easily from a New Orleans situation to a Norfolk, Va. situation. Further, after a hurricane in New Orleans, the ‘lessons learned’ can be transferred to the Virginia model, with appropriate modification.

The exemplary embodiments of the present invention also provide the ability to assist with Smart Agents. The Smart Agent also does Subscription by Proxy by subscribing users to tools based on their physical location. As an example, a Smart Agent can be set to: subscribe any suitable National Guard unit within 10 miles of a particular bridge to the information described above. When the unit enters the radius, it is subscribed; when it leaves, it is ‘unsubscribed’. This Subscription by Proxy is the second unique feature of the exemplary engine.

The exemplary embodiments of the present invention can include a web-based user interface to control and access the information architecture. From a routine user's perspective (e.g., not that of an information manager or information technology (IT) specialist), the website provides a simple, intuitive menu of information resources users need access to. These resources are categorized as tools, communities of interest, actionable data (e.g., feeds), knowledge staging sites, and alerts. The access to each item within these categories is provided (e.g., brokered) by the exemplary embodiments.

From an information manager's perspective, the website provides a simple, intuitive set of controls to regulate this access, based on the attributes of the requestor. The requestor conditionally inherits the attributes of his organization, assigned duty position, and finally his personal attributes respectively. The exemplary embodiments of the present invention provide a complete set of web-based controls for the information manager to manipulate the underlying database engine.

The database engine can be hosted on various platforms including: MYSQL, SQL2000, Oracle, and others. The website is hosted on various platforms including: Microsoft Internet Information Server (IIS), Apache or others. The website includes programming code written in Active Server Pages, Java, and other programming languages. Smart Agents and other control functions include applications written in various programming languages that interact with the database engine.

The following section describes the database schema employed with the exemplary embodiments. Programs or web pages that interact with this database schema should employ the pertinent art of relational database design and database management.

System: The Exemplary Engine and Engine Function (FIG. 14).

The following begins the description of what the exemplary engine is and how it works. The exemplary engine is a relational database, associated background applications, and programmed web pages and scripts, not necessarily operating on a particular database mechanism or operating system. A relational database is unique because the engineering is based on the way different tables relate to each other. It has held up to testing as an accurate way of describing these relationships.

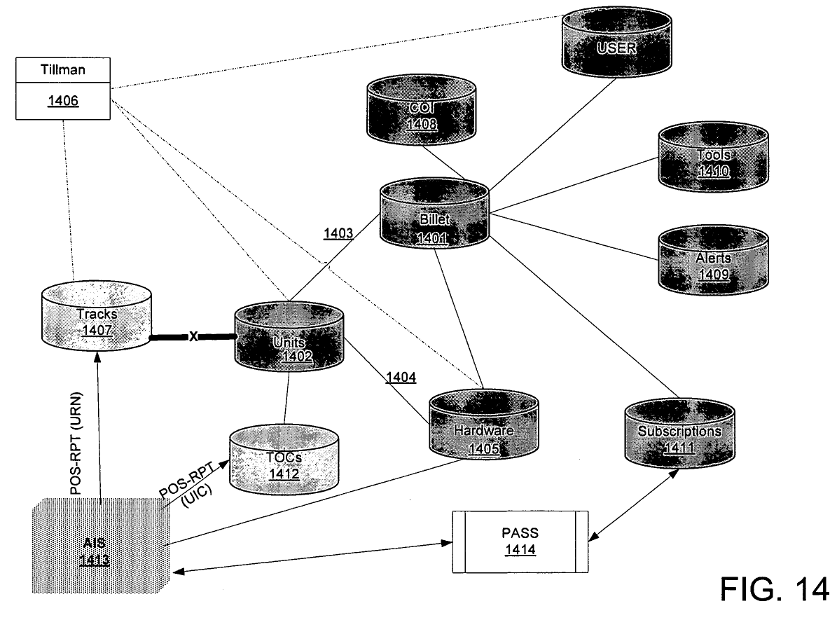

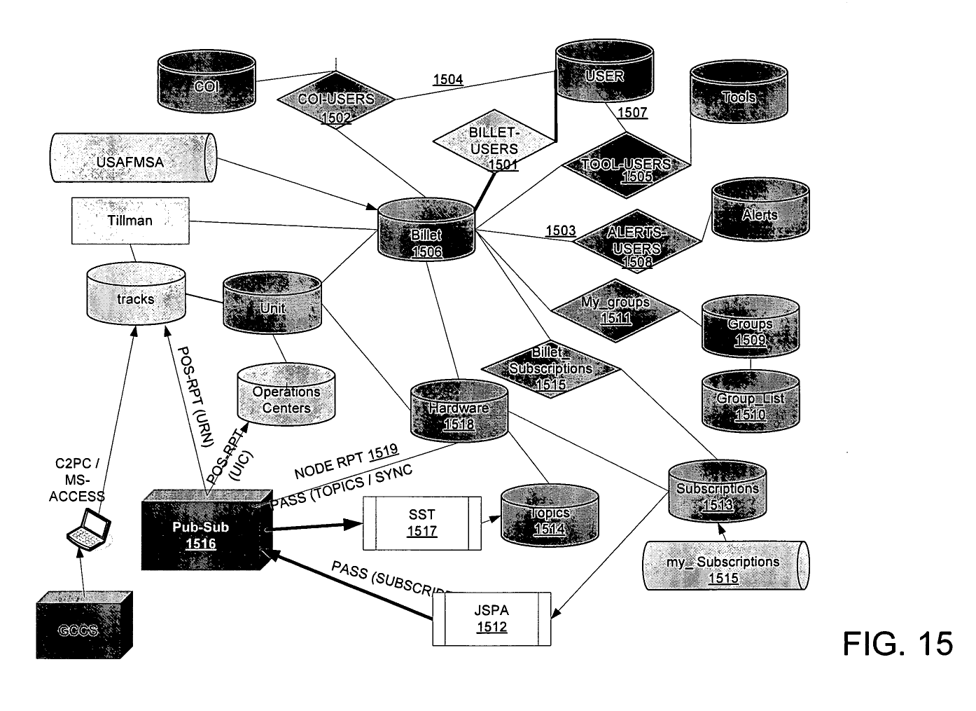

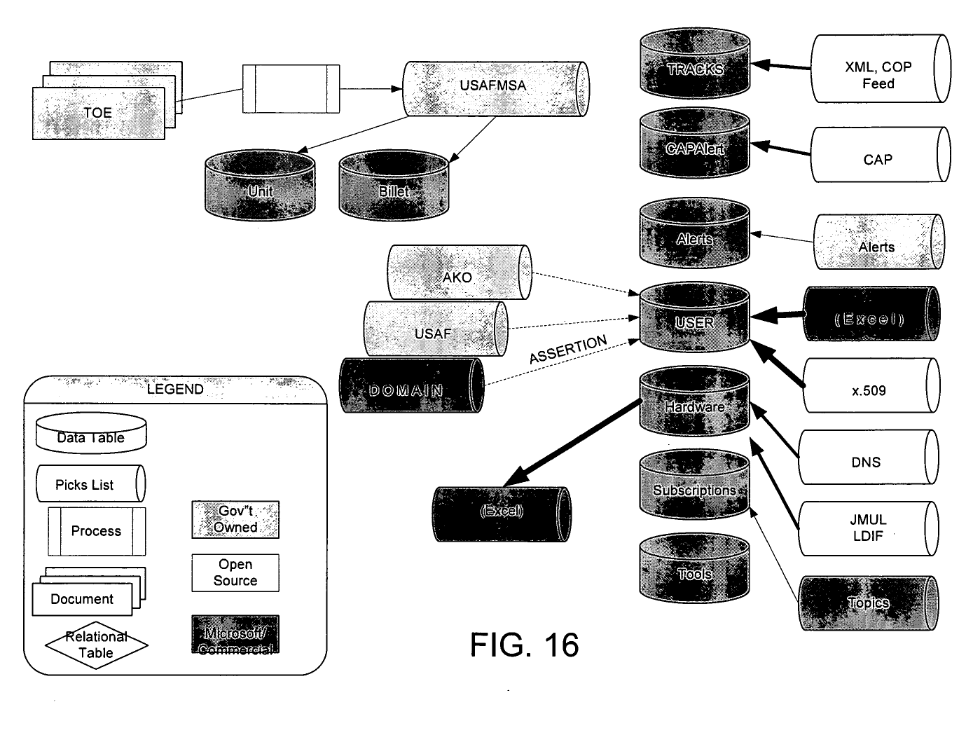

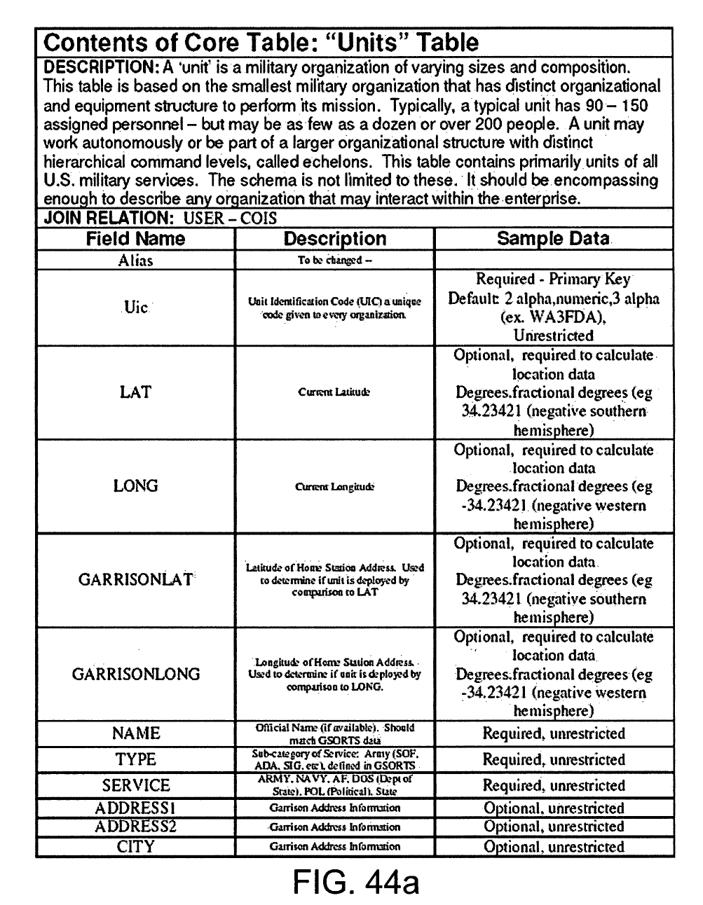

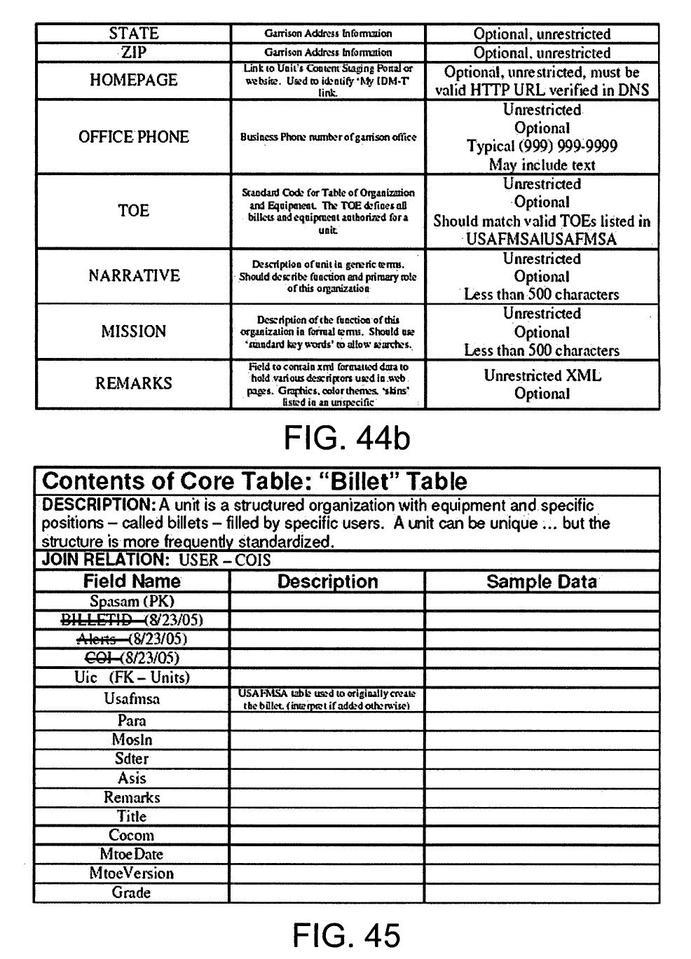

This database, which can include a series of tables, relates the tables to one another (FIG. 14). The fundamental tables that make up the database are the ‘Billet’ (e.g., role) Table (FIG. 45, and FIG. 14, element 1401). A Units (e.g., organization) Table (FIGS. 44a-44b, and FIG. 14, element 1402) has billets within it. That is, a company (e.g., unit) has a number of positions (e.g., billets) within it. This unique recognition that the billet is the essence of the role-based operation of the exemplary embodiments is exemplified by the relation of the other tables to this ‘Billet’ table. The Units Table describes that organization, including its home address, its current address, its function, and the like. The unit has both organization and equipment (FIG. 14, elements 1403 and 1404), sometimes referred to as a table of organization and equipment (TOE, FIG. 16). In fact, a lot of military billets were interpreted originally from the United States Army Force Management Support Agency (USAFMSA), on which the exemplary system bases the billets within an organization. Next is hardware (FIG. 14, element 1405). Hardware represents the IT devices on a network that a unit owns as well as other physical objects. So within the ‘hardware table’ (FIG. 30), every piece of hardware is owned by one and only one unit and every billet belongs to one and only one unit. Hardware is not limited to electronic devices, as any suitable object owned by an organization can be inventoried and recorded in the ‘hardware’ table.

However, a person can work temporarily for another organization and the exemplary system can make allowances for that. This is very unique to the exemplary engine. Even though a person is temporarily working for another organization and this temporary billet may restrict his access to certain tools, the exemplary system recognizes that they are still inherently paid and employed by the original organization. When this happens it is called operational control or OPCON; that is the temporary organization has operational control of that user. Thus, a user may occupy a particular billet, more than one billet, or the billet of another controlling organization (e.g., OPCON).

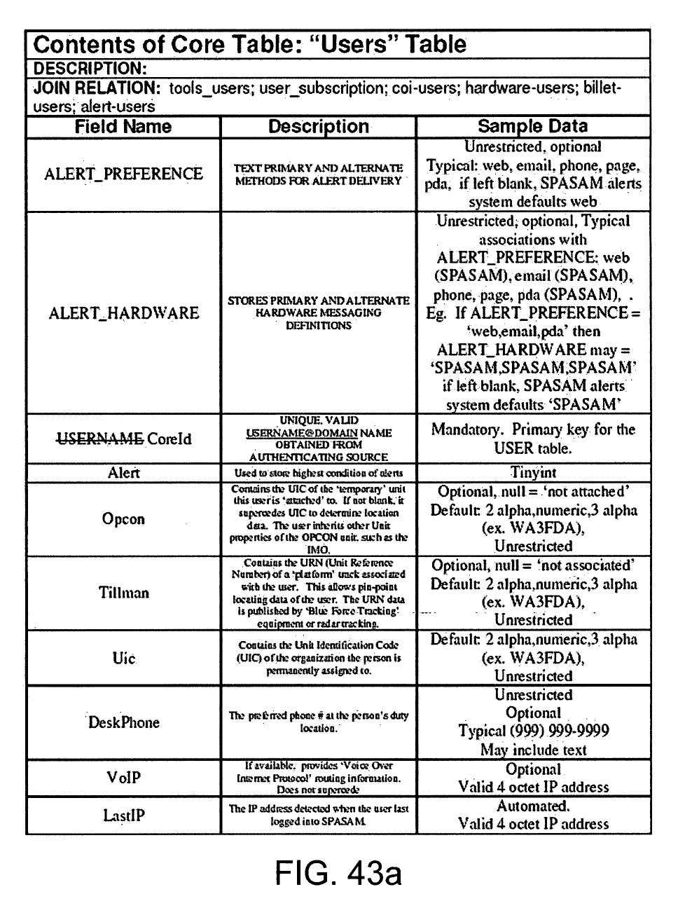

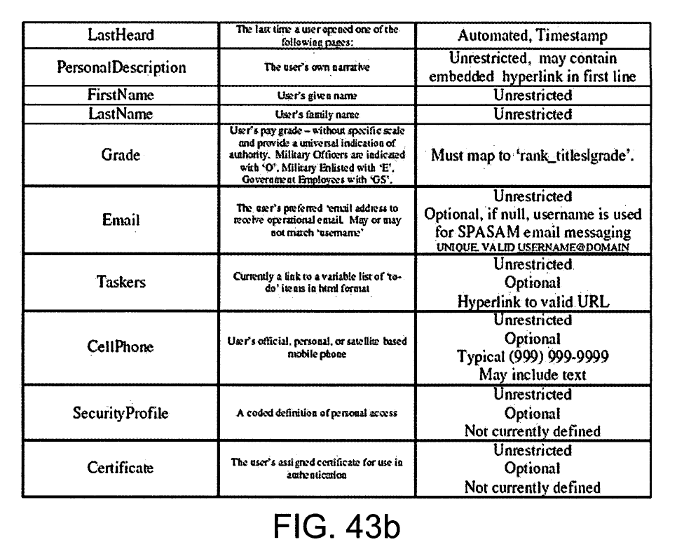

Next is the ‘Users’ Table (FIGS. 43a-43b, and FIG. 14, element 1415). Users are the people who are filling the appropriate billet. A person has their own attributes: their level of security clearance, their social security number, their name, and their occupation. For example, suppose a city mayor is also a doctor. In this case, their position or billet is mayor, but they have the attributes of a medical doctor. The exemplary system makes judgments for access based on billets as well as on personal attributes.

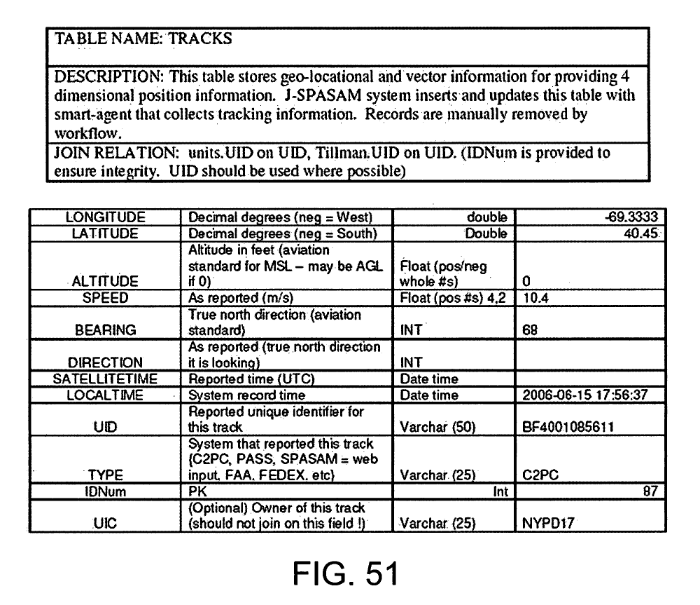

A unique feature of these tables is the Tillman field (FIG. 14, element 1406). This field, named after war hero Pat Tillman, represents the present invention's recognition that not only does an organization have a location, but users and hardware may inherit location attributes of their conveyance as well. The organization may be able to move around (e.g., a military unit). However, it is typically spread out, so when the exemplary system has to pinpoint a location of a unit, it usually gives the location of the headquarters. Tillman, also called a platform, track or conveyance, however, has a different identifier; a platform may be an aircraft, a vehicle, or a small ship. Basically a Tillman can be differentiated from a location like headquarters through an example. When a police officer goes to work every day his organization, his headquarters, stays at a single address, but the officer himself gets in a car and his location changes based on the location of his vehicle. This location can be identified in the Tillman field, which is included in the user table (FIG. 45) and related to a continuously updated “tracks” table (FIG. 51, and FIG. 14, element 1407). Here is an example of the usefulness of platforms and the Tillman field. Suppose a person is flying across the country, the exemplary system can assign that aircraft's unique reference number (URN) to the Tillman field as well as the user table and wherever that platform goes, the exemplary system assumes the person goes with it. Therefore the exemplary system always knows the location of the person. Then, if the exemplary system wants to restrict access to users within a fifty-mile radius it can look at the Tillman field and, although the user's organization may not be close by, grant the user access if the user is within that range or a network resource can be made available when it is within range.

The need for this unique capability stems from the necessity to ‘find’ people geographically for the purpose of proactively sharing information, managing scarce bandwidth resources by ‘throttling’ (e.g., proximity based access control). Another problem that exists in military networks, that this feature addresses, is related to information overload. The army, for example, only reports a fraction of its locational information to the larger enterprise. Due in large part to the expense in placing tens of thousands of tracking systems on vehicles, the practical necessity (e.g., military vehicles tend to operate together, in close proximity, in cohesive units or convoys, and finally to practicality of updating these vehicles' positions with limited bandwidth—there is a need for a system that can ‘read between the lines’—which advantageously is made possible with the exemplary embodiments of the present invention.

As an example, the majority of the information provided by the Army today is un-used by other services, coalition partners, and the like. However, in the tactical sense, that fine-detail information is critical to prevent fratricide and execute Joint operations at the speed of modern combat. The exemplary system's ability to subscribe the right person to the right data at exactly the right time is critical in addressing these two realities. To illustrate, an Air Force aircraft is designated to provide Close Air Support to a particular sector on the battlefield. This sector is defined in advance, based on planning and the current situation of ground advance. The ground units maneuvering in that sector have individuals responsible for ‘calling in’ these strikes—but are also un-aware of which individuals will be flying the aircraft. Current doctrine allows for tactical coordination via radio networks (e.g., both voice and digital) between these individuals—but lacks automation and is therefore prone to error. This method allows for using data that exists within the enterprise (e.g., the air force data that assigns this sortie to the area, pilot assignment, mission type, etc—exists on an air force system) to be used more effectively in a net-centric manner. The exemplary system allows for the pilot to be subscribed by proxy to that ‘best data’—the ‘tactical’ data feed of the supported unit.

Information to fill the Tillman field is coming from a tracks table, which is continuously updated, minute-by-minute, by an engine that is looking for current position locations. The exemplary system need not own this data. Rather, it subscribes to the location data that tells us where the platforms and units might be. The exemplary engine can use various sources to achieve this, including subscription to the common operational picture (COP), and the like, wherein COP tracks both the stationary location and the dynamic platform information. Other exemplary locational services include: aircraft positional information provided by the Federal Aviation Administration (FAA) or a commercial shipping companies parcel tracking system.

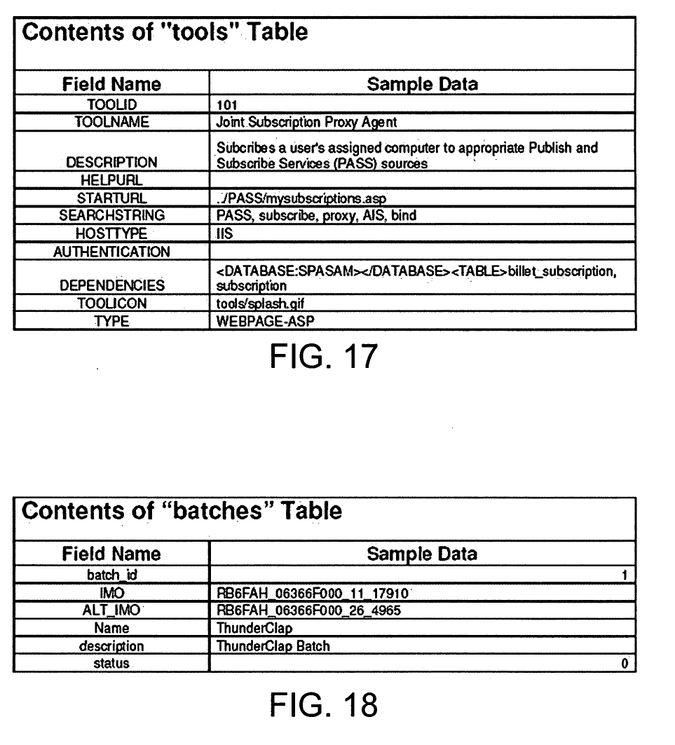

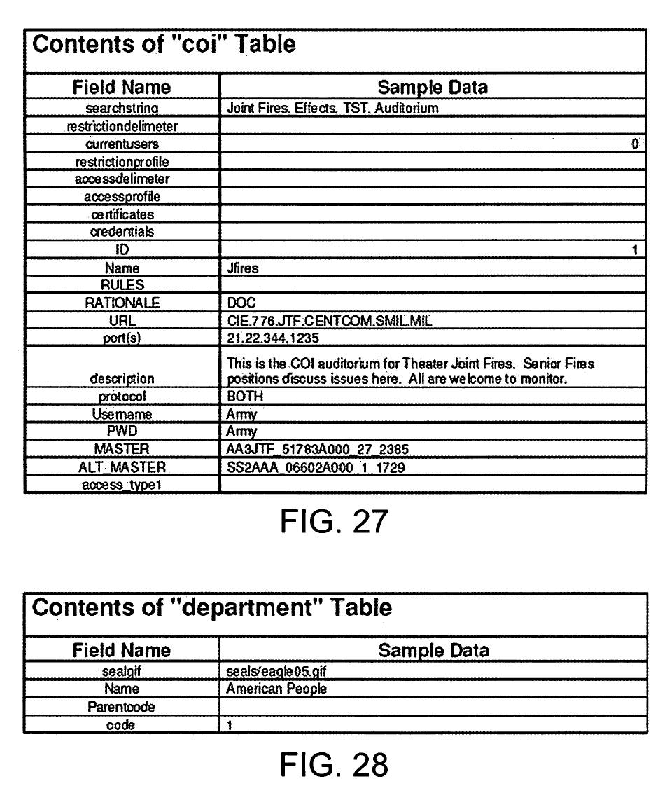

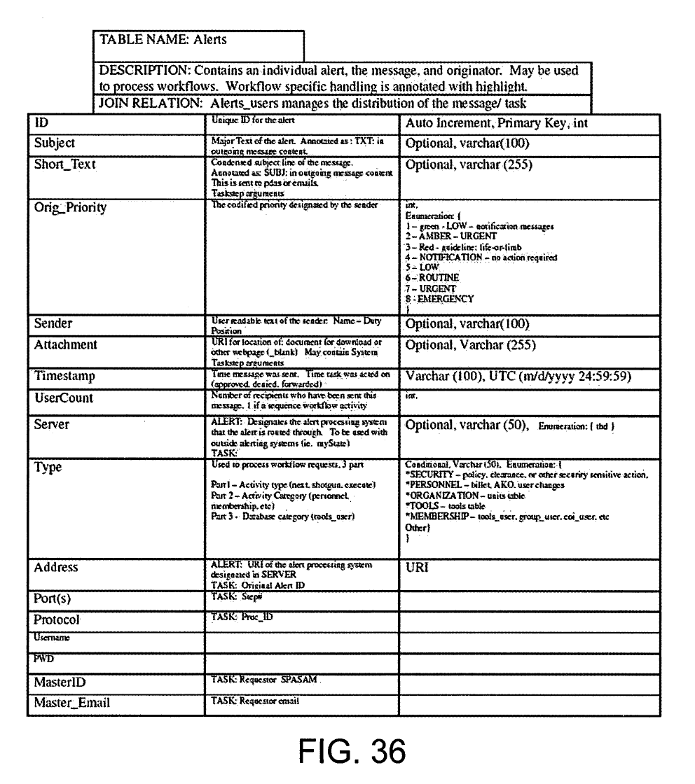

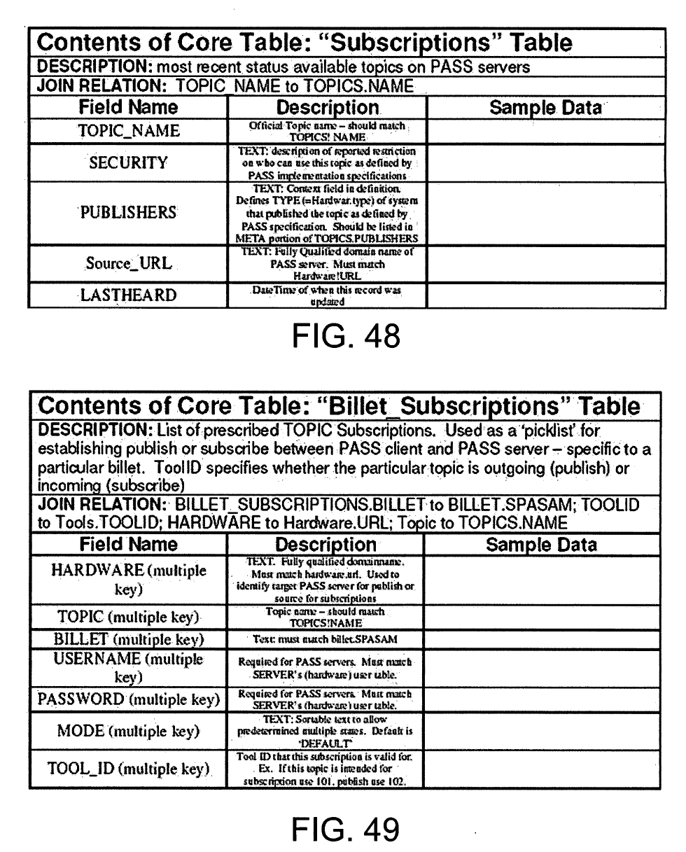

On the right hand side of FIG. 14 are objects that represent tables for the information domains. The exemplary system keeps track of information of various domains in several different tables: the COI Table (FIG. 27, and FIG. 14, element 1408), the Alerts Table (FIG. 36, and FIG. 14, element 1409), the Tools Table (FIG. 17, and FIG. 14, element 1410) (e.g., which relates back to access to the knowledge domain or other tools that allow users to do their job), and the Subscriptions Table (FIG. 48, and FIG. 14, element 1411) (e.g., which relates to the actionable data domain and make the applications work appropriately). The Tools Table (FIG. 17, and FIG. 14, element 1410) is the gateway into the knowledge domain and it is the way the exemplary engine registers many other ‘enterprise resources’ such as web pages, and the like. This summarizes the most significant tables employed that make the exemplary engine work and contribute to the uniqueness of the exemplary engine. These tables support the fact that the exemplary engine cannot solve the identity management problem for the user unless it can manage how all of these things relate to each other. The billet provides role based profiling and the exemplary engine uses those billets to provide role based access control into the resources, the information domains that a person needs to do his job.

The exemplary system subscribes to two U.S. government managed locational data sources. That is, it subscribes to tactical operations center (TOC, FIG. 14, element 1412) data, which gives the locations of units or their headquarters, and to tracks (FIG. 51), which provide us the locations of platforms or Tillman information. The ABCS Information Service (AIS, FIG. 14, element 1413) is for exemplary purposes only, as the object in the diagram represents a data source to which the exemplary engine subscribes. The exemplary system can subscribe to the systems that make up the ABCS (Army Battlefield Command System). The exemplary AIS data source is a ‘publish and subscribe service’ (PASS, FIG. 14, element 1414); it is the exemplary engine that provides the service. The “PASS” box in FIG. 14 indicates that “PASS” is a process. The exemplary PASS Process allows for the linking of a user and their subscriptions to a particular information source, which in this case is the representative ‘AIS,’ which is a subscription-based, actionable data node. In other words, if the City Mayor billet had a subscription to ‘publish and subscribe’ data so that the Mayor could know the location of city police cars, the Pass Process can give the Mayor access to that source.

Service Oriented Architecture (SOA) Orchestration. The actionable data domain includes applications that communicate with one another directly using web-services. These web services primarily take the form of a request-response dialogue enabled with Simple Object Access Protocol (SOAP) messages. In addition to the publish and subscribe capability described above, the exemplary embodiments of the present invention enable SOA orchestration by assisting in the configuration of such applications that relate to each other directly via web services.

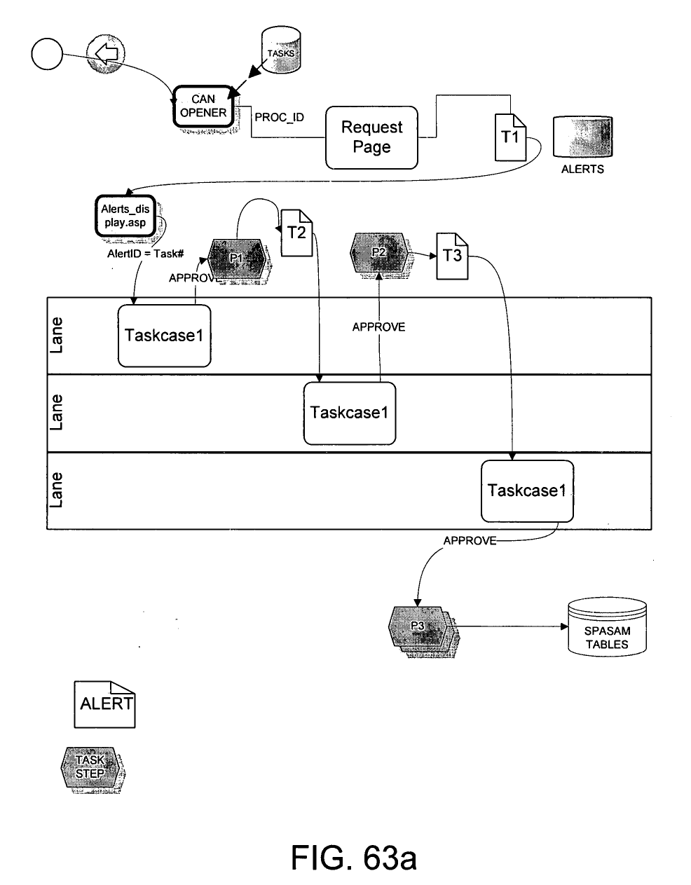

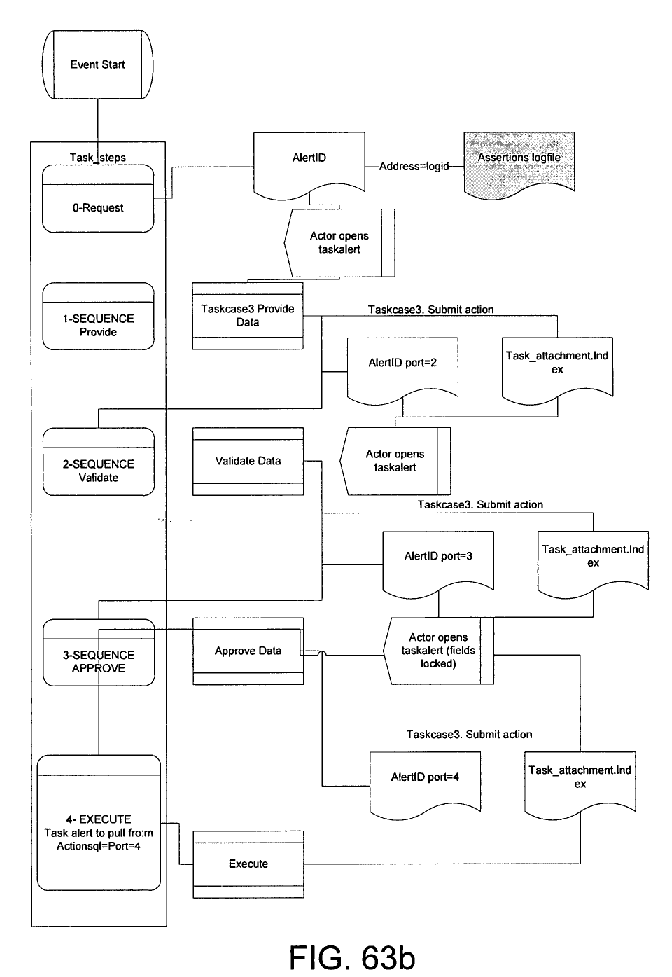

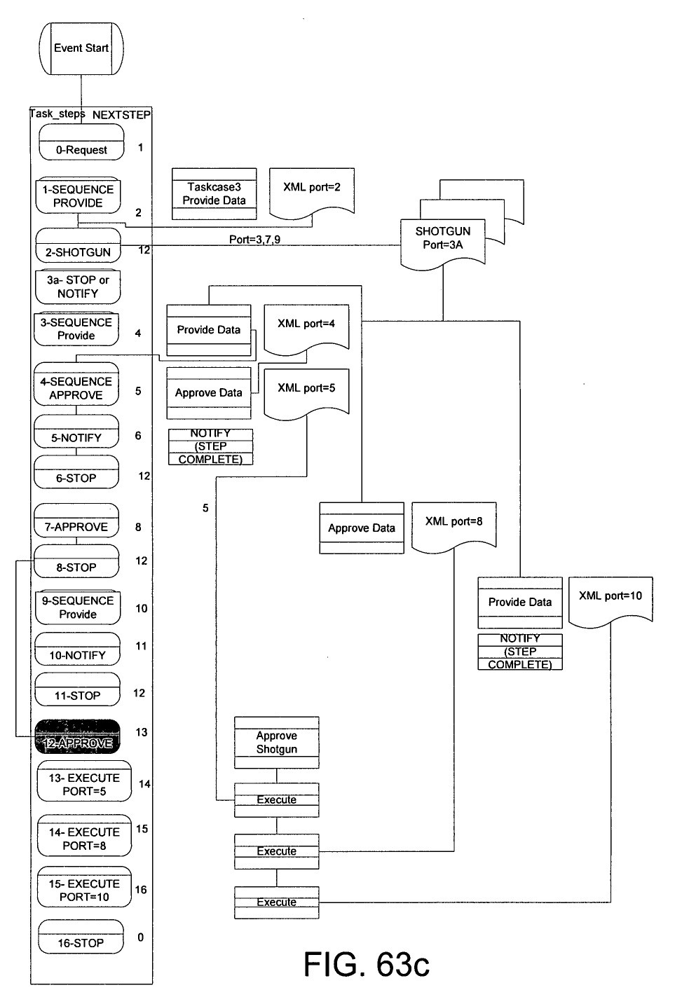

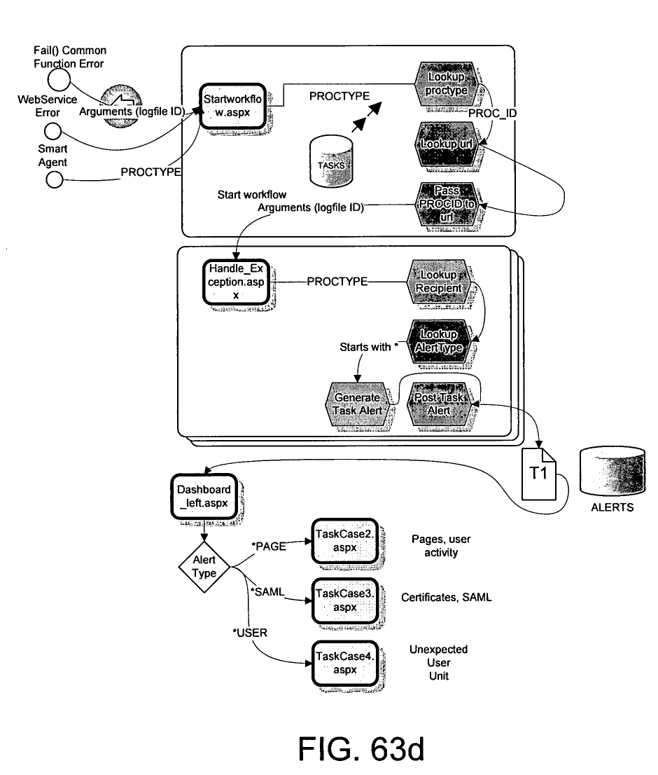

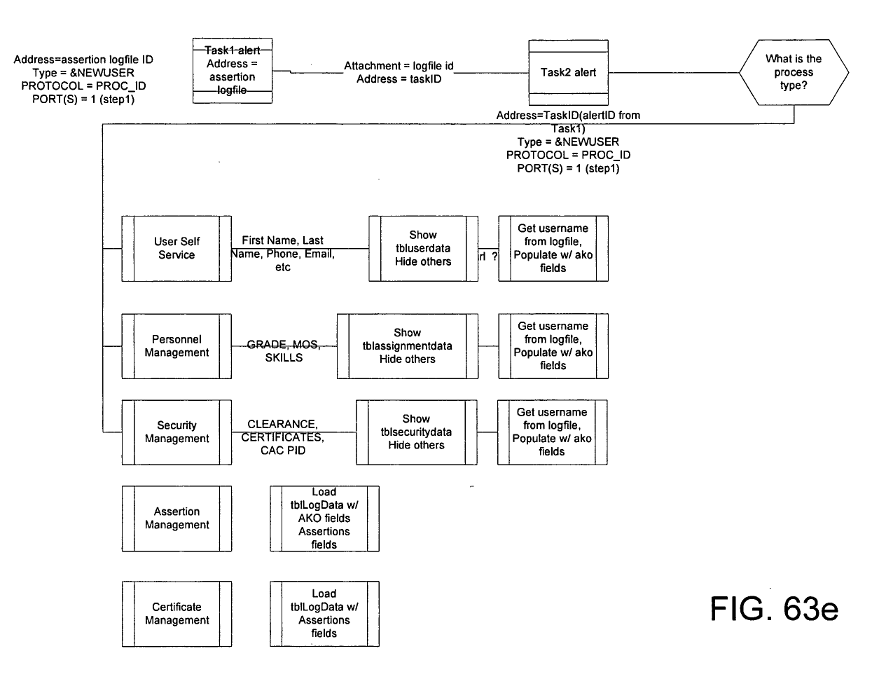

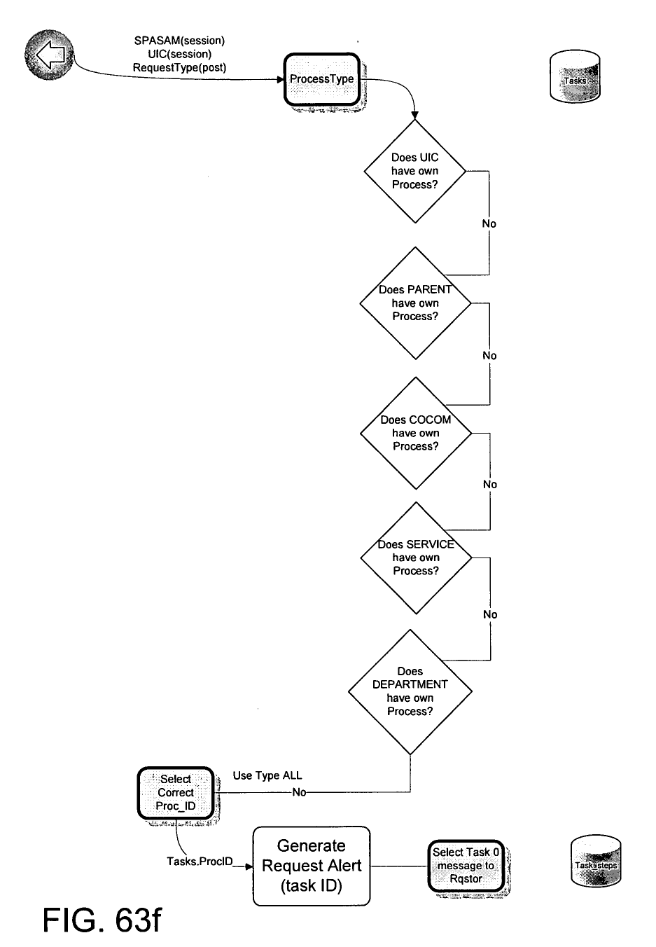

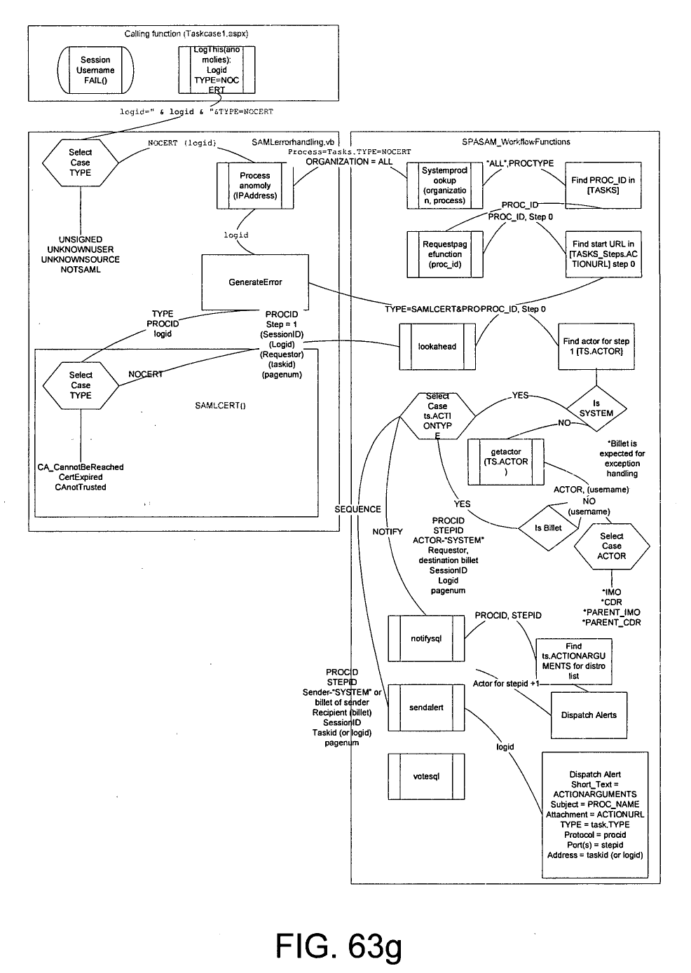

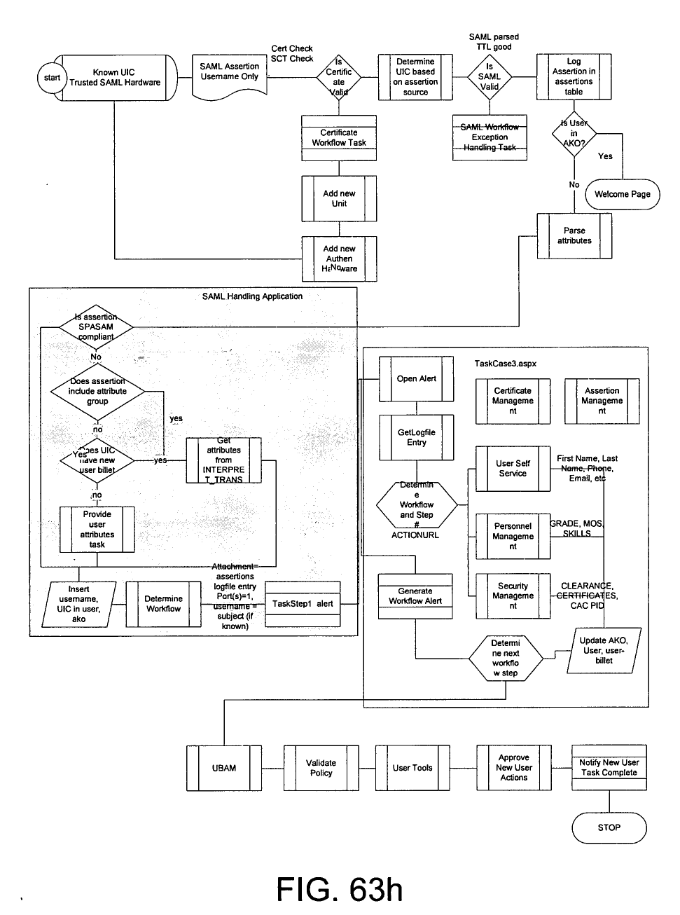

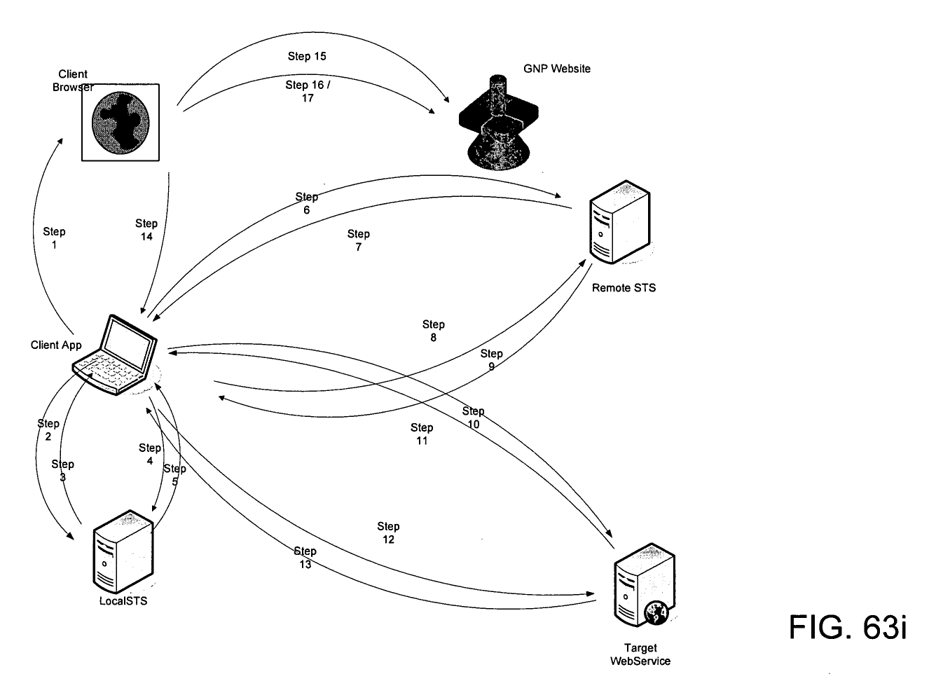

The art of securely establishing these peer-to-peer connections is described in the definitions of WS-Security (e.g., which includes WS-SecureConversation). This specification leverages the concept of a Security Context Token (SCT). FIG. 63i illustrates an exemplary process for the distribution of an SCT via the Security Token Servers that may exist across an enterprise. This employment is consistent with the WS-Security specification, but allows for an authoritative provisioning of web services. The requestor employs the Hyptertext Transfer Protocol (HTTP) to request a validation token from their local STS which is presented to the J-SPASAM engine. Access to the desired web service is negotiated using a second STS which is providing access control for the web service. When the process is completed, the requesting application gains direct communication with the data providing resource. The exemplary embodiments of the present invention include the novel feature of role-based access control and its definition of authority to serve as a centralized distribution point or provide for decentralized SCT distribution by providing authoritative configuration decisions. The exemplary embodiments of XACML messaging to convey these decisions, attributes of the subject (e.g., user) and the resource (e.g., hardware or tool as appropriate) provides for standardized communication with other systems. The exemplary system further uses the subscriptions table (FIG. 48) to resolve this point to point architecture.

System: Join Tables (FIG. 15).

There are over 90 exemplary tables according to the exemplary embodiments of the present invention that together provide full functionality to the web-users, administrators, and system operation. Some of the tables serve as ‘data lookup’ (e.g., VA=Virginia, OH=Ohio) and are not described in detail in recognition of the relevant art of database driven website design. Some of these lookup tables retain user preferences and system settings and therefore are only described in the data definition figures provided. In the standard vernacular of a relational database, there are tables that include information and then there are tables called join tables that allow relationships between other tables. The exemplary engine is designed so that there are join tables. The following describes how these tables are populated and the way the tables relate to each other (FIG. 15).

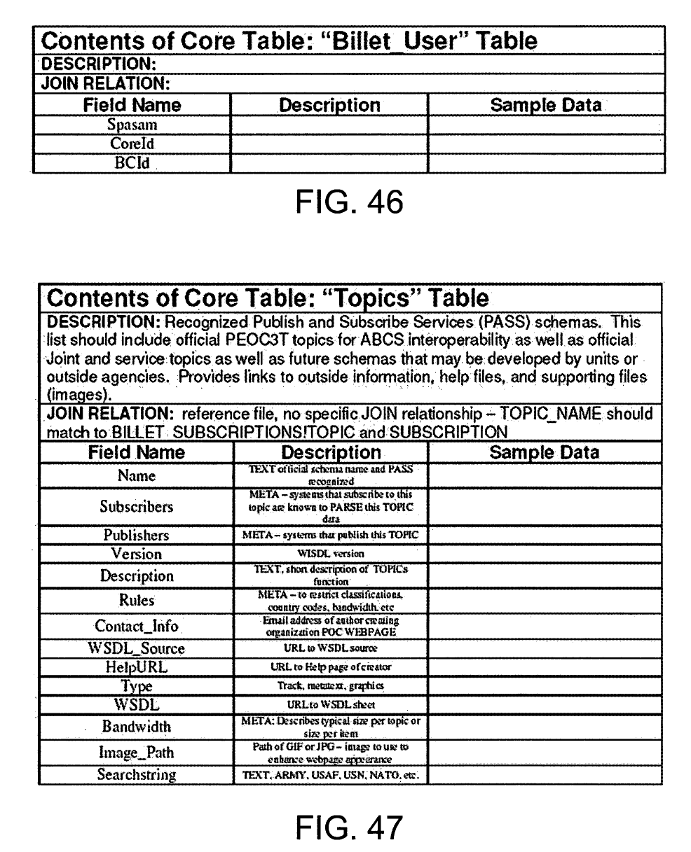

Joining Users to Billets. The number one connection or joining of information occurs with the identification of which user is in which billet. For example, when John Doe gets hired into a company as Senior Vice President of Operations, Senior Vice President of Operations is the billet and the fact that John Doe works in that position means that John Doe is in the Billet-Users Table (FIG. 46, and FIG. 15, element 1501). The exemplary system joins the person, John Doe, into that particular billet, Senior Vice President of Operations. However, the exemplary engine also recognizes that a person can have more than one billet. For example, John Doe may be the Senior Vice President of Operations, but he may also serve as watch officer from time to time. Thus watch officer is an example of a billet that needs to be filled 24 hours per day, but that position is filled by a different person within the organization every eight hours. So John Doe is the Senior Vice President of Operations but he is also the watch officer. This is a complex relationship that the exemplary engine handles in a very unique way. The following exemplary tables join on the billets listed in the billet table and then use this Billet-User join relationship to associate to the actual user at run-time.

Joining Billets/Users to COIs. The exemplary system has a registry of collaborative resources, chat rooms, or other Communities of Interest (COIs) and of the billets that need access into those COIs, including who becomes part of the COI-Users Table (FIG. 39, and FIG. 15, element 1502). The way a user becomes part of that table is based on a decision, which is based on policy. The exemplary system assumes that the authoritative decision has already been made and knows what users are in a particular chat room. A user can have many different chat rooms as part of his list of resources the user needs to do his job. So this is what is called a “many-to-many”relationship that joins users to chat rooms. People can get access to a chat room based on their billets (FIG. 15, element 1503) or based on who they are (FIG. 15, element 1504), regardless of what particular unit they belong to. For example, suppose there is a professor who is a subject matter expert. Regardless of what university the professor teaches in, it may be desirable for the professor to be a member of the weapons of mass destruction chat room. Therefore there is a link between ‘COI-users’ and ‘users,’ indicating that they are additionally allowed access based on their personal identity.

Joining Billets/Users to Tools. The exemplary engine handles Tools in much the same way that it handles COIs. A person needs access to certain tools to do his job and such a need can be fulfilled by the connection between ‘tools’ and ‘users’ based on the ‘billet’ of those users. The exemplary tool-users table manages the association of both billets and individual users to tools. The way the exemplary embodiments work is that for a routine day, John Doe, the Senior Vice President of Operations, would have a list of tools in his ‘Tools-Users’ Table (FIG. 41, and FIG. 15, element 1505). However, when a new situation arises, like a hurricane, for example, additional tools may be granted to him. Thus, the exemplary system can add additional records into the Tools-Users Table so that this particular billet (FIG. 15, element 1506) is going to be given different tools. The user himself does not matter. In other words, during this hurricane, John Doe himself may be victimized and cannot go to work to be the Senior Vice President of Operations. The organization finds someone else to fill the billet during this emergency and thus this new person now has access to all of the tools that that billet needs.

However, there are some tools which, based on the user's preferences (FIG. 15, element 1507), the user may want to use regardless of what duty the user happens to be filling. This is like a “my favorites” or “preferences” type of relation, that being the one between users and tool users. For example, John Doe as VP of Operations may have access to accounting files, but not to Doppler radar. However, if the user interested in the weather because the user's parents live in a weather-sensitive area like coastal Florida, the user might make Doppler radar for that area part of “my tools.”

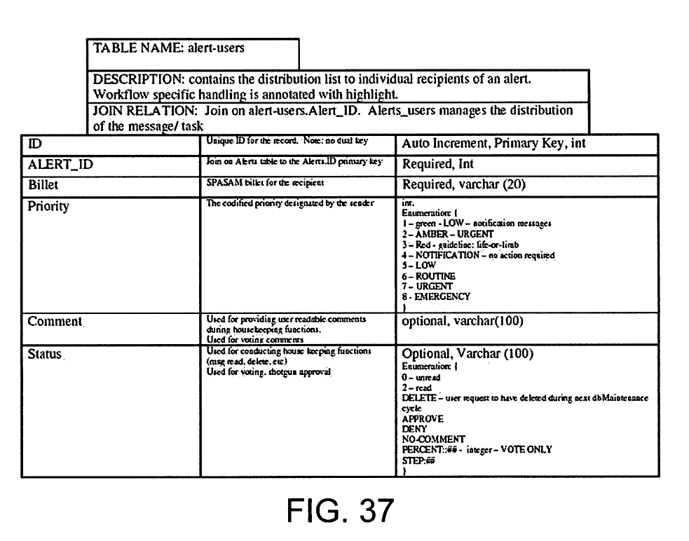

Joining Billets/Users to Alerts. Alerts are dispatched primarily based on billets and they are joined using the Alerts-Users Table (FIG. 37 FIG. 15, element 1508). Suppose every mayor in the state needs to be alerted about a particular situation. The exemplary system makes the assumption that alerts are executed based on a duty position. However, because of the billet-user relation described above, a person can, piece by piece, find a particular individual to alert. Thus, the exemplary engine need not preclude the ability to give someone an alert based on “who” that person is, based on his or her user identity. The other unique feature to doing it this way is that if the billet happens to be the watch officer, when John Doe fills the role of that billet, John Doe inherits those alerts from the previous shift, the workflows that came with that shift, and new alerts for the current shift. In essence, no matter who the watch officer is, the watch officer receives the alerts and has access to past alerts.

Joining Billet/Users to Groups. A role may necessarily be a member of a group (e.g., previously defined as a community of interest—different from the COI described above which is specific to the association with a ‘channel’ on a collaborative tool). These groups are used for four purposes: to define a particular role's ‘relative enterprise’, to serve as a pick-list of commonly used roles, to define a community of interest (e.g., which can then be referenced in the creation of ‘black core’ encryption keys), and to enable LDAP transformation.

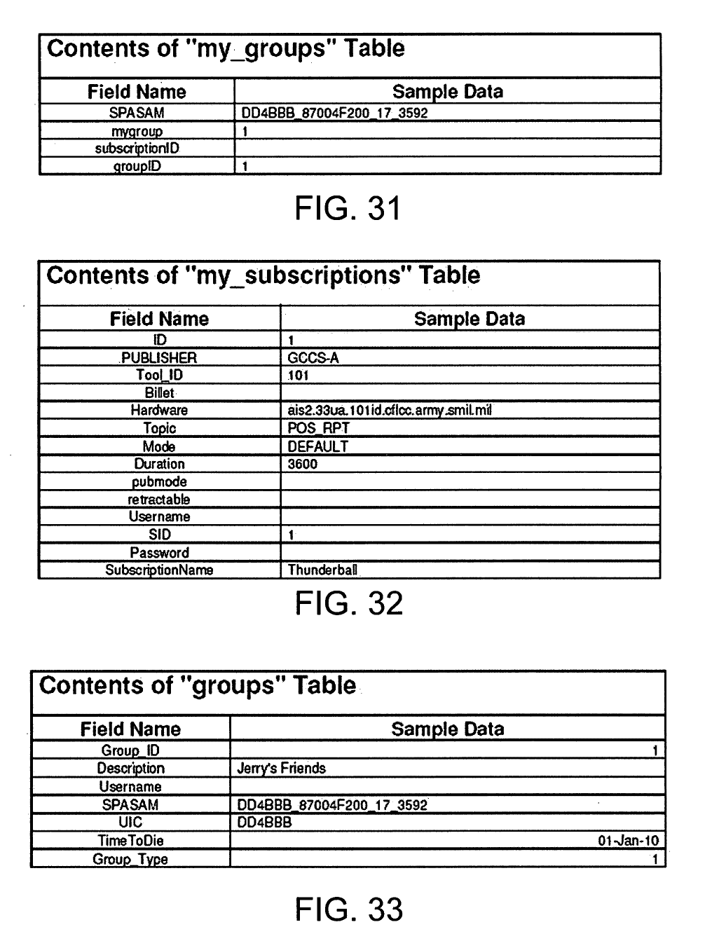

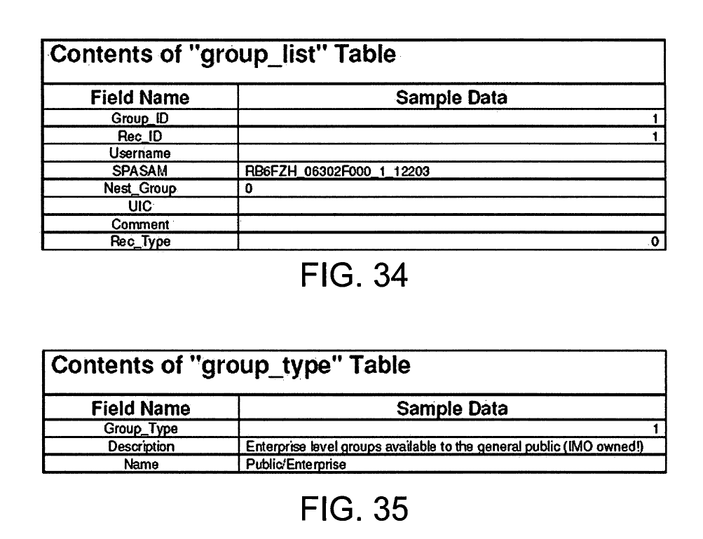

The ‘groups’ table (FIG. 33, and FIG. 15, element 1509) includes all of the individual groups, their description, and purpose. The billets, units, nested groups, or individuals included within this group set are enumerated in the ‘group_list’ table (FIG. 34, and FIG. 15, element 1510). The ‘group_type’ table (FIG. 35) maintains the purpose of the group within the exemplary embodiments. The billets that may use this group, for the exemplary purposes described below, are enumerated in the ‘my_groups’ (FIG. 31, and FIG. 15, element 1511) table. This unique capability of the exemplary embodiments allows collective and/or distributed management of a group, its composition, and ‘sharing’ with many billets.

Defining the ‘relative enterprise’ is employed to provide scope to a particular billet—in an effort to avoid information overload. As an example, from a governor's perspective, ‘the enterprise’ includes counties, state agencies, and select federal organizations. To a local police chief, however, his enterprise could include city organizations, state law enforcement, and organizations within neighboring counties. For example, during Hurricane Katrina, the local police chief's enterprise quickly expanded to include unexpected organizations, such as: FEMA field teams, National Guard units from distant states, Coast Guard, or church groups. The unique capability of the exemplary embodiments of the present invention to rapidly expand and contract the numerous ‘relative enterprises’ can be advantageous to emergency federation management and virtually impossible with existing Federated Identity Management products.

The importance of Community of Interest Groups has been discussed. A main advantage of this unique role based feature is—the groups can be defined irrespective of the individuals that occupy the duty positions. Access control policy (e.g., including alerts, tools, etc.) and ‘black core’ encryption keys can be applied to this type of group.

Transformation Groups are almost identical in composition to directory services (e.g., LDAP) groups in that they are defined by individually selecting the members (e.g., versus a sort on attributes) without regard to a selection methodology—except that they are defined by billets instead of actual users. The billet-user association is made at run time. The purpose of transformation groups however is twofold: to bridge the attribute gap that LDAP driven systems may not make to billets; and to transform one LDAP group name to match the group name on another domain. As an example, a police station domain may be configured to provide provisioning according to: detectives, traffic, swat, administration. Assertions made based on these groups is common in other Federated Identity Management products—but are cumbersome to match to other domains—configured independently. The neighboring police station may be configured as such: DET, MOTORCYCLE, SQUADCAR, ACCIDENT, INCIDENT_RESPONSE, and PUBLIC_AFFAIRS. To a human, although this transformation may be relatively apparent, the exemplary embodiments of the present invention make it possible by providing the transformation for the domain controllers. These can be matched one-to-one or based on the billet attributes. For example MOTORCYCLE, SQUADCAR, and ACCIDENT groups would likely transform from the second domain to ‘traffic’ in the first—based on the Standard Duty Title Codes, and occupation of the billets.

The final type of group is the ‘picklist’. This can be a collection of billets assembled based on user preference to facilitate ease of use of the exemplary embodiments of the present invention. These can be ‘shared’ with other billets across the enterprise—to quickly assist with coordination. In the Hurricane Katrina example, the IMO within the police organization can share one or more of his ‘picklist’ groups with the IMO's in the supporting National Guard units to quickly facilitate information sharing between organizations that are unfamiliar with the other.

Clearly, a user in a duty position needs access to tools, to COIs, and to alerts to do their jobs, regardless of the identity of the person filling the billet. The exemplary system has a process called the batch process. The batch process has a predetermined list of billets that need access to a predetermined list of tools, COIs and alerts. So when this batch is invoked based on the current situation, the exemplary system can add records to the Tool-Users Table (FIG. 41), the COI-Users Table (FIG. 39), and the Alerts-Users Table (FIG. 37) to facilitate the user in doing his job to help deal with the given situation.

The program code to manage, engage, and disengage batches is rather complex as these ‘pre-planned associations’ should be carefully overlaid into the previously described join tables. The following eight tables may be considered ‘lookup’ tables that modify join tables: batches_alert_users, batches_alerts, batches_coi, batches_coi_users, batches_tool_policy, batches_tool_policy_save, batches_tools, and batches_tools_users. When invoked, the batch (e.g., defined by the parent ‘batches’ table) overlays records into the run-time tables as the names imply.

System: Subscriptions (FIG. 15).

Subscriptions are a powerful capability. They allow users negotiated access into the actionable data domain and help with enterprise configuration management and bandwidth throttling. The core of what the exemplary system does with regard to the Actionable Data Domain lies in the Joint Subscription Proxy Agent (JSPA). It maintains a list of all subscriptions. Subscriptions are those data feeds that a person needs to make their “box”, essentially a computer, work correctly. The needed subscriptions are going to change based on the given situation. These subscription based services include traditional publish and subscribe services (e.g., the Army Publish and Subscribe Service=PASS) which use an intermediate ‘topic distribution server’, RSS (Really Simple Syndication) feeds, and direct client-server web services negotiation via Security Context Tokens.

The exemplary Joint Subscription Proxy Agent is advantageous. For example, suppose the Senior Field Artillery Targeting Sergeant needs to be subscribed to two pieces of hardware/places, one is AIS (e.g., located at 34id.monmouth.army.mil) and the other's location is at majorgadget.com during the default operation. These pieces of hardware are the servers that hold the information. They can be listed in the Hardware Table (FIG. 30); that is why there is a link between the Subscriptions Table (FIG. 48) and the Hardware Table (FIG. 30) in the diagram. The subscriptions of his default topic (e.g., a preconfigured Extensible Markup Language (XML)) message that adheres to an extensible format) (FIG. 47) prescribe that to do his job, the Senior Field Artillery Targeting Sergeant needs to have the position report, a topic, that is being produced by one particular system, a position report from another system, and the enemy situation and the graphics included a third system.

These topics are being hosted on the server and the way the subscription works is that the person typically subscribes himself to the topic. “Enemy Situation” is an example of a topic. Anytime information within the topic changes, the person subscribing to the topic is going to get an update for that particular change. Clearly, this is a great way of connecting people to raw data when done by a trusted proxy agent. The way these people use that data is up to their application, but the exemplary engine can maintain a registry of known “topics” (FIG. 47). The supporting tables allow for any suitable extensible messaging method using a publish and subscribe architecture to pre-plan such that for any suitable topic, for any suitable type of preconfigured situations, there is an architecture of information on the exemplary system that is ready to be invoked. Another advantage is that if a user invokes the JSPA, the exemplary engine can execute the join command or the subscribe function on behalf of that user. In other words, though they could, the users do not have to set up the tools or topics themselves. Rather, this set-up and subscription process can be done in coordination with the Information Manager, who knows what information is required for the operation and where the information needs to come from and the IT professionals, who know where those servers are located and know how to negotiate access to them. Fortunately, the average user does not have to know all of that information. The user has to “click on the subscribe button” and it can execute the JSPA function and those subscriptions that are employed for him to do his job can be subscribed into the AIS box. This is a great and flexible capability. This process is similar for RSS feeds and SCT brokering.

There is also the implied unsubscribe function. The exemplary system can unsubscribe a person from a topic when bandwidth becomes critical and a limited commodity. The exemplary system can unsubscribe those billets for which it is not absolutely necessary that they have the particular information. Instead of subscribing them to top-tier, priority one information sources or the hardware that holds those topics, the exemplary system can subscribe them to a second tier. As this hierarchy flows down, there is always latency, but it allows the Information Manager, based on the particular user's attributes and the current situation, to unsubscribe someone by proxy. The JSPA gives the user the ability to subscribe his box by proxy, but also gives the exemplary engine the ability to manage the network with preconfigured routines that can subscribe and unsubscribe those users without their consent. Subscription and unsubscription are invoked by another series of exemplary tools.

The other capability that comes with subscriptions is that of enterprise monitoring through the Subscription Status Tool (SST). The SST process looks for and queries each of the information nodes (e.g., the AIS servers) and ‘asks’ them what topics are currently being hosted. There are no existing definitions which would preclude anyone from publishing any suitable type of new topic. Examples of those might be a position report that is being published by majorgadget.com. Majorgadget.com is producing the position report, but it is not part of the prescription that was originally configured as part of the default architecture. This position report from majorgadget.com appears when the user clicks on the refresh and thus executes the subscription status tool and performs the SYNC command. This results in the obtainment of information about all the suitable topics that are on the server.

This subscription function also provides a filtering capability. Thus if unexpected information is not part of the “prescription” then the user is not necessarily going to be allowed to have that information. This is beneficial because as different topics are developed, the Information Managers have the ability to manage who is going to subscribe to it so that users do not encounter configuration problems. For example, suppose the Air Force decides to create a “weather” topic, complies with all the suitable PASS specifications, and publishes weather data to a PASS service. This information shows up as a “weather” topic. When another user clicks the refresh button and the SST is invoked the user can see that there is a weather topic. However the applications that this user has loaded onto their computer might not be designed to process that weather data correctly and consequently the user's box will not function properly. The exemplary system allows Information Management Officers to control this information and keep these problems from happening. In essence, this capability of enterprise configuration management allows for the management of the workload of each of these servers and management of where information is published. If for some reason a server goes down and publishers need to get their information out, they can redirect using the “publish by proxy” agent and the Information Managers can control where publishers are publishing. Further, the exemplary system allows the data producer to query the exemplary system to obtain information about the subscriber and can thereby filter the information they are providing accordingly. Accordingly, the exemplary system has exemplary capabilities, including the subscription proxy agent, the publishing proxy agent, and the SST, which allows for monitoring of those unknown or unexpected topics that may arise.

System: SPASAM Enabled Tools

This is a description of the Single Sign-On methodology enabled by SAML and uniquely employed by the exemplary embodiments of the present invention. There is a client-server capability that negotiates the access between a client and a server or between the subscriber and that information node. In this case, the exemplary system allows the J-SPASAM enabled subscriber to subscribe to a publish-and-subscribe service. However, it can also use a similar capability to subscribe any suitable functioning client to that information node. For example, in addition to the application data domain there could be a chat client. So in this case, a Thin JAVA chat client is being subscribed to the chat server. When that client needs to be invoked, the negotiation method needs to be pre-established with the server to ensure that, when invoked, the server will allow the connection, to ensure that the particular resource or chat room exists, and to ensure that the configuration data and a token are passed to the server. Once the client has been initiated and has acknowledged that a token has passed to the client and the redirect information about the location of the information node and the token have finally passed to the client on where its information node is, along with the token. In this example, the J-SPASAM enabled resource knows how to listen not only for instructions from the J-SPASAM engine but also from a J-SPASAM enabled client, which is going to pass that token. This is a function of the exemplary engine that can be conducted outside of the exemplary engine itself, but is essential to providing security and single sign-on. In this way, the exemplary engine can negotiate access and make the applications work. This is a unique capability that the exemplary system provides.

The exemplary system also introduces a “node” report as a topic. This is a preconfigured topic established on the publish and subscribe service. Basically, it is a particular publisher's way of notifying the network that it exists, and announcing that it is publishing information or that a user's box should be a subscriber but is not receiving information. The following are the definitions of the current configurations of a particular subscriber that is waiting on the network. This notification is the sending of a node report. The node report exists for “receivers.” The node report is the only way for an enterprise to know that someone is listening to their data. The beautiful thing about this node report is that it also sends configuration data, which helps trouble-shooters to configure the myriad of settings that have to be accurate to make the boxes in the enterprise work.

J-SPASAM-J-SPASAM ‘Dead-Drop’ Federation

The exemplary engine is designed to be deployed in a clustered server environment—providing segregation of data tables, internal modules, and web page hosting onto different servers for performance and security. The J-SPASAM engine is also designed to communicate with other J-SPASAM engines to create a seamless enterprise environment between agencies (FIG. 60). Large organizations or agencies that find it necessary to employ their own J-SPASAM capability to address security concerns or to better facilitate the needs of their subordinate organizations can use this feature to allow for inter-agency federation. The exemplary embodiments of the present invention can include a unique ‘dead-drop’ methodology to accomplish this.

The exemplary system is designed to allow for a flexible ‘federation mesh’ where J-SPASAM engines can exchange database information with each other. Each engine can be configured to serve as a ‘dead-drop’ server, or use the methodology to synchronize directly with other engines, or synchronize via the ‘dead-drop’. The exemplary system provides web-based controls to allow Information Managers and IT specialists to manage this configuration quickly and securely.

As a background, common security practice dictates that web service calls may be originated from within a closed network—but unsolicited requests are blocked. A J-SPASAM engine can serve as a ‘dead-drop’ where requests intended for other J-SPASAM engines can be left—virtually anonymously. Participating J-SPASAM engines initiate queries to the ‘dead-drop’—checking to see if there are pending service requests intended for them—maintaining a degree of anonymity.

The need for this comes from differing organizations need to control disclosure of their organizational structure, network resources, and even the network address of these resources. Yet, these reclusive organizations have relevant information they may desire to share in certain situations or a need to participate in a federation with a degree of anonymity. The J-SPASAM engine provides Information Managers with a mechanism to tightly control: who information is being shared with and if necessary coordinates for more direct collaboration. These choices are made entirely by the participants ‘need to know’—which is based almost entirely by virtue of the positions they hold. The federated trust that is established through Federated Identity Management practices when coupled with a way to find and only share with the occupants of certain duty descriptions—mitigates the risk of sharing.

It is difficult for people, let alone computers, to share information in such an obscure environment. The mere discovery of other organizations and the duty positions they choose to disclose to is a challenge that is hereby necessarily addressed. The exemplary embodiments of the present invention provide for tight human intervention in processing these requests between organizations. The exemplary system also provides for two-party confirmation of these processes when necessary—by employing the workflow processing described later.

At a high level, this method is using secure web services to synchronize databases typical of the relevant art. The exemplary engine employs a web services based request and response architecture to make synchronization calls to the ‘dead-drop’ server—which serves as a ‘cut-out’ in the exchanges. There are two categories of message requests: protocol messages and synchronization messages.

Protocol messages are cyclical messages that ask synchronization questions to the destination server. Like a heartbeat, these web methods are executed periodically to check for incoming requests. These web methods include:

Heartbeat_System( )

Returns true/false

Question: Do you have any inbound system messages for me?

Heartbeat_UIC(string UIC)

Returns true/false

Question: Do you host (one to one or by proxy) this organization?

Heartbeat_UICInfo(string UIC)

Returns true/false

Question: Can I access this organization's basic information?

Heartbeat_UICBillets(string UIC)

Returns true/false

Question: Can I access the list of billets for this organization?

Heartbeat_Alerts( )

Returns true/false

Question: Do you have any inbound alerts for me?

Heartbeat_Future((future))

(place holder for synchronization of database elements (e.g., Tools, groups, etc))

Returns true/false

Question: Do you have the response to my previous query?

Once the protocol messages establish that the requested data is available, the following web methods provide for receiving and transmitting requested database information:

Get_Message(request_id)

Description: Get the data I requested earlier, which was confirmed that it was available in message (request_id).

Send_Message (request_id)

Description: This message includes data that was requested earlier in message (request_id)

Get_UICInfo

Description: Get the data I requested earlier, which was confirmed that it was available in message (request_id).

Get_UICBillets

Description: Get the data I requested earlier, which was confirmed that it was available in message (request_id).

Search_UICInfo

Description: a query message that enables J-SPASAM servers to ‘learn’ from each other about the constitution of the enterprise and for Information Managers to establish the operational information mesh.

These web methods need not be all encompassing, but are representative of those that are unique and employed for providing a role-based enterprise.

Role-Based Workflow

This capability is unique to other Business Process Modeling capabilities in that it incorporates the role-based methodology of the J-SPASAM engine, along with its ability to interact across the alerts information domain. A workflow is a definition of the process on how requests and information are handled between people (FIG. 63a). The Business Process Execution Language (BPEL or BPELWS) is a standardized XML language used for transmitting these definitions. This language is employed by the J-SPASAM engine, where possible, to interpret and establish workflows between federation partners.

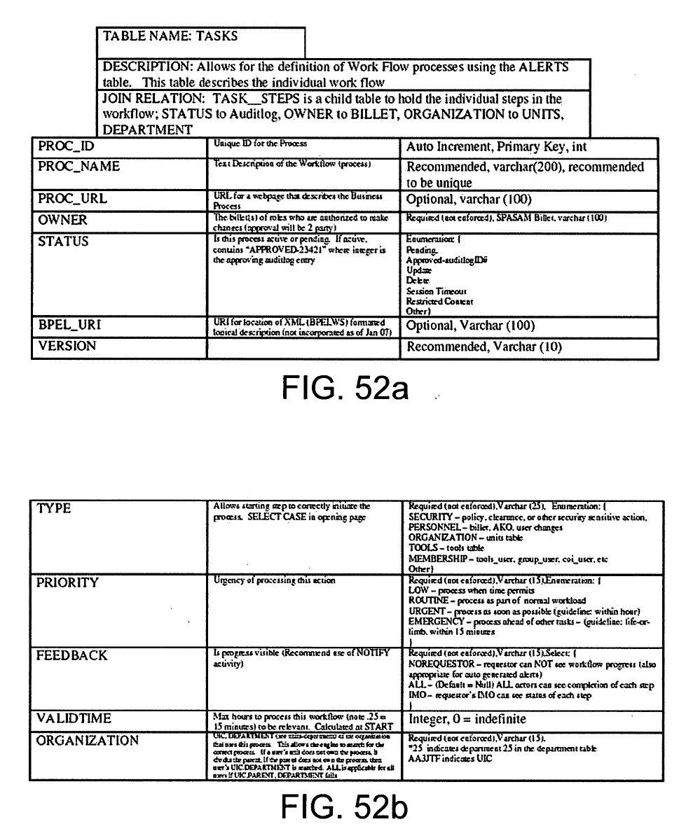

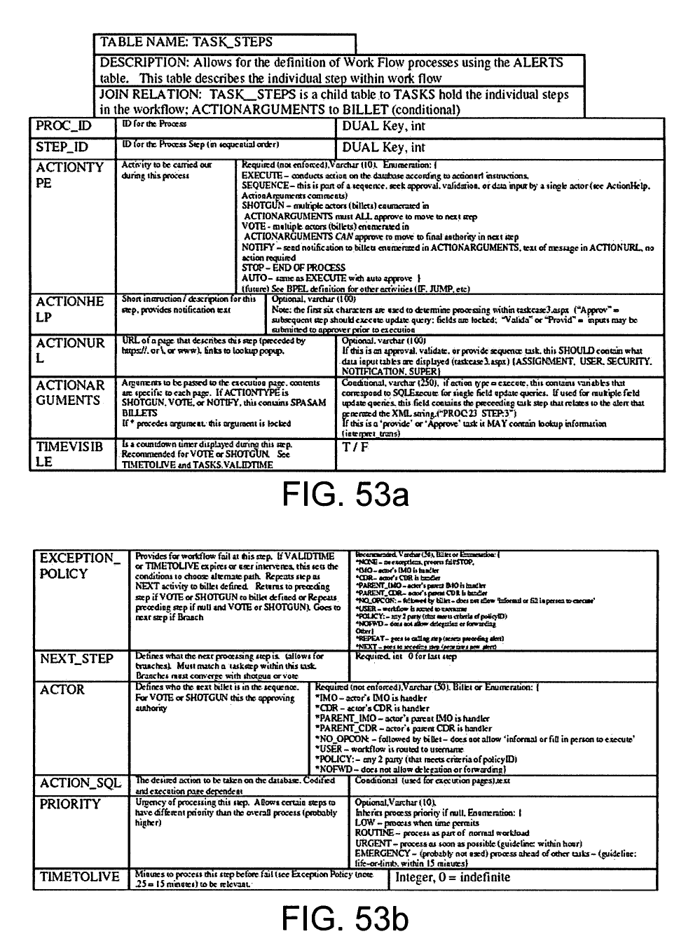

The J-SPASAM engine maintains these workflows in two tables, ‘TASKS’ (FIG. 52) and ‘TASK_STEPS’ (FIG. 53) to allow organizations to define how requests will be handled, particularly when human intervention is required (FIG. 63b). There is a need for these workflows to resolve the actor based on specific billets or more generic roles (e.g., such as the IMO or ‘the parent IMO’) throughout a federated enterprise. Therefore, the exemplary embodiments of the present invention can include the internal role-based capability to define: positions that are involved in a process and a flexible rule set to allow the workflow to diverge when necessary. In emergency situations, this divergence from a plan is a fact of life—the exemplary system allows for the preplanned workflow to flexibly adapt—based on its unique ability to define authority and policy—and manage the information architecture in the face of adversity.

The J-SPASAM engine utilizes its internal system to leverage the alerts information domain to expedite prosecution of the requests. As steps within the workflow are completed (e.g., approved, denied, deferred), the exemplary system processes these ‘taskalerts’ through the alerting system according to the workflow owner's preferences (FIG. 63b). This workflow may include sequential data entry steps, approvals, notifications, database updates, and branch steps (FIG. 63c) that run simultaneously (e.g., voting, and shotgun approval). This recognition that people may not always be fixed to a computer workstation, allows the alerts system to extend the federated information architecture—in this case, workflows—to users who have relocated to an austere environment like an incident site.

There are basically four categories of workflows: exception handling (FIG. 63a), request processing (FIG. 63e), federation learning (FIGS. 63h, 63i), and system alerting.

Exception handling includes processes where user intervention is employed to provide or validate information to maintain optimal user performance or maintain federation trust. Examples of processes that fit into exception handling are: in-processing an unexpected user or organization to the federation, or adding a new tool (e.g., website, collaboration tool, etc) to the internal catalog of enterprise resources. As an example, the exemplary system may receive inadequate assertion information from a federation partner regarding a new user. While the organization and the device may be trusted (e.g., by virtue of legal agreement with the federation and installation of PKI certificates respectively), the user is joining for the first time. The exemplary system initiates a workflow, unique to the organization or the sponsoring department (FIG. 63f), to collect more information about the user's assignment within the organization, their occupation, special skills, clearances and the like. Because this collection and authorization process may involve different roles, the workflow functionality steps through the task, allowing different roles to provide information and validation (FIG. 63g).

This capability is used to provide the framework by which the legal agreements can be articulated (e.g., the federation membership may require that two-party approvals and a final certifying authority be used to add new members). This unique method of role-based workflow definition and alerting provides an unprecedented speed and flexibility—but more advantageously—provides a method by which disparate organizations can enter into a federated relationship with an acceptable degree of confidence in sharing information.

The second category, request processing, is similar to exception handling in its execution, however, the process is user initiated.

The third category, federation processing, is a powerful method of providing the operational community a mechanism to maintain authoritative control of the information processes necessary for federation learning and information sharing. Federation learning is a form of artificial intelligence with human intervention. Therefore, the exemplary system uses its internal alert processing capability described previously, the dead-drop communications capability to ‘federate’ one J-SPASAM instance with others, the transformation capability to interpret various organization definitions and allow other FIM products to be used, and the work-flow capability to establish flexible intervention points.

Dead-Drop communications and transformation provide the artificial intelligence aspect. As an understandable example, a J-SPASAM federation server dialogue might equate to the following:
Server: DHS1—“GulfCoast1, Do you know about this unit: the Mobile Office of Emergency Management? From (IMO-FEMA Team1)
Server: GulfCoast1—“I don't host them, but I know who does. Let me contact them for you?
Server: GulfCoast1—“Alabama1, IMO-FEMA Team1 would like your unit information.”
Server: Alabama1—“pass the credentials for the requestor”
Server: GulfCoast1—“DHS1, credentials for IMO-FEMA Team1 required to process request”
Server: DHS1—(credentials for IMO requests set to auto respond by workflow) “Credentials provided”
Server: GulfCoast1—“credentials provided”
Server: Alabama1—(human intervention to review credentials, approve transmission of response)-“unit information provided—valid for 4 days.”
Server: GulfCoast1—“unit information provided”
Server: DHS1—“Alabama1, request IMO, Mayor (commander), Public Safety, Comptroller, and Emergency Management billet information”
Server: Alabama1—(human intervention to approve transmission)—“IMO, Emergency Management billet information provided”
Server: DHS1—“IMO, Emergency Management billets will be granted access to the following tools: FEMA ‘Hurricane Victor’ web portal; Region4 Relief Supplies chat room, and the IMO will be granted access to the: ‘Hurricane Victor’ collaborative tool suite for IMOs”

This dialogue is affected via secure, signed web services but illustrates the following features: select anonymity as chosen by the data provider, intermediary servers affecting enterprise learning, quickly providing human intervention points, progression towards peer-to-peer authentication/federation.

In numerous scenarios, this anonymity is desired—however trust is required to ascertain that the anonymous individual is authentic, and that the organization is vouching for their personal and billet credentials. Unsolicited sharing by access control, illustrated above, is only possible when: the federation can expand and contract, roles can be ‘discovered’ and user association confirmed, and most advantageously that humans are provided a mechanism to quickly share information, mitigate the risks associated with sharing, as well as manage information overload.

The fourth category of workflow is system alerting. Also similar to exception handling in the prosecution of the workflow and the fact that the process is initiated by a system event, the exemplary system alert is the J-SPASAM engines way of communicating with its administrators. Intrusion detection, database errors, unexpected page errors, routine maintenance requests are examples of events that employ intervention by qualified personnel.

System: Billet Resolving Service

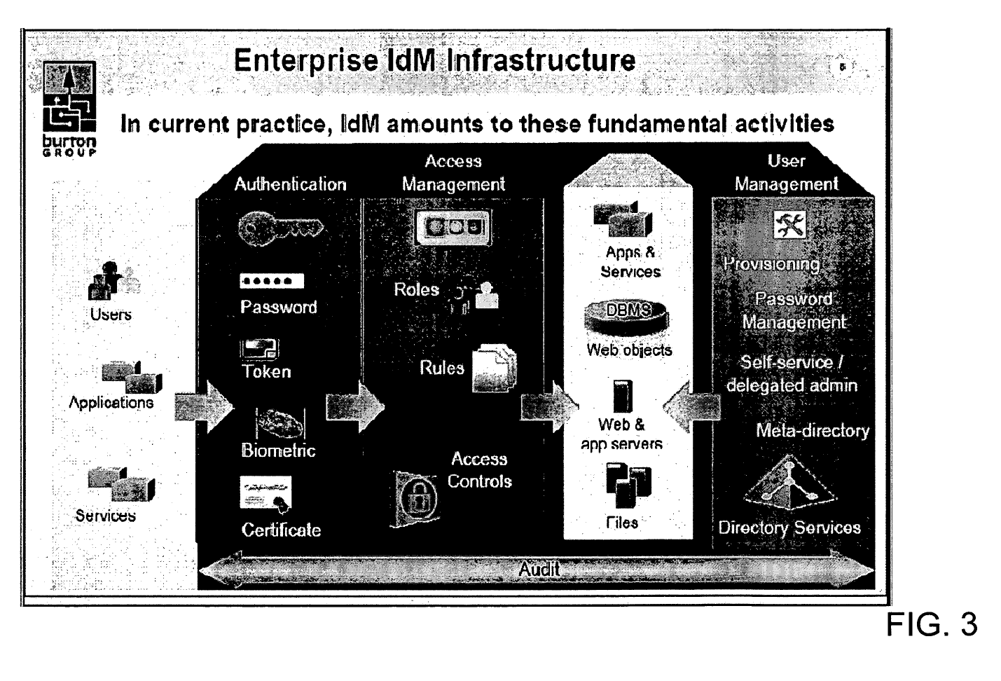

As the name implies, this feature is enabled through secure web services. The importance is that it bridges several gaps in the Identity Management construct (FIG. 3) where conventional FIM solutions are employed.

The J-SPASAM engine bridges these gaps by combining the core capabilities of other applications that are connected to the enterprise network via SOAP messaging. As previously discussed, there is a capability void in the enterprise Access Control infrastructure to adequately define roles and correlated rules (e.g., policy). For the full integration to be accomplished, the J-SPASAM engine should ‘re-use’ authoritative information from across the enterprise. These information sources include: Public Key Infrastructure (PKI)—particularly Certificate Authorities; Personnel Management services, Authentication Services, and Assertion Services. These services are combined by the exemplary engine to resolve questions about access control policy for target resources. Communication with these resources is accomplished with SAML assertions, XACML dialogue, and web-services defined specifically for the exemplary system. These messages are conveyed between network devices on a ‘back-channel’—whereas the conventional user and even the IMO do not directly see them.

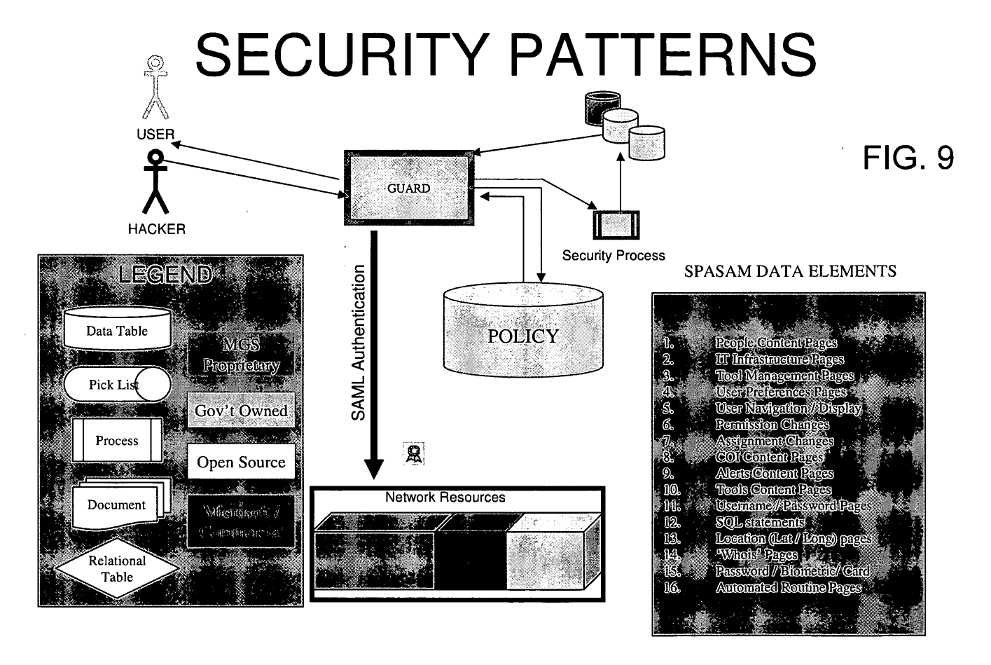

As mentioned, enterprise resources may include websites, portals, collaboration tools, shared folders, and even admittance to a domain itself. Prior to entry, these resources should make a decision on whether or not to permit access. Described later, the J-SPASAM engine can make access control decisions, based on policy established by the tool provider using the J-SPASAM web interface, prior to re-routing a candidate user utilizing SAML to convey both the decision and the identity of the candidate (FIG. 9). This implies that the J-SPASAM engine serves as the Policy Decision Point (PDP) and Policy Enforcement Point (PEP). While this reduces the development cost of the resource, by avoiding policy definition controls, it means that the resource ‘trusts’ the decision making capability and the chain of trust provided by previous assertions implicitly. In many instances, where the information is relatively benign or the needs of the enterprise may change rapidly—external to the scope of the tool provider, this is completely acceptable.

The Billet Resolving Services, however, come into play when the resource makes its own access control decision. Here the PDP and PEP are performed at the resource. The exemplary embodiments of the present invention provide a novel method by which to make true billet based (e.g., in this case different from ‘role based’) access control decisions. Not only because it serves as a ‘clearinghouse’ for billets across the enterprise, but because of the ‘transformation’ feature that allows ‘LDAP roles’ to be transposed between domains described previously. Other systems have the capability to perform this transformation on a one-to-one basis. Only the J-SPASAM engine can truly transform disparate domain duty positions without this prior coordination.

The first category of billet resolving service is user query. This is used by resources (e.g., including receiving FIM devices) to gain or confirm attribute data regarding a user. For example, if two assertion devices are attempting to re-direct a user (e.g., single sign-on) from one to another—but the attributes are unclear or not included whatsoever, the receiving resource's access control module may query the J-SPASAM server for billet attributes or ‘groups’ that it is configured to understand regarding that user. The response can take the form of a full SAML assertion or a SOAP message including the <ATTRIBUTE_STATEMENT> of the SAML assertion.

The second category of billet resolving service is group query. This is basically the inverse of the user query. Here, a query statement is sent requesting user contact information with a response including federation user's that meet the criteria. This is particularly useful for systems that focus on the alerts information domain. The SAML protocol is impractical for this application, so conventional SOAP messages are used.

Say, for example, that a system wants to send a Common Alerting Protocol (CAP) message to all emergency management coordinators within a defined region (e.g., polygon). The calling system can query the J-SPASAM network using the polygon (e.g., or reference the CAP broadcast message), and standard duty title code. The response can include email, Short-Text Messaging Service (SMS) devices (e.g., cell phones), or pager numbers. Other systems may exist that include predefined ‘call down’ lists and mechanisms to affect this type of alert. Using these, devices (e.g., instructed by J-SPASAM via web services) can be ‘instructed’ to execute the predefined call down (e.g., included within the J-SPASAM system as hardware, tool, and the group). A second CAP message could also be sent to the same geographical region—for all law enforcement members (e.g., based on occupation). A third CAP message could be sent to a community of interest (e.g., group) including decision makers. This query and response is also in the form of a SOAP exchange.

The third category of billet resolving service is group query. It has two variations: one is to respond with which communities of interest (e.g., groups) a user belongs to. The second is, who are the members of a particular group? This query and response is also in the form of a SOAP exchange.

The fourth category of billet resolving service is role-transformation. Here an asserting FIM service or a receiving FIM service can request a role transformation. The transformation capability described previously replaces the need for one-to-one matching and coordination between domains.

The validity of transformation and the billet resolving service may be subject to scrutiny—particularly because of the algorithm's ability to correctly match undefined groups—but also because trust is based on legal acceptance of known standards. Therefore the quality of the transform or billet resolving is also sent where applicable. The following scale is used to quantify the validity of the assertion:

0—verified by outside source (e.g., AKO and DEERS as previously discussed) w/matching CAC info

1—verified by outside source

2—complete assertion from Authentication Source

3—1-to-1 mapping from Authentication source role (Default_Billet approved)

4—approved mapping

5—best guess mapping (MOS, SDT, RANK, NATIONALITY minimum)

6—minimum mapping (NATIONALITY minimum

7—no mapping (e.g., placed in generic billet)

Levels 0 through 4 provide the best assurance that the attributes have been vouched for. Levels 5 and 6 may best be employed by a FIM system that can then perform is own internal ‘workflow’ to map SPASAM transforms to its own directory services ontology. In the case where a reasonable transformation cannot be matched, no transformation is made and the receiving system is ‘advised to place them accordingly into a ‘holding role.’

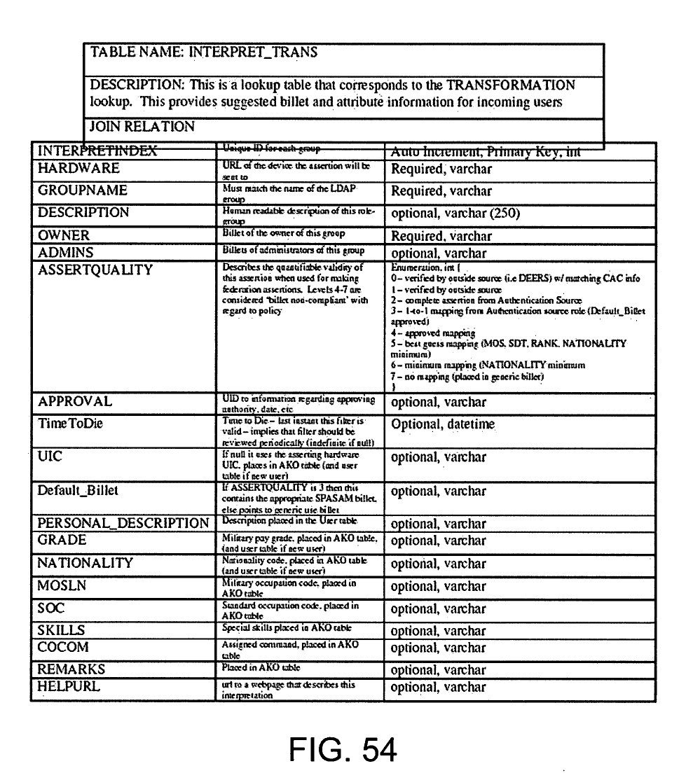

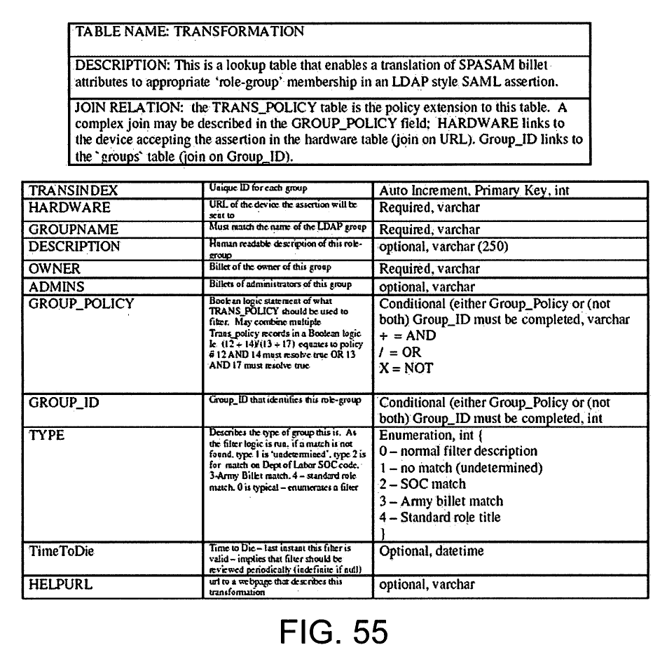

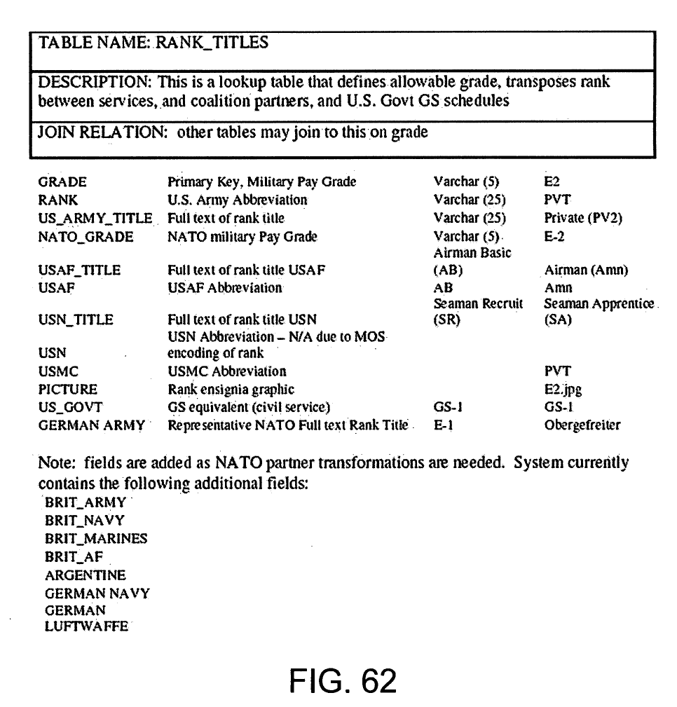

The billet resolving service uses the engine's exemplary relational data to associate users with billets. Transforms are enabled by the INTERPRET_TRANS (FIG. 54) table (e.g., which interprets incoming LDAP roles to billet values), and the TRANSFORMATION (FIG. 55) table (e.g., which relates LDAP group to LDAP group, or group to billet values). Transforming seniority (e.g., rank) assertions is advantageous when bridging different agencies. While the U.S. government has well articulated criteria for promotion to different levels of seniority, the exemplary system provides for a translation of this concept to other established seniority delineations using the RANK_TITLES table (FIG. 62). Corporate entities may use the guidelines described below to select appropriate GRADE values.

Guidelines for Selecting Rank:

The J-SPASAM engine uses a modified version of the U.S. Civil/Military pay structure to imply ‘rank’ or a codified representation of seniority between roles. The military ‘Pay Grade’ directly translates to ‘Rank’ . . . regardless of title.

As an example, an Army or Marine officer with a bachelors degree, 4-8 years of experience, and 6 months of 2^{nd} level professional training is a ‘Captain’ or CPT with a pay grade of ‘O-3’. In the Air Force this pay grade is frequently abbreviated ‘Capt’. In the Navy, however, this is a ‘Lieutenant’ (e.g., the first two pay grades in the Army and Air Force). A Navy ‘Captain’ is an O-6, the equivalent pay grade as an Army, Marine, Air Force ‘Colonel’.

The above example is difficult to convey in the computer world—which deals in absolutes. Therefore, the concept of relative seniority is translated to an absolute—the government pay schedule. The following tables may be used as a layman's guide to interpreting rank within an organization:

| | | | Employment | |
|---|---|---|---|---|
| Rank | Education | Experience | Level | |
| E-1, E-2 | Non-High School | 0-1 yrs | Hourly/Part-time | |
| | Graduate | | | |
| E-3 | H.S. Graduate | 0-1 yrs | Hourly/Full - Part | |
| | | | Time | |
| E-4 | H.S. Graduate | 1+ yrs, | Hourly/full-time | Task responsibility |
| | | trained | (no overtime) | |
| E-5 | H.S. Graduate, | 2+ yrs, | Hourly, rare | Shift/Team Leader |
| | trade school | | overtime | |
| E-6 | H.S./Associates | 4+ yrs or 2 yrs | Hourly, occasional | First Line |
| | Degree or | exper w/ | overtime | Supervisor |
| | Secondary Skill | Secondary skill | | |
| | training | training | | |
| E-7 | H.S./Associates | 3 yrs as E-6 | Writes evaluation | Shift Manager |
| | Degree or | | reports | |
| | Secondary Skill | | | |
| | training | | | |
| E-8 | H.S./Associates | 3 yrs as E-7 | Supervises 3-4 E- | Foreman, Exec. |
| | Degree or | | 7's, job costing, | Secretary/Exec |
| | Secondary Skill | | work scheduling | Asst |
| | training | | | |

Salaried Staff, Secondary/Post Graduate Education

| Rank | Education | Experience | | Employment Level | |
|---|---|---|---|---|---|
| O-1 | Bachelors Degree | 0-1 | yr | Hourly/Salaried | |
| O-2 | Bachelors Degree | 1-2 | yrs | Hourly/Salaried | |
| O-3 | Bachelors | 3-6 | yrs | Salaried/Commission | |
| | Degree, + 6 mos | | | based | |
| | additional | | | | |
| | professional | | | | |
| | development | | | | |
| O-4 | Bachelors (8-12 | 3 | yrs as O-3 | Salaried/Profit | Small Department |
| | yrs)/Masters | | | sharing | head, supervises |
| | Degree (2-4 | | | | 1-3 O-3's |
| | yrs) | | | | |
| O-5 | Bachelors (10+)/ | 3 | yrs as O-4 | Salaried, profit | Department head, |
| | Masters Degree | | | sharing | Supervises 2 O- |
| | (4+ yrs), | | | | 4's/4-6 O-3's |
| | PhD (2+ yrs) | | | | Budget ($600k- |
| | | | | | 1.2M) decisions, |
| | | | | | Small Business |
| | | | | | Owner (2-25 |
| | | | | | employees) |
| O-6 | Masters Degree | 3 | yrs as O-5 | Salaried, profit | Provides business |
| | (10+ yrs), | | | sharing | guidance, small |
| | PhD (6+ yrs) | | | | (25-200 empl) |
| | | | | | business owner, |
| | | | | | Large Corporate |
| | | | | | Vice President |
| O-7+ | Masters Degree | 3 | yrs as O-6 | Profit sharing | Corporate |
| | (20+ yrs), | | | | vision/direction, |
| | PhD (14+ yrs) | | | | Large buis, VP, |

Specialized Technical Skills: pilot, heavy equipment
operator, explosives handler, computer programmer

| Rank | Education | Experience | | |
|---|---|---|---|---|
| W-1 | Associates Degree, trade | 1-2 | yrs | Apprentice |
| | school | | | |
| W-2 | Associates Degree, trade | 2-25 | yrs | Journeyman, |
| | school | | | Skilled, licensed operator |
| W-3 | Associates Degree, trade | 20+ | yrs | Rare skill level/experience (3 or 4 similarly |
| | school | | | skilled operators in population of 2 Million |
| | | | | People |

| | | | |
|---|---|---|---|
| W-4 | Associates Degree, trade | 20+ | Very rare skill level or experience (3 or 4 |
| | school | | similarly skilled operators in population of |
| | | | 10 Million People |

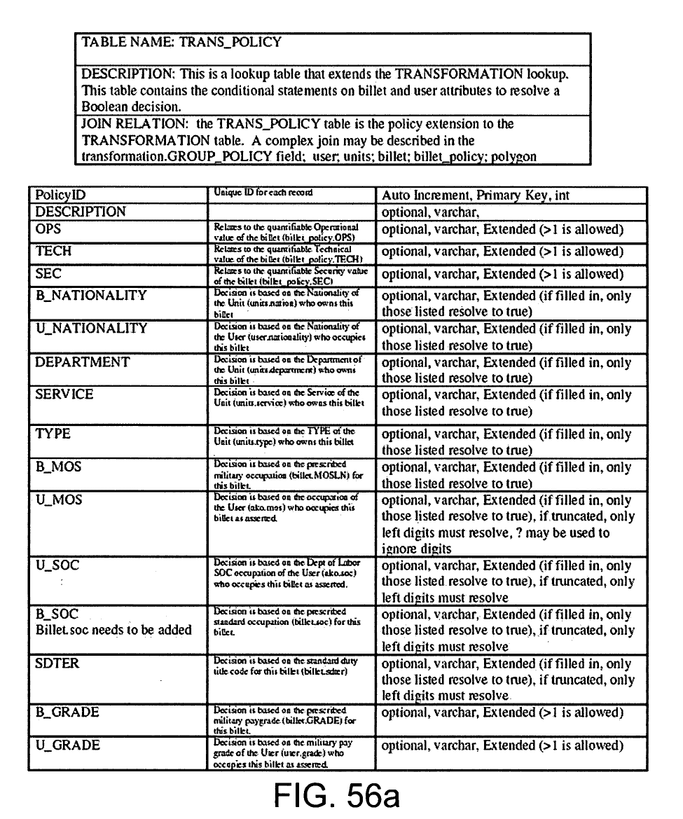

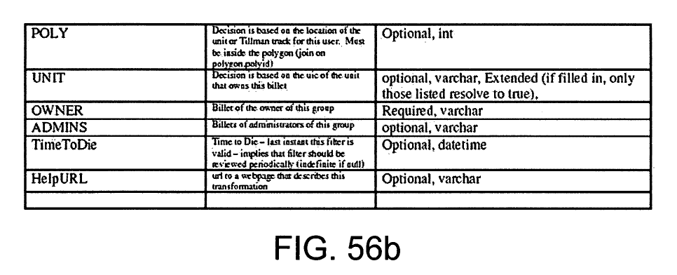

When a direct mapping is not achievable, the algorithm looks to the ‘TRANS_POLICY’ (FIG. 56) table to process intuitive mappings.

To illustrate the process of the transformation algorithm; as in a previous example, one domain (e.g., possibly a state EOC) may have created a group (e.g., LDAP role) called: LAW_ENFORCEMENT. The second domain (e.g., possibly a city) may have created a group (e.g., LDAP role) called POLICE. Humans would intuitively recognize the similarity. The J-SPASAM engine transposes the incoming ‘LAW_ENFORCEMENT’ to an occupation and a standard duty title category (e.g., L*), this is then transformed to the POLICE role of the second.

Currently, this process is possible when federation partners ‘register’ their domain into the exemplary system—providing table data. The objective is to refine to algorithm to ‘learn’ from similar mappings to expedite the registration process.

The final billet resolving service, billet query, is currently only used by the Dead-Drop Federation process—as there are no other devices in existence today that can interpret the billet attributes. It returns billets that satisfy an attribute query. In common language it responds to the question, “Do you have any billets that meet the following criteria: Occupation=Doctor, Rank>O1, Organization is in Virginia”. With wider acceptance of this billet-based methodology, other systems will undoubtedly use billet based definitions. This provides for an authoritative, unique identifier for these billets to be managed globally.

System: Common Alerting Protocol (CAP) Handling

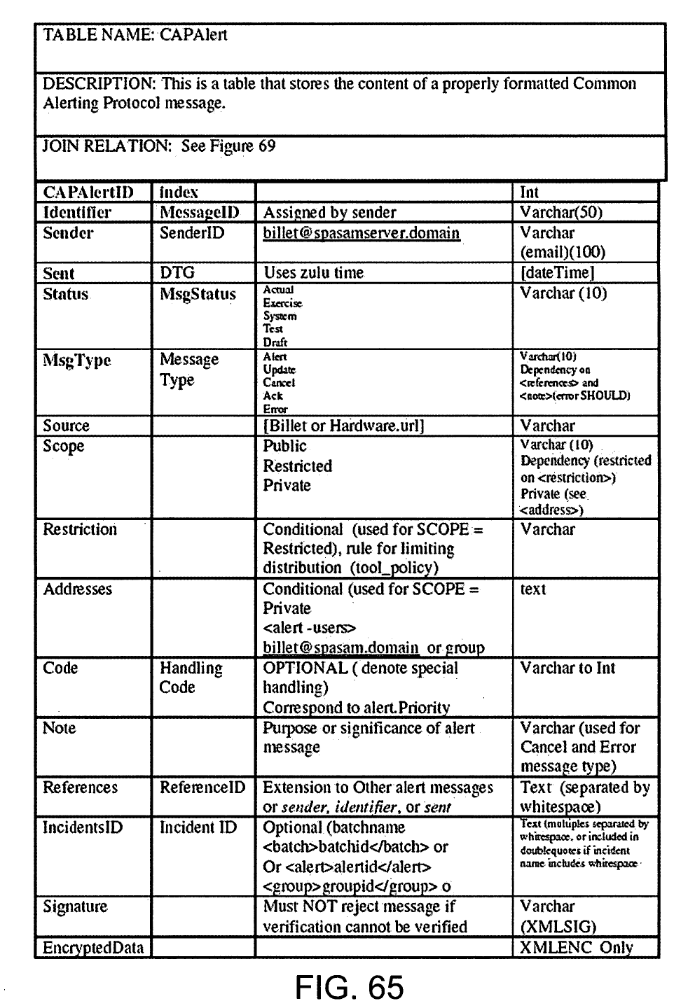

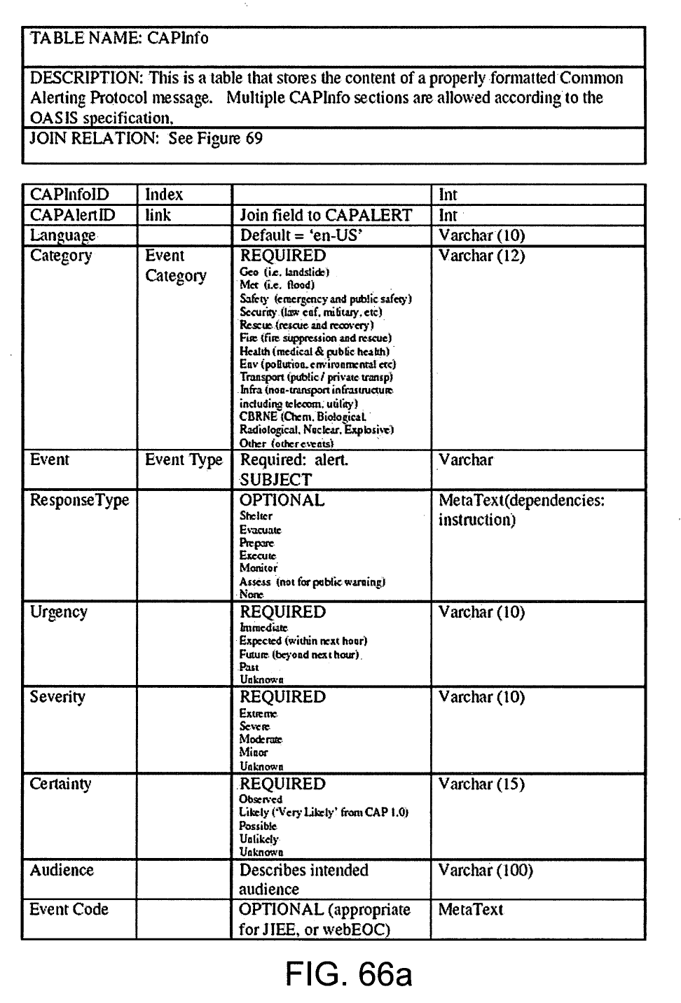

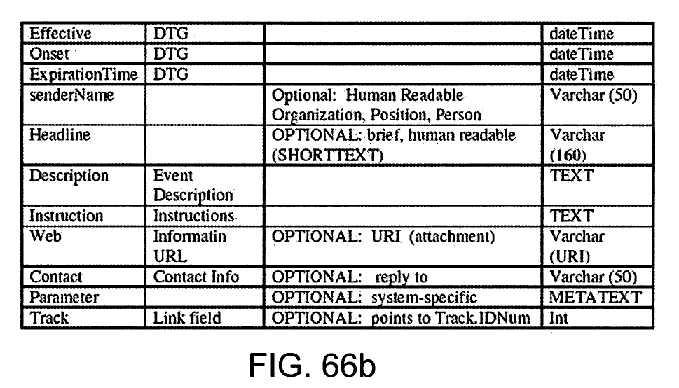

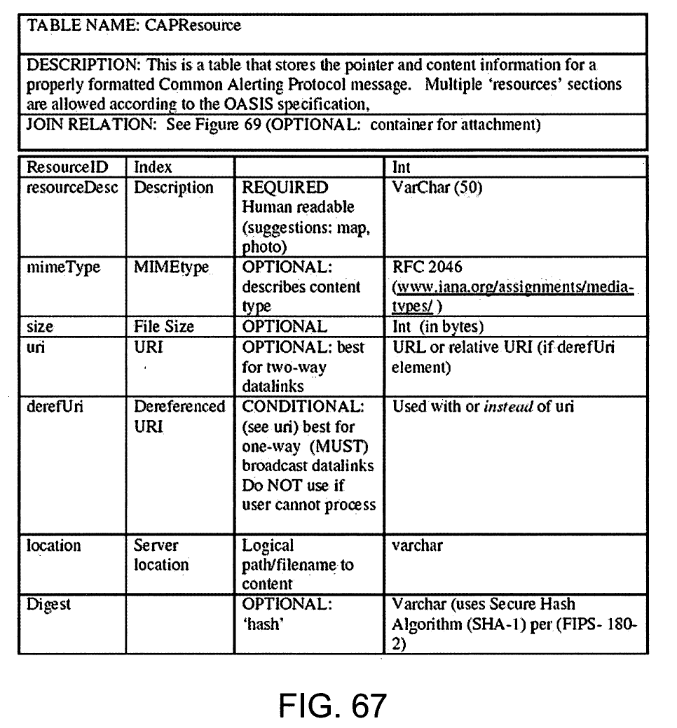

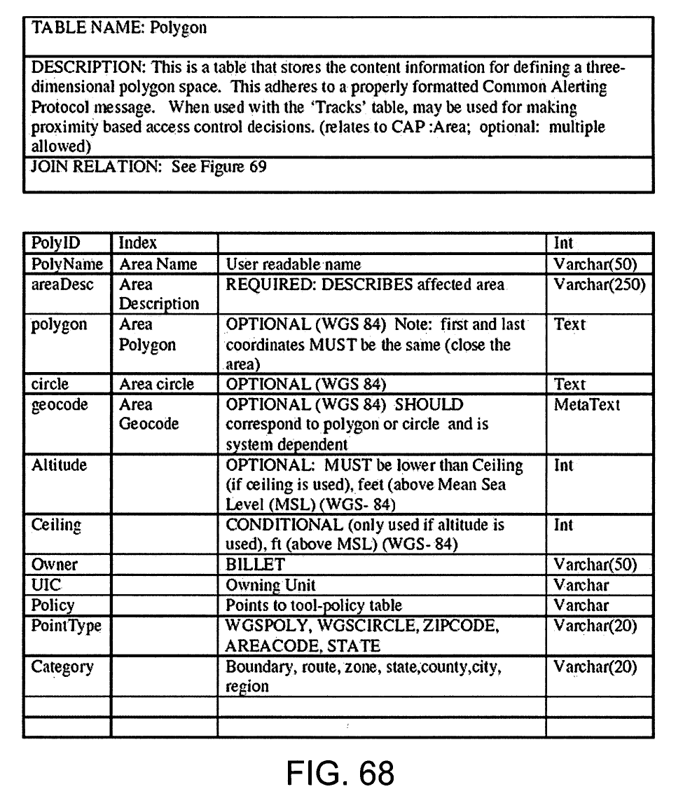

The exemplary embodiments of the invention allow for the receipt, transmission, and group transformation of CAP messages. The exemplary CAPAlert table (FIG. 65) is used to store the information contained in an incoming CAP alert, store information while a CAP alert is being constructed, and to archive CAP alerts that are sent. According to the OASIS specification additional information may optionally be provided. The relation of this information and the other embodiments of the system, including the J-SPASAM alerting system are depicted in FIG. 69. There may be multiple sections delineated in the alert. The exemplary CAPInfo table (FIG. 66) similarly stores, records, and archives this information which may then be used in multiple outgoing CAP alert messages. The CAPInfo section allows for multiple content resources to be attached along with the alert. These resources are parsed from incoming alerts, recorded in the CAPResource table (FIG. 67) and may be optionally used for other alerts or by the other embodiments of the system. The multiple resources may be referenced according to the CAPINFO_Resource join table. Polygons define an area with three or more points defined by latitude and longitude according to the WGS-84 specification. The Polygon Table (FIG. 68) stores these points or other geo-referenced areas as well as altitude information to provide specifications for three dimensional volumes. This exemplary table is used by other embodiments of the system, for example, including the policy decision algorithm, smart agents, the ‘groups’ graphical user interface, and the like.

System: User-Billet Association Manager

This graphical user interface is part of the web based toolset available to IMOs. It represents users in one column and billets in a second. The operator drags and drops names into the selected billet. This intuitive GUI is utilized in the follow ways:

User Billet Association, ShiftChange, and Manifest.

User-Billet Association is managing who is filling what role. Similar to a baseball manager's roster—users can be shuffled or it can be used for initial placement. This initial placement feature has proven to be particularly useful during training exercises or experiments. When volunteers and participants arrive or register for an exercise they can be placed into pre-defined billets that can be evaluated during exercise. As an example, if a state intends to conduct an emergence preparedness drill to validate the emergency management plan—the actual governor, state officers, and mayors are unlikely to participate throughout a lengthy event. However, representatives can be placed into these positions, the exercise is conducted, groups and batches are built—but because the exemplary system is billet based—the resulting data can be immediately used in a real crisis.

The second use is for ‘shift change’. Military and emergency operations are conducted continuously and indefinitely. As users are relieved at the end of a shift—certain duty positions should be filled—24 hours a day. This feature allows for a simple and instantaneous ‘change over’. Because the exemplary system allows a user to occupy more than one billet; and a billet can be associated with more than one user—overlap is possible as well. The shift change feature provides for pre-planning ‘who will occupy what billet’. This is stored so that it can be manually invoked at the designated time. This allows for users to be completely disassociated when off shift. When routine operations resume, a ‘shift change’ can be invoked to reset the associations to their previous state.

An unexpected use of this feature was discovered during such an exercise. The National Incident Command System has recommended organizational structure for the incident site. It defines positions according to their function. The ‘shift change’ and ‘User-Billet Association’ capabilities were used in tandem to establish the incident command center. An organization, with its own UIC, billets, and tools was created—with no users! This incident organization had been exercised to validate that enterprise resources were available to the different functional areas. Then when disaster struck, an IMO took notes on who the incident site commander designated to fill each functional area. The state police officer was in-charge of traffic, while the sheriff in charge of public safety, and one of three police chiefs designated for law enforcement, and so on. The IMO then used the Billet association Manager to OPCON these individuals into the incident organization with the appropriate billet. As the incident drew on, the IMO planned out the shift change in advance, had it approved, and invoked the change prior to shift change. The previous ‘chain of command’ was stored, de-activated and the situation continued to be managed. The biggest advantages to this were: alerts and tools were not lost when new users arrived—providing seamless continuity; and the identity and trust were preserved because data providers were assured that their tools were being access according to their specifications—with no access control modification on their part!

The Manifest functionality of the User-Billet Association Manager provides for an intuitive way to associate users and hardware with a ‘Tillman’ track. A form of conveyance (e.g., vehicle, aircraft, boat, etc) is tracked by external system that report current position and vector information to the network. There is a need to associate and disassociate people and hardware with these tracks quickly and easily as the management of such data can become unwieldy. Further, the assignment of people to these conveyances is not a new requirement and is frequently done today with duty rosters, automated scheduling programs, and even spreadsheets. It is common practice to have a list of passengers on file (e.g., a manifest) prior to boarding a commercial or military transport aircraft or ship. This feature allows for those lists to be uploaded (e.g., with a spreadsheet or re-using web services if available); manipulated if necessary; then invoked at departure time. When invoked, the exemplary system updates the users table and hardware table to associate these records with the continuously updating tracks table.

System: Policy Enforcement

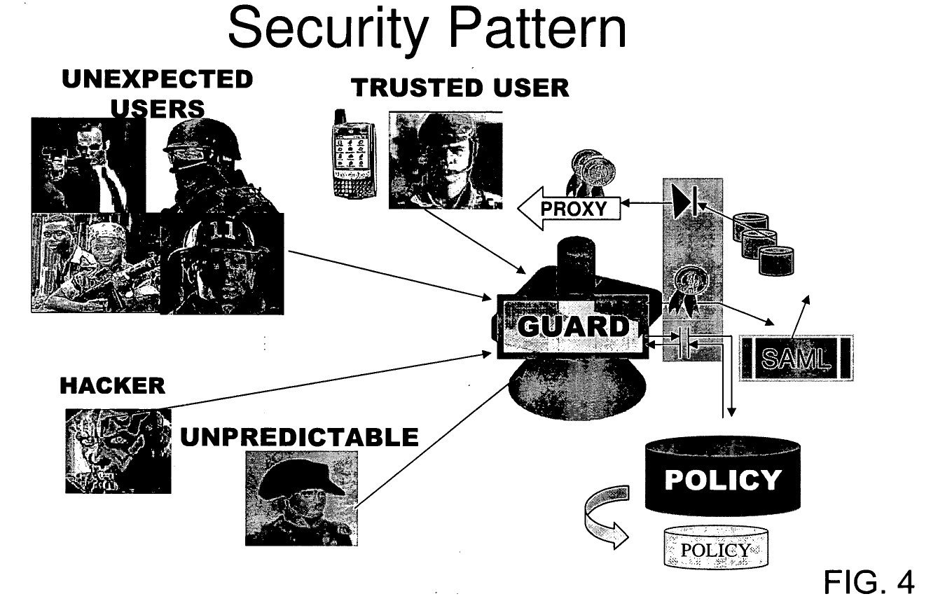

Access Control implies that a decision is made regarding an entities attempt to access a particular resource (FIG. 4). This decision is made by following a systematic comparison (FIG. 64) against a list pre-defined conditions that should be satisfied (FIG. 9). As described earlier, these conditions are: billet attributes, a user's personal attributes, the attributes of the organization they are assigned to (e.g., or OPCON to), and situational parameters (e.g., present location, browser type, IP address, time, and authentication method). ‘Advertising’ is the concept that the existence of a resource is made known to a particular user. This concept is particularly useful when working with ‘batches’—but is not based on policy. By not advertising a resource, it does not provide a mechanism to initiate the ‘single sign-on’ nor provide an indication that the resource even exists. This ‘invisibility’ is not considered ‘security’ by many resource owners . . . but certainly reduces the risk of intrusion.

The exemplary system allows the resource provider to articulate who gets access to what on an unprecedented scale. First the unique methodology of defining billet and user attributes provides ontology for setting these parameters. Next, by associating users with billets, the owning organization's attributes may also be inherited or placed in precedence of the user's attributes. Because of the fluidity of emergency situations and the flexibility that should be employed in coalition based military operations, there is a need for a system that can both allow resource providers to articulate the criteria for use of their data or system, quickly change those parameters to meet the needs of the federation, and yet mitigate the risks associated with sharing to a too broadly defined audience.

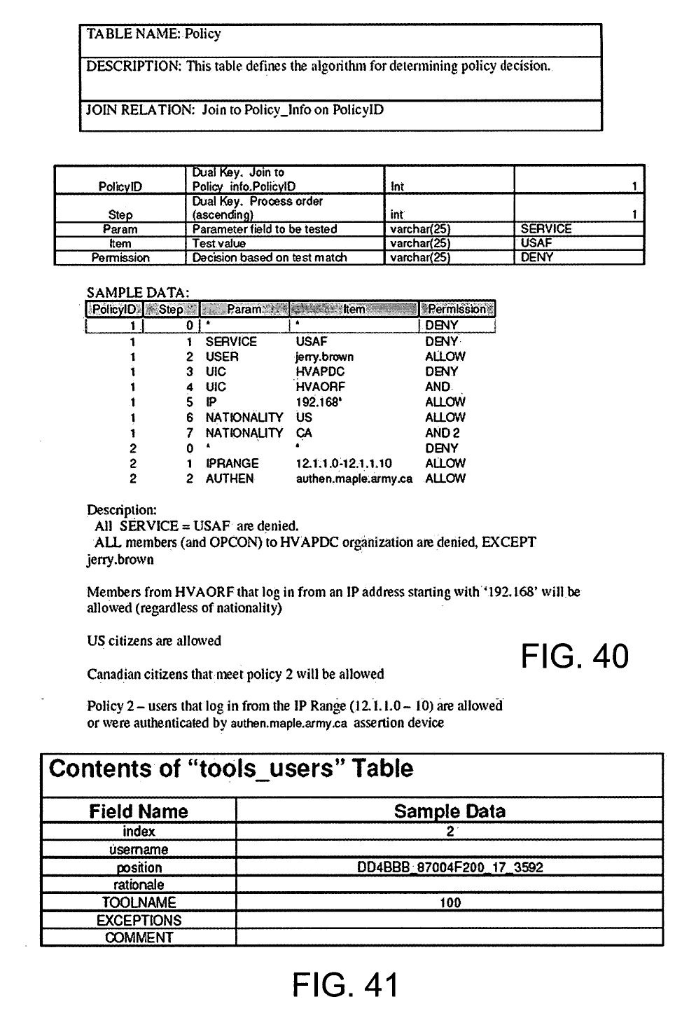

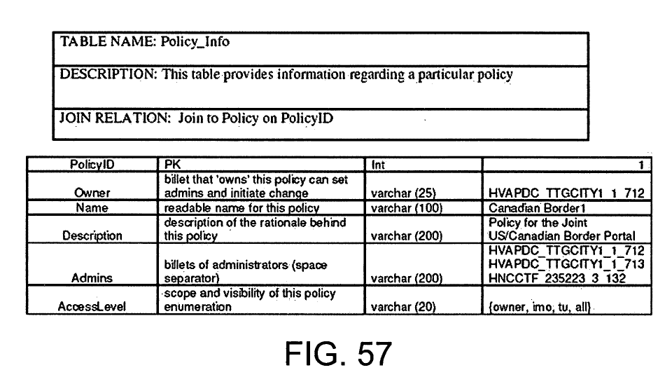

The exemplary system provides a web-based graphical interface for defining the parameters listed above and defined throughout this document. As parameters are defined, they are added to the POLICY table (FIG. 40). The order by which they are processed can be advantageous. The parameters are encapsulated into a single policy definition, described by the POLICY_INFO table (FIG. 57). The exemplary system allows for ‘nesting’ of these policies within the parameters definition as illustrated.

As the exemplary system encounters a decision point, it steps through these parameters in order to determine if there is a match between the parameter and the entities attributes. If there is match, it enforces the desired outcome. This is best described by the following example.

| Policy # | Parameter # | Parameter | Match | Decision |
|---|---|---|---|---|
| 1 | 0 | | | Allow |
| 1 | 1 | username | Jerry.brown | Allow |
| 1 | 2 | UIC | HVA* | Deny |
| 1 | 3 | IP | 192.168.1.12 | Deny |

If the user, jerry.brown, assigned to HVAPDC, logged in from IP address 192.168.1.12 is requesting brokered access to a protected website via the exemplary system; the decision can be reached as follows. The first parameter is compared: jerry.brown is a match to the specified parameter. Then the decision is enforced: allow—so he is provided a brokered access while the other users assigned to that unit will be denied. However, if parameter number 1 was placed later in the list, the same decision would not have been reached . . . as parameter 2 would have dictated that his association with that unit (e.g., which meets the wildcard definition HVA*) requires denial.

This is a form of Boolean logic (e.g., each subsequent record equates to an OR decision) except that: it is defined step wise; where only positive decisions (e.g., matches) are evaluated and rendered the appropriate decision. If a match for a particular parameter cannot be determined, the exemplary system continues to progress through the parameter list for that policy definition. Parameter 0 of the policy definitions define the ‘root policy’—in this case ‘allow by default’. This root policy defines the decision in the event subsequent parameters cannot be resolved. The AND logic is handled in various exemplary ways: the access/deny value in the decision can include another set of policy parameters (e.g., which can be evaluated as nested OR's which eventually should resolve a decision) or a single additional parameter (e.g., the next sequential parameter) should combine to resolve a decision. Now, a resource provider can articulate role based policy as well as provide ‘exceptions to policy’ by further defining the parameter list.

There is no logical limit to the amount of parameters or policy definitions that can be supported. Access control decisions can be evaluated and enforced centrally by the exemplary system or approved outside systems can query the policy store for the current policy parameters and enforce at the tool. These decisions are based on credentials that the requesting user provides and may be supplemented with attributes (e.g., billet or organization attributes) that the J-SPASAM provides as a response to a query for more information about the billet (e.g., see billet resolving service). These policy parameters can be provided according to the XACML standard or via an XML response. Using the example above, the following exemplary XML response can separate the individual parameters, as follows:

<POLICY toolid= “100”>
<username decision= “allow”>jerry.brown</username>
<UIC decision= “deny”>HVA*</UIC>
<IP decision= “deny”> 192.168.1.12</IP>
</POLICY>

System: Site Architecture

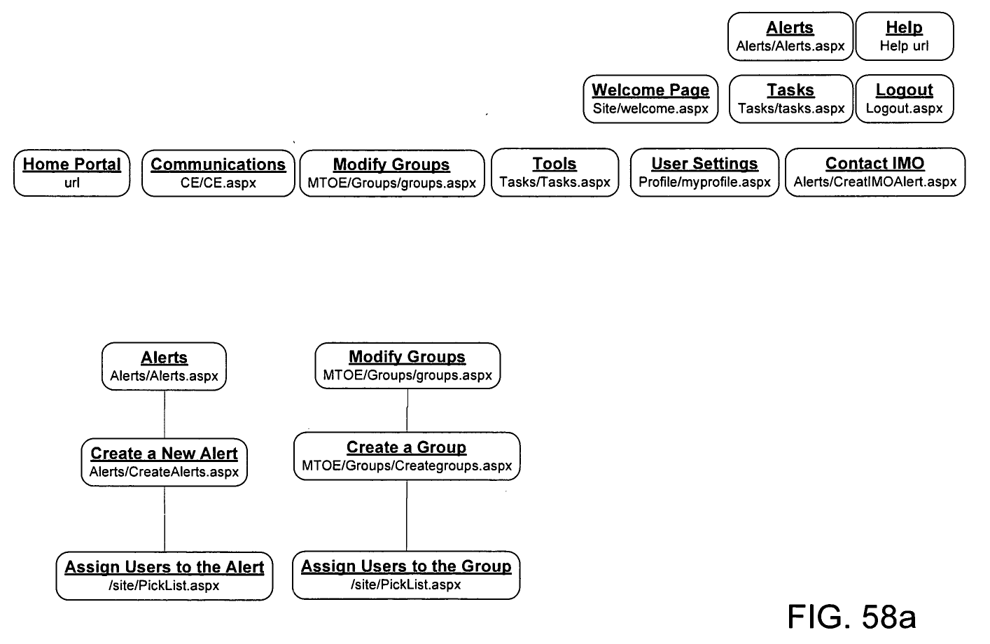

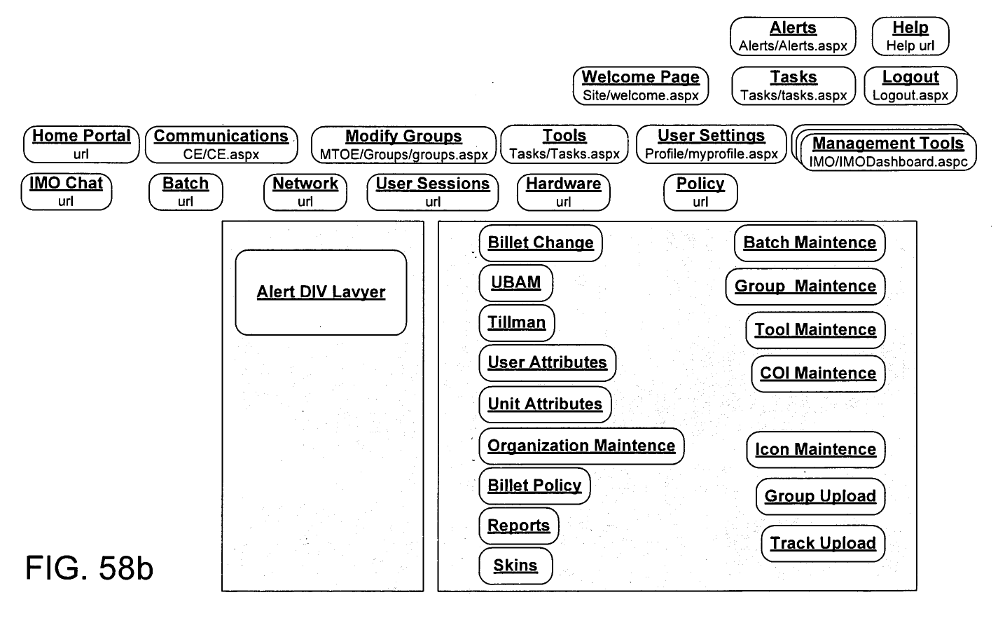

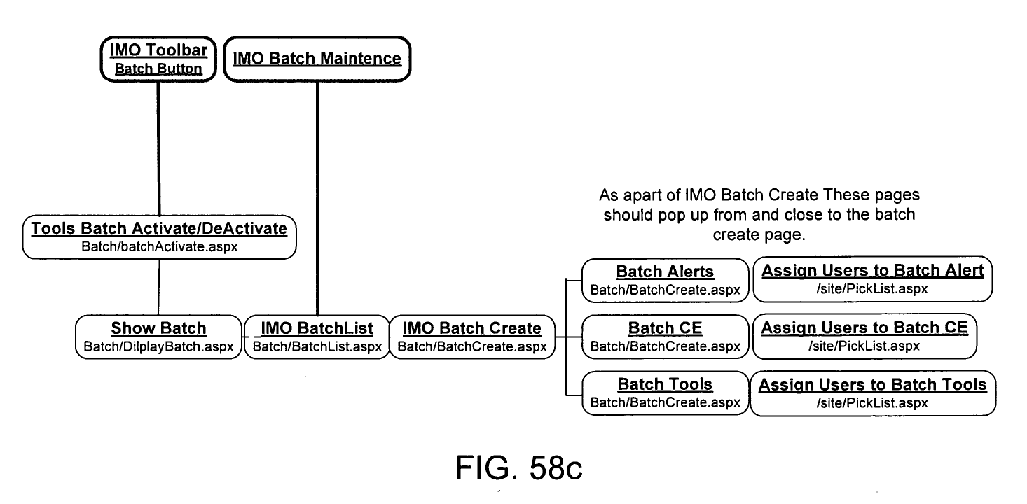

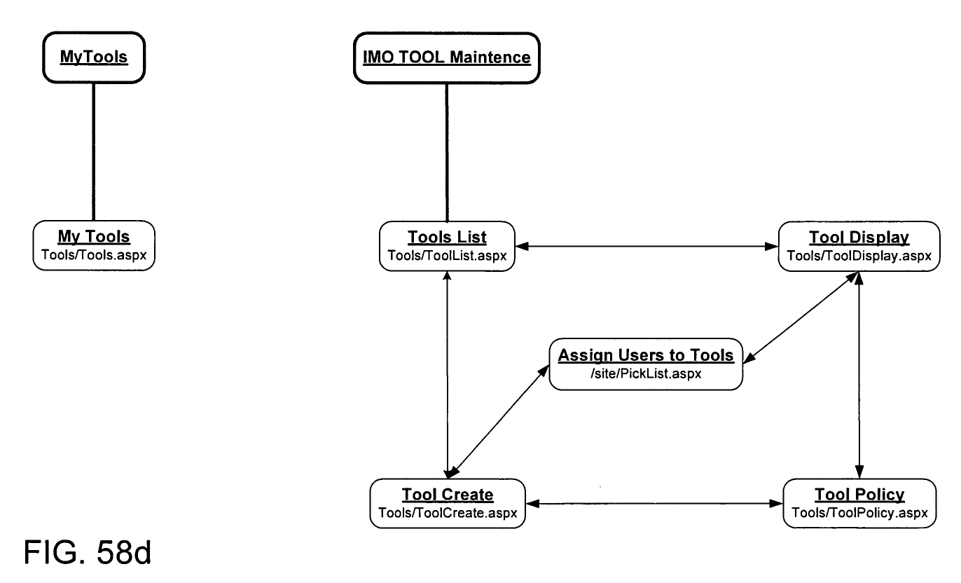

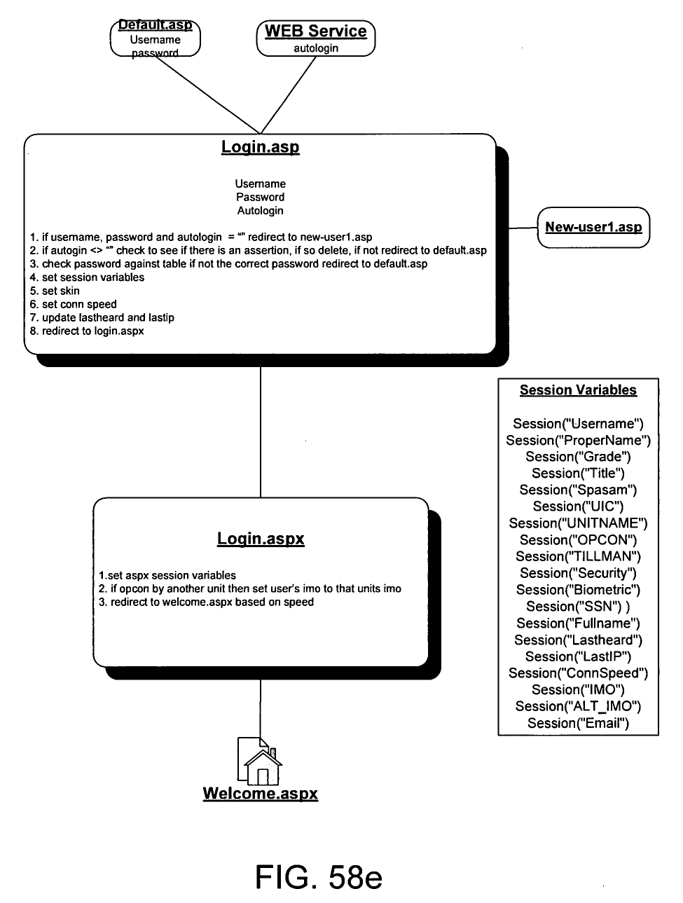

As a background, FIG. 58 depicts the site model as a perceived from a typical user. Every organization can craft its own look and feel by selecting different color combinations and fonts—intended to closely match those of their home website. Pages are presented below a ‘toolbar’ which includes buttons to rapidly access: their Home Portal, Communications Links (e.g., chat rooms, collaborative tools, and VoIP clusters), Groups, Tools, User Preferences and Settings, and a button to contact their IMO. Above the toolbar are 5 buttons: welcome page, alerts (e.g., color coded to reflect the highest priority of unviewed alerts), tasks (e.g., also color coded), help which provides links to tutorials and other help topics, and the logout button.

Functions within the alerts category (e.g., accessed when the alerts button is pressed) include: processing incoming alerts, creation of new alerts, and the subsequent dispatching of the alert. The Groups functionality is similar.

The Information Management Officer (IMO) has an additional layer of tools that assist him in supporting those users assigned to his unit, coordinating with other IMOs and IT specialists, and maintaining the organization's ‘cyber-presence’ in the federation. These include:
IMO chat (to quickly access chat rooms established to specifically aid in that coordination)
Batch—to quickly activate and/or maintain pre-established batches
Network—to quickly view a graphical representation of the enterprise and the availability of necessary services (email, dns, routers, etc)
User Sessions—to view user activity by viewing logs
Hardware—to view or maintain the information regarding hardware devices owned by this organization and possibly available to federation members as a resource.
Policy—to view the policy for federation resources or maintain the policy of resources provided by the organization.

The Alert DIV layer is a refreshing list of active alerts and workflow tasks for processing.

The section in the lower-right half of the IMO page is the ‘dashboard’. The buttons provide easy access to maintenance tools that allow the IMO to modify attributes, maintain associations, or access IMO specific tools.

Like the logical architecture, the applications and webhost files that ‘serve’ the pages to users, are segregated into different folder partitions for performance and security. The segregated folders include:
Admin—administrative pages for use by the NOC Network Users
Alerts—for processing activity involved with the Alerts information domain
Architecture—for processing network architecture and hardware information
Batch—for executing and maintaining the batch functionality
Chat—for processing activity involved with the COI information domain
Images—graphical images for producing icons, buttons, and the like
IMO—IMO specific pages, may pages for help desk personnel if so configured
MTOE—importing, processing, and maintaining organization billets
PASS—pages specific to the actionable data information domain
PDA—almost a ‘mirror’ of this director—with pages designed to accommodate the smaller screen size and functionality of network/cell enabled Personal Data Assistants
Policy—for maintaining tool policy
Profile—pages for users or personnel managers to maintain preferences or attributes (respectively)
SAML—pages for administering authentication processes
Site—the ‘home’ folder—hosts the welcome page, toolbars, and routines common to other folders
Skins—the cascading style sheets, graphics, and buttons specific to providing a custom graphical environment
Tasks—pages for processing workflows
Tools—pages for displaying available enterprise tools, as well as hosting J-SPASAM provided tools. This folder is further segmented to further segregate these pages. The numerous pages that perform helpful searches, translations, lookups, tutorials, diagrams, etc are included in appropriately provisioned subfolders under this directory.
Upload—a directory for holding uploaded spreadsheets, images, or other files prior to processing into the database or image folder (respectively).

System: Logical Architecture

As a background, FIG. 60 depicts several such ‘closed networks’ that desire to share information at some level across a network infrastructure—forming the ‘enterprise’. The collection of participating members makes up the ‘federation’. When two or more devices establish trust and successfully exchange information they are ‘federated’. Two closed networks that successfully establish trust and successfully exchange information at some level, are ‘federated’. The DMZ is a term used to describe a location, accessible to the larger network or enterprise (e.g., internet, SIPRnet, etc), but also accessible to the closed network. The term ‘closed network’ implies that it is protected from access from the larger network by logical segregation, firewalls, etc. Information inside the ‘closed network’ is sufficiently isolated to prevent intrusion, or leaks. Information within the DMZ can still be protected and controlled—but because of its exposure to the outside—is less secure. The owner of a closed network also owns its DMZ. Moving information into the DMZ is handled by technology—not covered in this document. The term ‘portal’ is used in various ways—but in the context of this document, implies that it is a device (e.g., system) that provides a controlled ‘view’ (e.g., in this context—from the DMZ) to data—that may be stored inside the closed network.

The J-SPASAM engine is designed primarily to provide inter-agency Federated Identity Brokering and access control at the boundary of closed network. (FIG. 60) Depicted by the ‘information domain’ logo (FIG. 2), this broker is logically placed within the De-Markation Zone (DMZ) of the closed network. Data need not pass through (e.g., tracks could be considered an exception) the broker. The structure and activity behind the DMZ firewall, is irrelevant to the broker. Only those resources that are registered in the TOOLS table are known, and each of these have policy established by the ‘owner’. The logical location of these tools may be within the closed network or outside, on the enterprise.

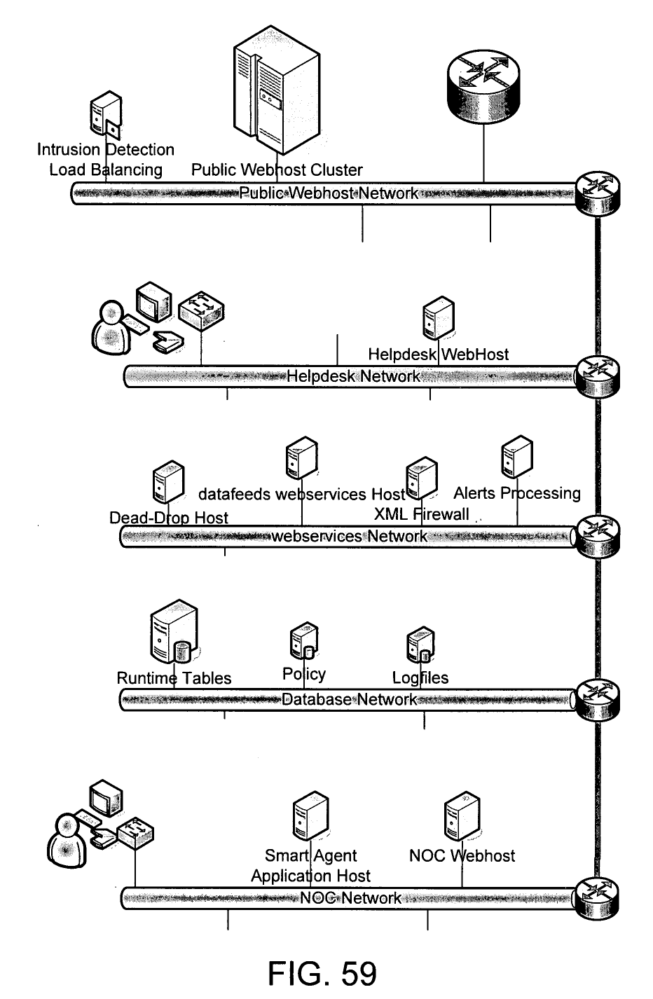

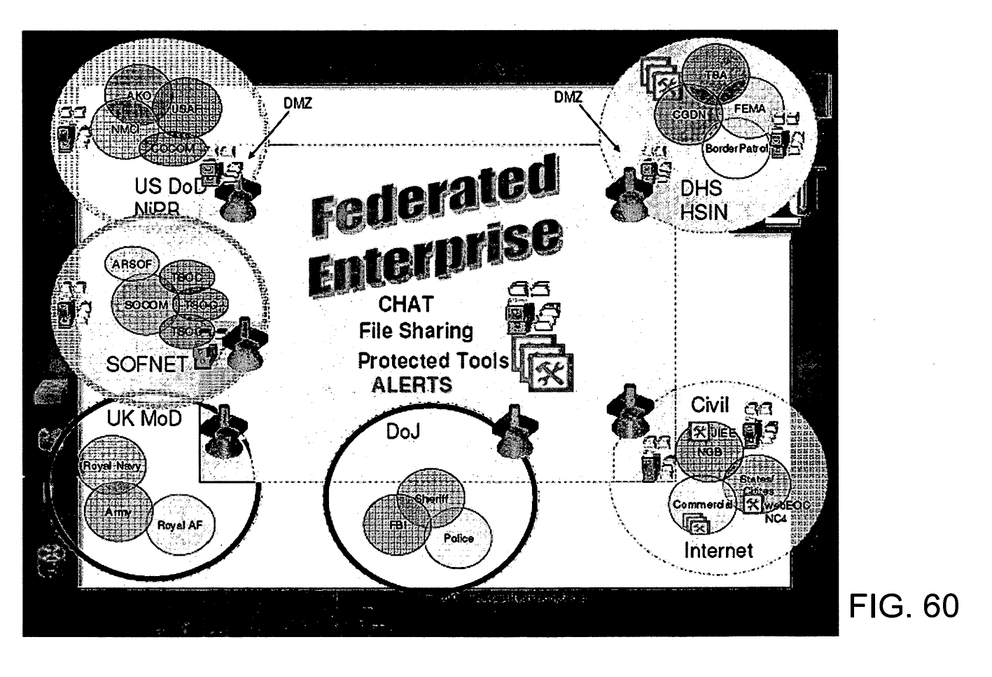

As a guard (FIG. 9), the exemplary system should itself be resilient to attack. While the icon and the perceived logical location may appear from the outside to be a single entity, the exemplary system is designed to operate as a clustered server node. It may be deployed on a single server (e.g., as might be necessary for a mobile, emergency response package) or segmented onto numerous servers to provide scalability. The logical architecture (FIG. 59) may be accomplished physically or virtually—but is designed to scale over time (e.g., the ‘Public Webhost Cluster’, when deployed, may actually be accomplished on hundreds of servers).

According to the requirements and the art of website security design, different functions are internally hosted from different servers on internal segmented networks. FIG. 59 depicts five such internal networks, but these may be virtualized or further segregated. Most of the exemplary system functions can be carried out using the exemplary engine's web interface. These functions can be segmented and segregated onto different web servers. The database is also designed to be segmented and may be hosted with several database systems (e.g., MySQL, Oracle, SQL2003, etc). The function of certain tables dictates that they be hosted differently. Logfiles, for example, can be constantly updated and employ archiving without degrading performance while many of the numerous ‘lookup’ tables are only accesses occasionally.

The first network segment, Public Webhost Network, is the entry point to both the DMZ and the enterprise and/or public internet. While each network segment has their own security functions, the intrusion detection and load balancing function in this segment is paramount to security.

The ‘helpdesk network’ is designed to provide for a staff of personnel that assist federation users and IMOs. This staff can be housed in a secure facility with authentication devices at each terminal. The helpdesk webhost has the same access to the database network as the Public webhost network, but is segmented to provide for failover, modification testing, and quality of service to both the public users and the helpdesk staff.

The ‘web services network’ is segmented to provide a logical ‘backchannel’ for outside communications as well as segregation. These functions include: Dead-Drop hosting, incoming datafeeds, and alerts processing. An XML firewall function is also depicted to provide security and routing of SOAP messages. The Alerts processing function includes external interaction with the alerts information domain. It manages incoming and outgoing alerts processed with external systems, email, and CAP processing.

The database network should control access to the database segments. Grouped into major function categories, runtime tables, logfiles, and policy each have different performance requirements. The runtime tables include the majority of the exemplary engine's relational database tables. This category is continuously being updated and accessed, but frequent archiving is not necessary. The policy category includes those tables that are the most lucrative to an intruder and are continuously monitored for unauthorized changes. Logfiles are continuously being written to, but, by comparison, are rarely accessed. They should be periodically archived during normal operation. This internal network also provides a function that regulates which of the servers from the other internal networks can read or write to the particular tables.

The final internal network is the ‘deepest’ and most physically secure. Administration staff operates from this network, using the Network Operations Center (NOC) webhost to maintain the exemplary engine, provide updates, and otherwise administer the entire cluster. Smart agents, applications that autonomously modify the database, may operate from this network or be further segmented.

System: Occupation Translation

This functionality involves the translation of various occupational codification schemes from one to another. For military purposes, the U.S. Army's USAFMSA codification scheme provided the best baseline because it provided the best compartmentalization of occupations with a codified structure. These Military Occupational Specialties (MOS) didn't become clouded by imbedding rank and special skills or position codes—as the structure of the other military services did. Further, the U.S. Army has numerous occupations, not present in the other services, that directly translate to civil occupations that are prevalent in emergency management (e.g., civil affairs, linguists, civil engineering specialties such as: water purification, traffic, or sanitation engineers).

The U.S. Department of Labor (DOL) has compartmentalized and categorized the civilian occupations—primarily to support governmental decision making, taxation, census calculations, and the like. It does not however adequately address the granularity of intra-military, combat specific occupations.

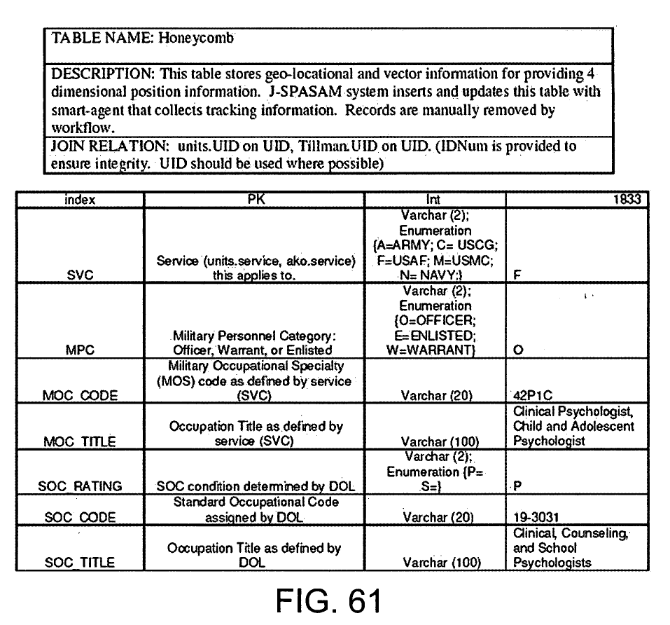

The exemplary system has combined the strengths of these two ontologies to bridge this capability gap—while preserving recognized coding structures. The internal ‘honeycomb’ table (FIG. 61) provides a ‘crosswalk’ of known direct associations (e.g., optometrist is uniquely defined by DOL, and all military services) and logical associations (e.g., police, deputy sheriff, military police, and special police). This table was based on prior art created by the department of defense as reported to the Department of Labor. However, with further additions and the exemplary system's ability to ‘learn’: this ‘honeycomb’ addresses an estimated 90% of all translations. An intuitive search capability is built into the exemplary engine to provide for the remaining translations. Typing a known military MOS or a word fragment into a web-based search tool can return possible word associations of the various occupation tables referenced above. For example, typing ‘RADIO’ into the search tool can return DOL occupations (e.g., radio announcer, radio repairman, radio/television salesperson, etc) along with occupations including ‘radio’ from the various services (e.g., radio repairman, radio operator, radiologists, etc). By analyzing human selections, the exemplary system is able to add to the honeycomb table, thereby ‘learning’ about the occupation translations that are not direct associations. The exemplary system allows for future normalization of this table to return better translation results.

System: Populating the Network (FIG. 16).

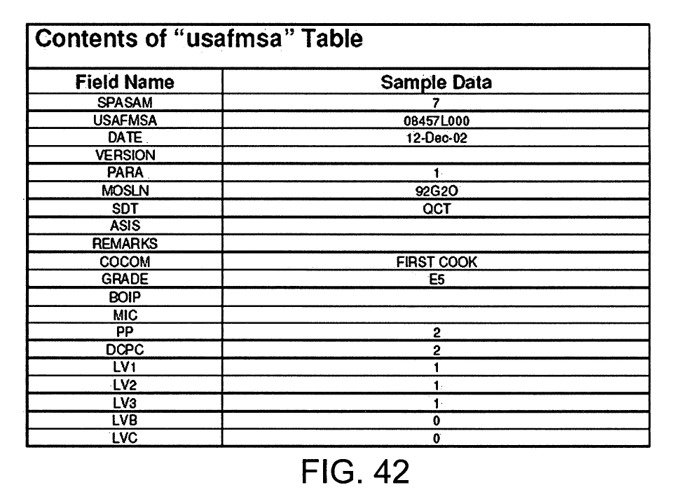

Populating Tables of Organization and Equipment (TOE). The TOE is a document that specifies what makes up a unit. The document can be in the form of a spreadsheet, but basically it is a table that describes the billets and equipment that an organization has. In FIG. 16, the process box to the right of the TOE indicates the ability of the exemplary system to accept a spreadsheet or a delimited table of some form and to run the checks on it and get it in the form of a USAFMSA data store. This table is called USAFMSA because originally the data was interpreted from TOEs through this process, which populated the exemplary USAFMSA pick table. The USAFMSA object represents a Pick List as indicated in the legend. Pick Lists serve as templates for the creation of units. A unit is composed of billets and hardware. The USAFMSA table (FIG. 42) allows for the addition of new units and billets based on this organization. For example, suppose someone from the Red Cross of Portsmouth, Va. needs to be added to the exemplary system, complete with unit designation and a list of billets. They can go on the Pick List and find the charitable organization template. Through the template they can see that his particular type of organization needs to have certain billets and then an administrator can add, delete, or modify those template billets to customize their unit. This is another feature of the exemplary engine—the ability to quickly create units based on a template and add them to the enterprise.

Sometimes it is easier to provide a template in the first place for someone less knowledgeable. Suppose a church administrator is trying to set up his organization to participate in an emergency management federation. They can log into the exemplary system, download a sample of a template for a charitable organization. Then they can take it back to the church and they will be able to fill in the roles and customize the billets and then upload their organization's billets and attributes much more accurately.

Populating Communities of Interest. There is a similar process for COIs. A user can download a spreadsheet and add those billets that the user wants for a particular chat room. Basically, the user is using the spreadsheet as a Pick List for adding COIs. The other way COIs can exist is if there is already a chat server. The exemplary system has a process of querying a Lightweight Directory Access Protocol (LDAP) server. A user can ask what chatrooms are currently hosted and what the census is for each of those rooms or channels. This query allows the exemplary system to know if a user has a COI, what its name is, which person moderates it, the attributes of it, and it can populate the exemplary COI table (FIG. 27). This gives the exemplary system the ability to learn about other resources that are joining the federation. In the legend, it is shown as being Microsoft/Commercial because there are a lot of different chat servers or collaborative servers available on an enterprise. The diagram shows the ability to communicate with those other servers to populate the exemplary COI table (FIG. 27). The reddish/purplish arrow indicates this ability.

Populating Alerts. Alerts come from a Pick List as well. Again users may have spreadsheets that can be imported at least as far as billets or usernames that they want to be added to a particular user list. The alerts capability need not provide the ability to query other alert devices, but can provide the ability to listen in on different alert sub-architecture or sub-networks. There are various network messaging tools out there, so the exemplary tool has the ability to listen on various channels. As appropriate, those external tools can be added to the exemplary alert message system. For example, suppose someone sends out a network alert message that the server will go down for maintenance at a certain time and the subscription to the alert is made. It may be very important that someone get that alert on their cell phone or through e-mail. The exemplary system can actually change the alert medium from one form to another. Or suppose there is an emergency response tone on a VHF network. As soon as the National Weather Service issues an alert, the exemplary system can change it to a network alert message, or web-based messaging, or SMS text messaging. Thus the capability exists there to subscribe billets to other alerts coming in through different media.

Populating User Tables. User Tables (FIGS. 43a-43b) can facilitate user management. Starting with an Excel spreadsheet someone can take a simple formatted list and upload the users and the billets those users happen to be filling at that particular time. This is very advantageous for user management and is why the capability of the exemplary system is unique. In fact, user management is typically a major hurdle for a system like this. However, the fact that the exemplary system reuses other systems like the human resources software PeopleSoft greatly facilitates user management. For example, in the Army, the personnel command has a lot of databases that show what position or organization a person belongs to. As a person gets promoted, changes to their attributes may become difficult to maintain. By populating the attributes for this user, the exemplary system keeps those changes up to date easily or at least makes it so that an occasional update of the exemplary system into a spreadsheet can be uploaded with its user attributes and user join tables correctly identified.

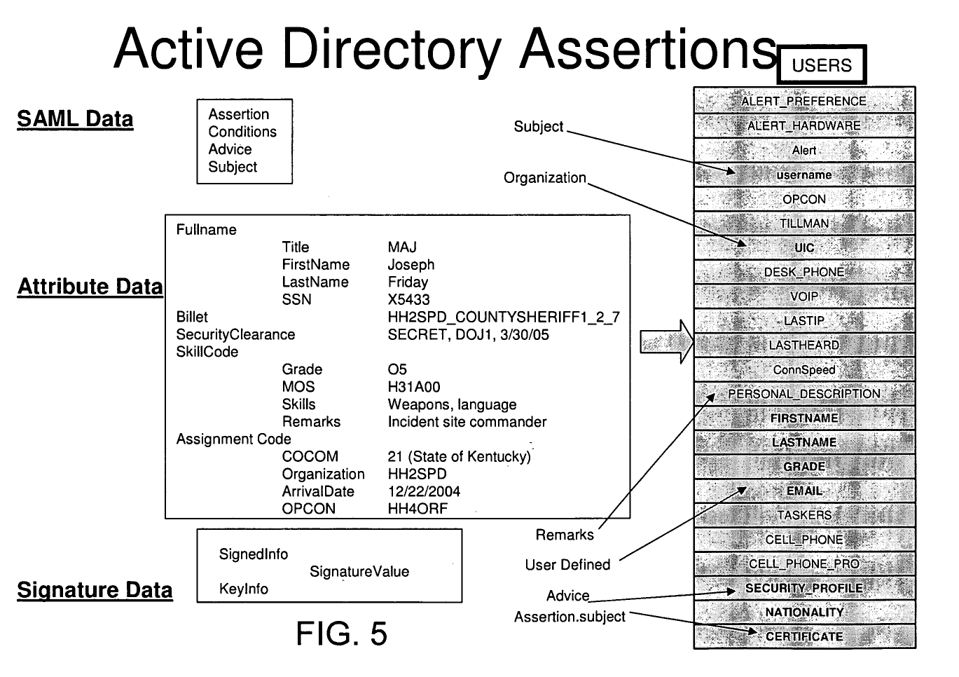

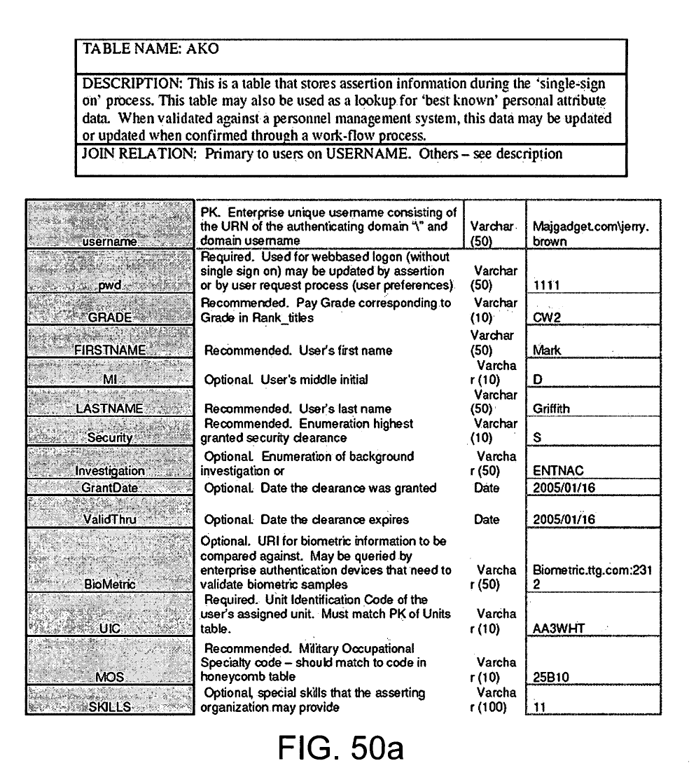

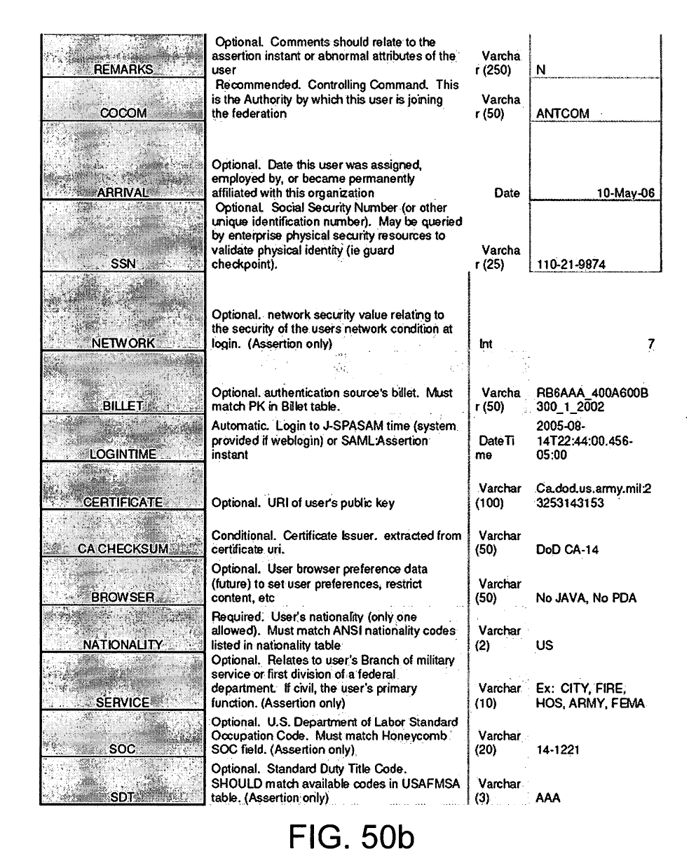

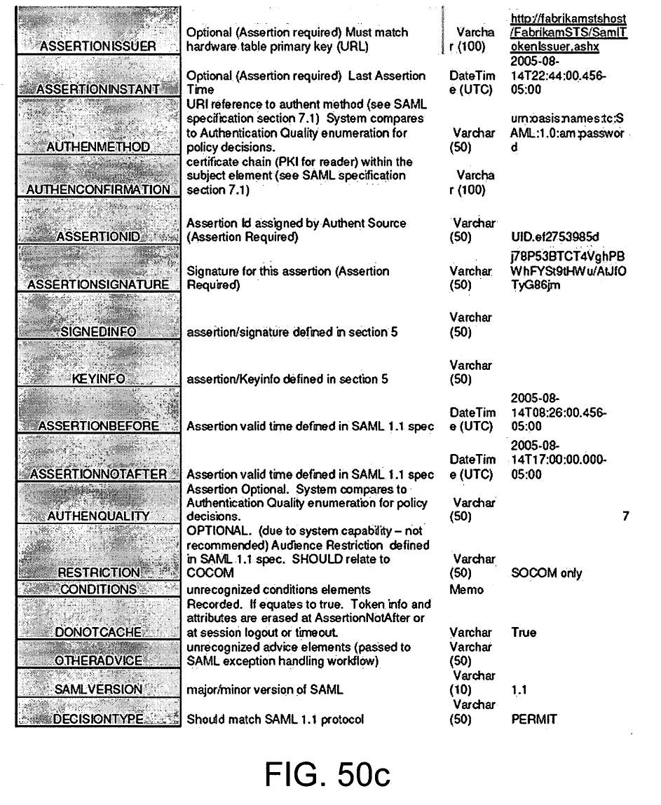

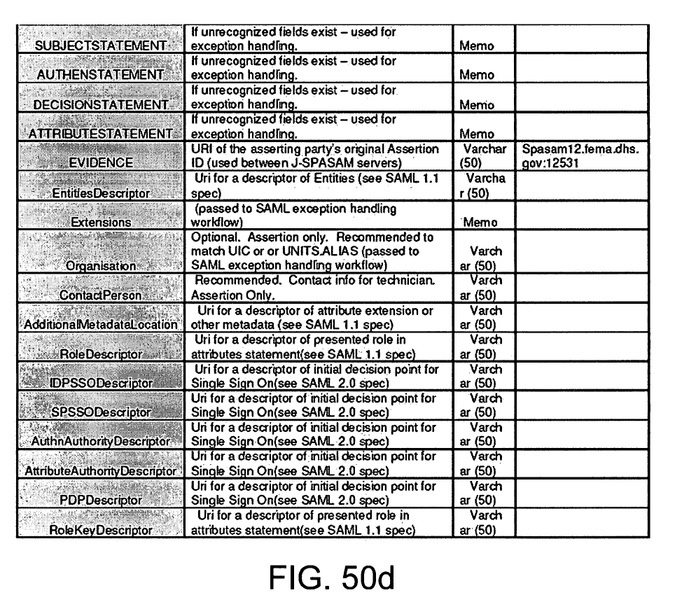

The AKO table (FIG. 50) is directly related to the Users table (FIGS. 43a-43b) especially as the Users table is ultimately updated from an assertion, made by an authentication source or validated by an external personnel management system. FIG. 5 shows the association of the elements of a SAML assertion to the AKO table. The AKO table is designed to store elements of the most recent SAML assertion pertaining to a user. Army Knowledge Online referenced below refers to the collective set of personnel management services available from the Army Personnel Command (including, e.g., the Defense Enrollment and Entitlement Repository System—DEERS) as well as the Army's portal for content staging and collaboration. This AKO portal has been extended to the entire Department of Defense. For the purposes of this document, these references to the Army portal imply a cohesive message exchange to any suitable agency's authoritative repository of personnel attribute data and an authoritative PKI certificate authority.

As an assertion is presented to the J-SPASAM engine, once ‘unwrapped’ and tested for validity (e.g., using the art described in the WS-Security specifications including signatures, encryption, and keys), the exemplary engine records the assertion in the ‘assertions’ logfile and then places the specific SAML elements into the AKO table. This is compared to the ‘last known’ data included in the users table. If there are discrepancies, a workflow is initiated to resolve the discrepancy. If appropriate, the user table is update.

The User Tables (FIGS. 43a-43b) are advantageous for authentication as well. That authentication can come through the PKI network. The exemplary system is designed so that when the PKI system is in place, it can be compliant with whatever those standards are. The diagram shows there that the Army Knowledge Online (AKO) is performing not only the user management from personnel, but also the authentication. This is done in concert with the Common Access Card (CAC). The user's CAC (Common Access Card) has his PKI certificate and the exemplary system can bounce that information back and forth from the exemplary User Table. For example, if a person logs in to a SPASAM-driven portal using their username, the exemplary engine can go to their authenticating source, in this case the AKO, and ask if that person is still, say, the mayor. The response might be that an assertion can be made that for the next eight hours this person is the mayor and these are the attributes that are valid for that time period. The exemplary system has its own capability that comes from a Domain (e.g., which can be shown in blue) written so that it can adapt the active directory or LDAP records within a domain controller so that those same assertions can be made about a user. This is a great capability because it does not require the Information Managers to reload data more than one time. As part of their normal routine, Information Managers can administer their LDAP server. Whenever the IMO either from home or elsewhere, logs into the exemplary system, the exemplary system can check for those capabilities. So that is a Simple Object Access Protocol (SOAP) type of a message that the exemplary system has developed so that a domain controller can update the User Table. Part of this ability comes from x.509 certificates and authentication. This x.509 source is an open source not just a domain controller like a Microsoft capability.

Populating the Hardware Table (FIG. 30). The following describes how the exemplary system populates the Hardware Table (FIG. 30). There are a few ways. The first is through the use of DNS servers. The exemplary system can do a query request of a DNS and get information about the IP address, the host name, or the fully qualified domain name of the Hardware Table. The fully qualified domain name can be the key for the hardware table. The Joint Master Unit List (JMUL) or the LDAP Data Interchange Format (LDIF), an Army-specific address book of where the computers are, were created in the 1970's for radio-based networks and not based on the Internet protocol. So in order for hardware to be backwards compatible it has been described in radio-readable, serial format that is used to keep the machines, old and new, able to communicate with one another. One of the problems that the exemplary system solves is that there are about seven different ways of describing a particular resource on a server. The data has become so unmanageable because it is centrally controlled as opposed to allowing lower-level users to have control over the address book. The exemplary Hardware Table solves that problem by making it more delegated and by allowing more people to keep the information updated in the exemplary registry of hardware. The exemplary system can query the DNS and the JMUL address books and import the information into the exemplary Hardware Table.

In order to keep those backwards compatible systems working and to maintain open compliance, the exemplary system has two different ways of reporting that hardware data going out. One is described as a spreadsheet or delimited table so that the information that is employed by the user can be in a format that can help their systems talk among themselves. The other way is through web services. A query can be sent requesting data about a unit, or about a particular piece of hardware, or about a particular category of hardware, or about those relations previously described. Whether the query is on a billet or on topics, it can result in the hardware data that the user needs to configure his machine in the form of a web service. The topics, as described, come through the SYNC command, the SST, and then a list of tools. Primarily, tools are entered into the exemplary system as they become available, but they can be imported from a delimited table as well. Basically, this table holds the things that make the exemplary engine run and hold the processes of how the exemplary engine obtains, keeps and updates the information.

Web services: Outgoing Message Types

The new name for the J-SPASAM engine is the Joint Subscription Proxy Agent and the Services Alert Manager. The word “services” implies that the exemplary system performs web services. The main reason why the J-SPASAM, a subscription alert manager, was at first unsuccessful was because it was not sufficiently mature to provide services. The web services that are part of the exemplary engine include the ability to make assertions to tools about the attributes and identity of a user. The exemplary engine assumes that it is participating in a federation, meaning that the exemplary engine trusts servers that are doing authentication and servers that are hosting these resources. Taking part in this federation also indicates that the J-SPASAM engine provides the intermediary service of negotiation between these servers and resources. There are levels of assertions that those tools may employ. It is advantageous to delineate what assertions are employed not only because information providers may wish to restrict access, but also to achieve maximum cost-effectiveness. In other words, if it is not know what assertions are employed, one may waste valuable time and money by making extra, unnecessary assertions.

Outgoing messaging types refer to the different types of assertions that the exemplary system can make. Some are SAML compliant, while others are not fully SAML compliant as it is not necessary in every instance. This hybrid assertion scheme uses ‘open’ definitions of elements defined by OASIS that are included within SAML, which are also included within XACML. Through these definitions the exemplary server has a greater capability to take on a device that is at a variant level of SAML awareness or XACML compliance.

The following are the different levels of outgoing messages. Level 0 indicates that there is no assertion. This is just a simple HTML redirect. A user clicks on a link and it takes him to a different web page without an assertion of identity. Level 1 indicates that there are arguments attached, but those arguments coming in as part of the URL stream. An example of Level 1 might be a URL that ends in “.asp?username=” and an argument, but there is no security being provided. Level 2 is the first level of real security that the exemplary engine provides. Here, a back channel message, which indicates that the exemplary engine will negotiate user access into the target tool, is transmitted to that tool. This is done with the “B to B” architecture; this is kind of the way a person is redirected from one site to another with some of their information securely transmitted in a message prior to redirecting the user to there. Level 3 has pre-negotiated access levels, somewhat using anonymous user names. For example, if a particular tool has five different levels of security, the exemplary engine can make the determination based on policy as to which of those categories this person fits into and then can redirect the person through a secure back channel negotiation and give them a token. Level 3 provides a layered level of access so that users may be using a tool, but they may not be privy to all the information that the tool has to offer. This works pretty well with an LDAP type of configuration where there is a visiting person who the exemplary engine may want to redirect into a portion of the tool to customize that user's classification. Essentially, the exemplary engine provides a grouping of the user and the tool is providing the categorization of what access that user has.

Levels 4 and 5 are SAML assertions, which include the authentication advice that was described earlier, the nationality sensitivity level of the current condition to a somewhat SAML enabled device. The tools are still doing the access control from their end; there is no decision making being done from the SPASAM engine. The SPASAM engine is passing along the authentication advice from the original user. This implies that the user should be pre-registered with that tool and in the user's own format. The exemplary engine makes the assertion that the user did, in fact, properly authenticate from his authenticated source. Level 5, on the other hand, additionally includes XACML information, which is access control information. It includes those attributes. It assists in the decision-making capability of that target tool. All the information, all the access control and policy information is being sent along with Level 5. In summary, Level 4 is just SAML and Level 5 is the access control and decision making information that the exemplary system needs.

Level 6 is the back channel assertion that is conducted without the knowledge of the user. For example, when a user logs onto his own computer, redirects himself to a web tool, the web tool queries the J-SPASAM engine for updated information about that user and the response is sent back to the tool. So Level 6 is conducted without the user ever being logged into or being redirected from the J-SPASAM engine. Level 7 is the subscription-by-proxy which makes the subscription on behalf of the beneficiary. It is a back channel assertion that is made to a web service.

Enterprise Identity Management Infrastructure: The Essence of Enterprise Access Control (FIG. 3)

Authentication. An enterprise includes separate domain controllers that have been federated. When this federation occurs, several things should be done to accurately fulfill building blocks of trust. There will be a set of users, a set of applications that may be running domain services, and devices that will be authenticated. Essentially, users, applications, services, and devices will be authenticated. First, one should make sure each of those entities are who they say they are to establish validity, to authenticate. This can be done in the following exemplary ways:

What We Know—This takes the form of password or PIN (e.g., personal identification number) along with a user name. This is the simplest method of authentication in that it is easy and the user does not need to carry anything.

What We Have—This takes the form of a key or token, that is, a physical object. This key, a magnetic card, USB device, or other object, stores an encrypted set of numbers stored. In other words, access is determined by the representation of a code on something that the user physically has in their possession. Only a person that has the encryption key gets access through the door. Since keys can be given to the wrong people or misused, their use is typically combined with password to ensure security.

Who We Are (e.g., Biometric)—This form of authentication is achieved through the use of things that make us unique as humans, like fingerprints, retina patterns and voice recognition. Biometric information is difficult, if not impossible, to replicate. It also has a high degree of unreliability. Like keys or tokens, biometric authentication is more useful when used in combination with keys or passwords.

Authentication is conveyed through a certificate, which is a digital registration. Once a person is logged in legitimately, a certificate identifies him digitally on the network. The user should apply for a certificate. This is done in such a way that it is certain the person is who the person says they are and they are given a unique certificate that is impossible to copy without one of those keys. That is, the certificate is combined with an encryption key for added security. Then that is commonly registered so that one can verify that a person is who they say they are: authentication. A device or a process (e.g., an application or a service) need not have a physical key, but servers do have certificates and those certifications are registered. This registration of certificates ensures that one computer knows the location of a computer with which it is communicating. That is how they provide authentication, which is required for trust. Once authenticated, one can talk about access management.

Access Management. The second step to Enterprise Identity Management is access management. This is an exemplary area the exemplary system attempts to tackle. Once authenticated, the exemplary system can provide a tool to regulate a user's access to other resources available on the network. Thus, the exemplary system accurately defines the roles of users. The exemplary system categorizes them by roles because the best way to determine access is to determine a person's need to know which is based on his role or job. The exemplary system has a unique way of defining roles. Secondly, it establishes a set of rules that apply to both the roles and the identity so that those rules are applied as policy. In other words, in defining roles and identities, the exemplary system creates a set of rules about who is allowed access and these rules make up what is called policy. The exemplary system then provides a robust set of access controls so that it can pre-configure those rules to be applied when needed or that it can quickly change the attributes or descriptions of those roles or that it can easily or quickly modify the rules. Provided is a web-based control structure so that the access controls can be modified by Information Managers on the World Wide Web, as opposed to some other mechanism. This allows users, who have a need to know based on authority decisions access to those resources. Essentially, the exemplary engine negotiates access into the information domains and the resources therein on behalf of the user. Those resources may be: 1) data feed, which are databases on the web; these are housed on web-application servers; these servers hold files that are on portals or on content-staging servers; 2) applications and services, or tools which may include websites or portals; and 3) collaboration tools (e.g., previously referred to as COIs). See the section on Policy Enforcement for more information on policy.

Another way to get into those resources, particularly locally, is through user management and the exemplary product can include user management capability. If a personnel management system does not exist, the exemplary system can control a lot of user functions and attributes through the web. To simplify this complexity, the exemplary system has provided a delegated administration capability to user management, which gives users the ability to help themselves. For example, they can perform their own searches for tools, which can reduce the workload in the user management domain. The exemplary system reuses information that a domain may have already established and that is commonly housed using directory services. Lightweight Directory Access Protocol (LDAP) is the way computer systems today store their users and put them into groups to determine the provision of resources. For example, an IT person may be deemed a super-user in general, but if they often work with the accounting department, they may only have “read-only” access to accounting files. Directory services and LDAP provide access into those directories based on folders and the matches to those groups. Thus, the exemplary system can put a person into different groups and characterize them and provide different groups access into directories. Password management is another part of access management, but it is typically controlled at the local level and need not be controlled by the exemplary system.

The exemplary embodiments of the present invention combine the Business Process Modeling capability and the alerting capability to establish a quick, flexible method for Information Managers, IT specialists, and approvers to quickly handle and approve requests. By employing the other aspects of the exemplary embodiments, this capability is unique in its flexibility and speed by which the access controls can be managed and information may be proactively shared. The ability to ‘learn’ from other domains is necessarily controlled at many points by humans—by using the exemplary system's workflow process. The disclosure of information should be flexible enough to be handled on a case by case basis—for security—but quickly enough to be practical in emergency environments. This speed and security is only possible through a role-based methodology that recognizes the four information domains.

Audit. Provisioning, getting access into folders, managing bandwidth, and managing access to resources based on the abilities, employ an audit. Audits need to run throughout these processes in order to maintain trust. The way to control this is through log files. This is particularly advantageous in access management. Every time an authenticated person is brought in, it is logged. The log files tell exactly when a user came in and what changes have been made to the user's permissions (e.g., rules). Audit is advantageous as a record of changes to users' profiles and as a record of the types of resources they are attempting to access. Through audits and logs the exemplary system can detect intruders, suspicious activity, and misuse of the exemplary system.

Designed as a broker (FIG. 9) in a federation, the audit capability is advantageous in establishing trust. These logs should be accurate and searchable to enable intrusion detection, provide repudiation, respond to queries by less capable systems, and provide a history of activity. There is an abundance of relevant art pertaining to the need and method for applying audit capabilities. Of these, the exemplary embodiments of the present invention provide a unique capability to enable ‘corporate learning’. During exercises, a participant's activities are recorded for later study in order to provide insight into better business processes and practices—particularly in studying ‘who needs access to what’ for a particular scenario. This ‘corporate history’ can be used to ‘replay’ activities during a fictional or actual event. Because the exemplary embodiments of the present invention can be role-based—these lessons can be transposed to other organization.

As an example, the information management activities and information architecture of an emergency management exercise conducted for the Virginia coastal region can be analyzed by federal agencies to improve their own information management plans, policies, and batches. The log history resulting from an actual hurricane in Louisiana can be analyzed for successes and failures in information management. Again, because the audit logs record role-based (e.g., and user-based by association) information, these two events can be incorporated into Florida's emergency management information plan. Corporate Learning.

There are four tables that record the various categories of log entries: accesslog, anomalies, assertions, dblogfile, and SPASAM_log.

Accesslog records a user's every mouse click. The time, page, IP address, and session id is recorded when each page is served to the browser. This table is very rapidly populated and is routinely archived.

Anomalies records unusual system activity (e.g., pages being requested without a valid session, or access being denied due to policy violation, etc). These records are analyzed for patterns that may indicate misuse, lack of training, or a legitimate user need. These anomalies and or patterns are reported to Information Managers and/or Information Assurance specialists using the previously described workflow process for exception handling.

Assertions records every incoming and outgoing SAML assertion that is made for repudiation as well as to quickly handle unexpected users. The exemplary system's workflow process, coupled with the transformation capability greatly reduces the time needed to introduce new organizations and users to a federation in emergency management situations. In addition to meeting normal requirements to respond to questions, Assertion logs store assertion data that can be used for quickly in-processing unexpected users and establishing transformation mappings. The J-SPASAM attribute extensions, allowed by SAML, are parsed, approved, and mapped to the exemplary system's internal tables (FIG. 5).

The DBlogfile is used to record database transactions. This is instrumental in detecting intruders.

The SPASAM_log records IMO actions that affect policy, tools, or batches. Because these actions may have undesirable effects—but are not system violations—they are recorded separately to quickly ‘undo’ accidental changes.

Security Design Patterns: Introduction

In order to provide the previously discussed access control the exemplary system can employ security patterns as commonly defined in industry. The exemplary system is the guard that determines whether a person gets access to a resource. There are two common terms: the decision point and the enforcement point. The exemplary J-SPASAM engine fills both of those roles, particularly the decision point at the enterprise level, which is binding two domains together. It serves as the decision point for allowing access to four types of users: trusted users, unexpected users, intruders, and unpredictable users. (FIG. 4).

The J-SPASAM engine serves as an enterprise broker for trusted users, which is a registry of authenticated people; they are a part of the exemplary policy. Access controls allow trusted users to get to the resources they need.

Unexpected users may not be recognized as part of the exemplary system's internal trust of authenticated users. Nevertheless, the definition of unexpected users is that they are trusted and should have access to the exemplary engine's resources. Thus, the exemplary system provides a process of allowing people in positions of authority to quickly add unexpected users to the exemplary system. The exemplary system attempts to quickly establish trust and allow these types of users to have access. Referring again to the National Guardsman example, they are an unexpected user. They may need to communicate with a City Manager to determine the need for resources that the National Guard can provide. The City Manager can inform the Guardsman of where resources are needed or perhaps other important information. The National Guardsman is an unexpected user in that they are outside the established federation. Nevertheless, through the exemplary engine, they can be given access.

There will also be intruders. As the name suggests, these users are unwanted and dangerous to the exemplary system. The exemplary engine has a guard in place to plan against them and watch for them and assume that they will try to gain access. This prevents a hacker from allowing access to other hackers in a place where they are not authorized to do so. Even though a hacker may not be able to get through a barrier, they still may hack into policy and corrupt policy data to give themselves or another intruder access. Policy is the coded decision-making database that determines whether or not the guard allows access through the security barrier. When access decisions are made, a redundant copy (e.g., ghostly image of policy in security model tab) is employed so that if the guard fails or if the network fails, the exemplary engine can still operate in a degraded mode where someone still has the ability to decide to give a person access to the employed resources.

The “unpredictable” is a category of policies that need to be employed on users that are trying to get access. Unpredictable users are not the same as intruders. Rather they are users that the exemplary system wants to give access to, but for various reasons the exemplary system cannot predict to what resources they will need access. For example, a contractor may be hired to haul debris. They may need temporary access to the resources of the exemplary system to determine the location of the debris and where it needs to go. The exemplary engine can provide access controls to give them access to what they need when they need it, but can also take that access away when they no longer are the contractor and no longer needs the information. In essence, the access they have through the exemplary system can be tightly controlled, but still can be flexible.

These are the types of users who will try to gain access to the exemplary system's domain resources. They need to pass through a security barrier using tokens or certificates of trust, so that the devices on the other side know that they are communicating with the appropriate persons rather than with hackers. The exemplary system can convey an assertion on behalf of one of those users to one of those resources (e.g., which can be shown as three purple cans) using the Security Assertion Markup Language (SAML) (e.g., a widely accepted standard for conveying assertions about the attributes of entities and who they are). At this point in the process, the exemplary system has conveyed that it is the guard, it has authenticated the user, the user can trust the guard, the guard trusts the resource, and therefore, by proxy, the user can trust the resource and give it access. The exemplary system then passes tokens to that user based on that trust and that proxy because the user does have rights to certain resources.

To get through that security barrier, the guard should have a checklist to determine whether the unexpected user's requests will be answered. This checklist is referred to as policy. The policy engine is on the backside of the barrier because it is a very sensitive piece of information; it determines access.

Security Design Patterns: Policy Hierarchy (FIG. 64).

In order for a guard to make decisions, the exemplary system can employ the policy. The people who have decision-making authority in organizations, the information managers, should convey and regulate access between the users and the resources in ways that the computer understands and also in ways that humans can communicate their will to that guard, which is a computer. The exemplary system can employ an algorithm that helps it make those decisions. The algorithm is based on several different items that help to categorize not only the user, but also his or her role. These criteria are optional—allowing any suitable combination of tests to be applied. The sequence listed below conveys the order in which the algorithm is processed, not necessarily a hierarchy of precedence.

Nationality. In policy, the algorithm's first criterion, like the typical first consideration for the military, is nationality. The exemplary system uses the standard ANSI codes, two letter digits for nationality. Nationality is recorded for units as well as users. The exemplary system has enabled the data provider to set policy based on either of these attributes. The problem is: frequently allied users fill billets within friendly organizations as liaison officers and may be granted access to information—based on this assignment. Other sensitive data is restricted—based on the user's nationality, regardless of assignment. The exemplary system is designed to facilitate Multi-Level Security (MLS) environments by correctly identifying these attributes of the user and those that are inherited by assignment.

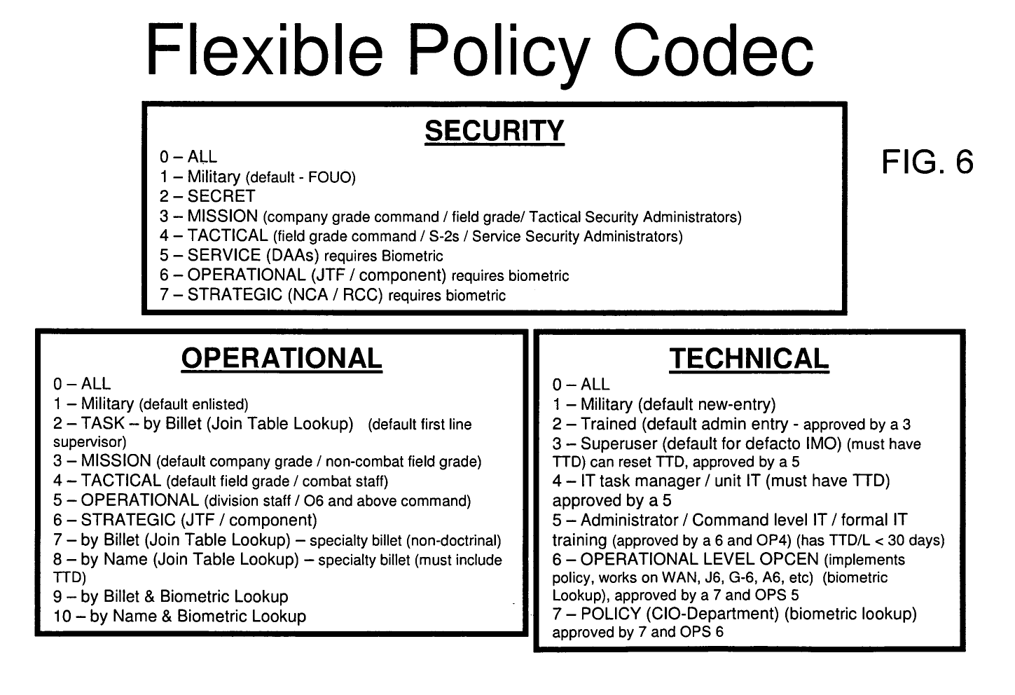

OTS. The second part is a very unique method of characterization. The exemplary system is the only one that has Operational, Technical, and Security (OTS) characterization of a particular billet. Basically OTS describes the will of the person and describes why the exemplary system should allow that person to have access. OTS then assigns numerical terms to those qualities. The following further describes this OTS method. (FIG. 6).

OTS: Operational. The operational category is an authority factor. The exemplary system ranks those factors based on criteria, such as whether a person is task-oriented or a front-line supervisor. Users with these types of factors are given an operational level of two. On the other hand, a person who makes decisions based on information from those front-line supervisors has a value of three. Next, there are the tactical levels; these are for someone who has achieved more than just front-line supervisory capability at the organizational level. As an organization level commander this user should be a minimum of a three. But if there is a parent organization instructing what “child” organizations should do, the staff members of the parent organization would be at level four. At the tactical level they are still part of a larger organization, level four people certainly have level fives above them. A level five may be the top of an organization of 200 or so people with departments under them. A five is the top of an organization that has child units.

Next are the strategic levels, which are the higher operational levels. Operational users can make decisions independently or on the ground. Operational users are not really given boundaries but rather an area within which to operate; they have the freedom to make decisions within a geographical location. Strategic levels, on the other hand, are those responsible for conveying the overall vision for an operation and are typically above the entities that are on the ground. Strategic might be a regional joint task force commander who would probably be at a seven. Then, provided are levels eight, nine, and ten, which allow additional levels of operation. Only a very specific kind of organization might need these levels. Though they are rarely used, these higher levels can allow someone to overtly contain the access to tools based on several qualities by billet or by name. Levels nine and ten can have the added ability to provide authentication advice as well.

OTS: Technical. While a commander may have the authority to give orders and spend money, they may not have the technical authority to turn off the server or perform surgery or fly a helicopter. Technical levels are based much more on a person's level within an occupation when a particular resource needs to be more skill specific. The higher the technical number, the more one controls something into the skill specific.

A level zero is anyone. A zero may or may not be authenticated. A person who is familiar with a skill and has been authenticated can be a level one. Someone with training can be a level two. Level two is the default for most users. The exemplary system assumes that they are trained on the tool. Most users will be a two within their field. In order to certify that someone is trained, that they are a level two, they need to be approved. The approval process is based on someone determining that the person's level of training is sufficient. The person making this determination is a supervisor, with technical level three. This is the typical technical level for an Information Management Officer (IMO). In terms of technical expertise, a super-user is the one person one trusts to administer the tool correctly. A super-user can be considered a level four, which has even more specific items within information management. An IT task manager might be someone that is controlling the network. They are determining who gets access to the routers and the TTD (time to die). In other words, the IT task manager determines the specific limits to access on billets and re-verifies this information periodically.

Though the IT community exists in great numbers today, IMO does not necessarily need to be technically part of the IT community, but rather part of the operational community. Level four definitely applies to this technical specialization. Though an IMO may not have a highly technical specialization, the IMO is still considered a four and someone should verify that the IMO is an expert in their field. An IMO needs to have some sort of certification. The different levels of technical specification help the exemplary system to establish a user's technical capability.

OTS: Security. Security refers to the ability to add users and to prevent fraud and abuse. Security is what provides for an operationally and technically unbiased person to serve as a traffic cop. There different levels here as well. A person with security level one is a person who is authenticated and has signed an acceptable use policy. Level two is an indication that some kind of background investigation has been conducted on the user. In other words, someone has made the assertion that this billet is a trustworthy person and that his position does require a level of trust. A level three is a person who may have sensitive information. This person may be making decisions that are sensitive in terms of the successful outcome of an operation. The person is held in high regard; they are trustworthy. Typically a level three person is not in a decision making role, but has an attribute that requires him to secure information. The person who can administer those background investigations or can determine whether one has been conducted has a security level of four. The exemplary system assumes that a level four has been given the authority to determine if another person is authorized within his or her organization. Though it was previously stated that authority is an operational rather than a security factor, the authority to authorize other users is an indication of a higher level of security as well. With this high security level, the user and consequently the exemplary system can hold data for security purposes and maintain a desired level of secrecy for the organization.

Department. After coding nationality and using OTS, the algorithm's third characterization is the department of the user. For example, in the United States (e.g., a nationality), provided is the Department of Defense (e.g., clearly, a department). The next characterization below that are agencies like the Army. If the Army does not want the Navy, another agency, to have access to certain information, the exemplary system can further define the agencies in such a way that limits access. However, the exemplary system need not preclude the United States Army from allowing, for example, the army of Great Britain to have access. In other words, though the Navy may not have access to certain information, it may be beneficial for the exemplary system to allow the armies of other nations to have access to the same information as the Army. The exemplary engine correctly identifies the will of those people to allow different organizations access into the exemplary system based on nationality, department, and agency.

Military Occupational Specialties (MOS) and Duty Titles. As a particular billet is defined, the exemplary system then defines occupation. An occupation is a broad term, like a doctor, engineer, attorney, or IT professional. Subdivisions of occupations are duty titles. The term Military Occupational Specialty (MOS) is used because the exemplary system uses a modified coding structure from the United States Army's coded structure for defining occupations. For example, within a hospital there are many doctors, but they have different duty titles like pediatricians, surgeons, podiatrists, and others. Even though they are all doctors, their duty titles further define these individuals and allow us to grant and to limit access based on their specific duty titles. Further discussion of coding duty titles follows.

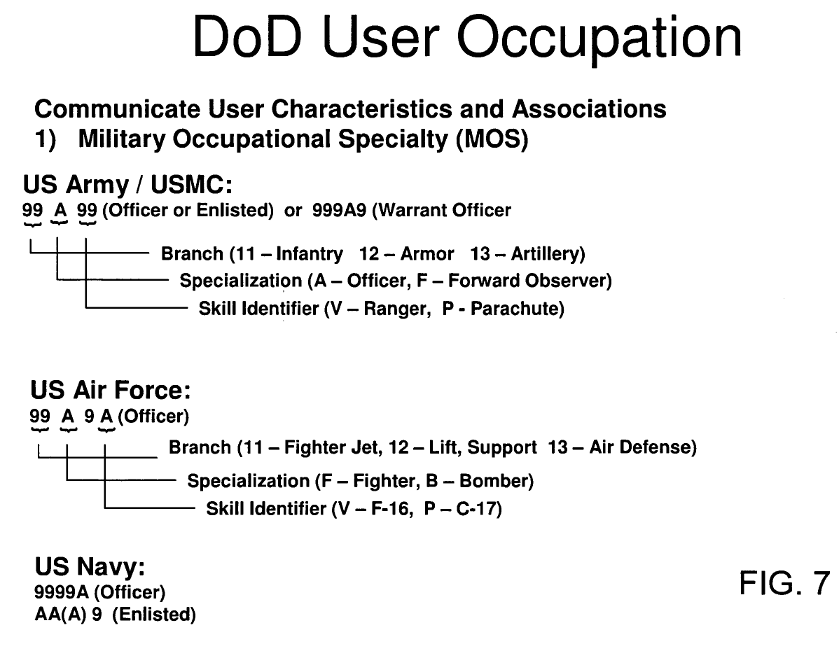

MOS. (FIG. 7). In policy hierarchy, department and agency are straightforward. However, occupation is a bit more complicated. The exemplary system uses two digit numerical representations. Higher numbers are indicative of more administrative, logistical, support-type positions. The lower numbers are representative of positions that are closer to the front lines. In essence, the lower numbers are for more general occupations while the higher numbers are for occupations with a greater degree of specialization. As an example, 25 is the two digit code for IT professionals. However, within those there are further specializations. For example, a 25B might be a server administrator, a 25C might be a network administrator, and a 25D might be an application specialist, an application being an accounting or personnel management system. A mechanic on the other hand can be a 53. Generally, a person who works in the automotive industry can be in this area of numbers. Accounting specialists, doctors, and lawyers might be in the 70s.

However the exemplary system recognizes that there are many coding structures already in place in the world. For example, in the Air Force, fighters are 11, lift support are 12, air defense roles are 15, and command and control would have other numbers. The Navy however is very broad. They have subsurface (e.g., submarine) specialists, special warfare specialists, logistics support, surface warfare, and aviation. The officers of a surface cruiser might all have the same designation, but within their duty code you might find their specializations like propulsion, navigation, or air defense, or whatever the role of the particular ship may be. Admittedly, the existence of these other coding structures can be a source of problems for the exemplary system and causes confusion for both computers and users. However, the exemplary system is the first to attempt to overcome this obstacle. Like Nationality, the policy engine allows data providers to stipulate whether the policy is to be applied to the billet the user is assigned to . . . or the user's occupation as reported in the assertion or by a personnel management system.

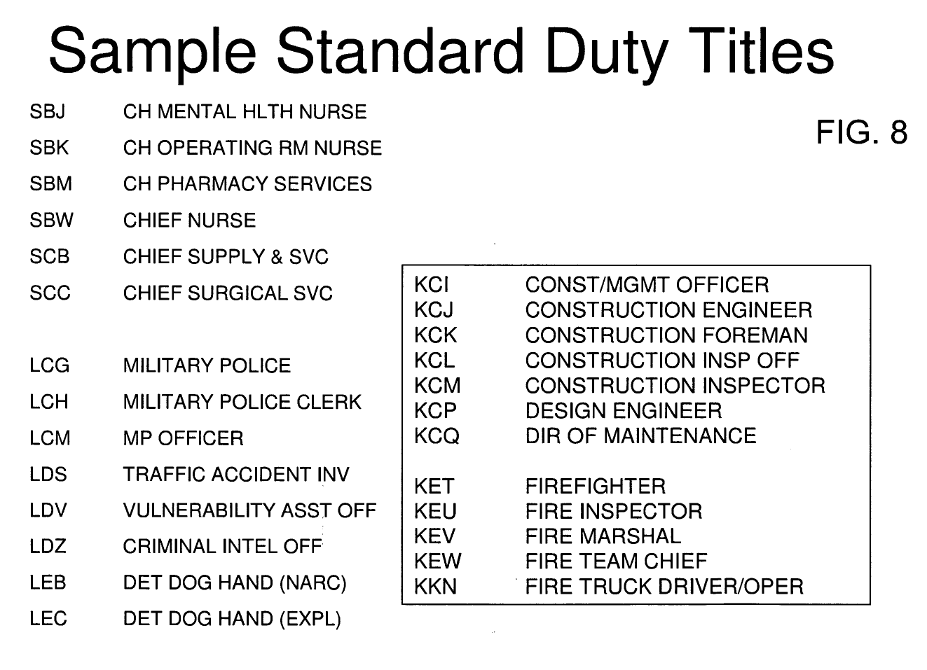

Duty Titles. These are reused from the United States Army as well. The Army has 2600 different duty titles. This may be too broad for the exemplary system to define and employ, so selected are various exemplary duty titles that typically can be employed. For example, AAA is always a commander. That is, AAA is the indicator for the person in charge, whether that person is a mayor, chancellor, director, or president. Each of these positions has the duty code is AAA which conveys to the computer that that position is that of the person in charge. The title can change, but the duty code will remain and always indicate who is in charge. Duty codes allow us to determine the billet. Refer to the Duty Titles Diagram, FIG. 8. An organization like a hospital may be indicated by the duty titles beginning with the letter “S”. If you look at the three letter codes, all the nurses have a “B” as their second letter. So, “SB” is an indication of a nurse in a hospital. Finally, the last letter of their duty tile code indicates their specialty.

This uniqueness and flexibility gives the exemplary system the ability to find duty titles that are so broad. Still referring to the diagram, law enforcement positions have duty title codes beginning with “L”. Thus, the exemplary engine allows the ability to search just on the first character of the 2600 possibilities of duty titles. The duty title codes allow the exemplary engine to make very specific distinctions between users. For example, on the diagram, the dog handlers' codes begin with “LE” and the exemplary system can specify them even further by indicating whether their specialties are narcotics or explosives. The exemplary engine provides a great way to determine and describe the particular roles or billets within an organization.

Rank. Next, the exemplary system defines a person's rank, which is based on their experience, years of service, or expertise. A doctor with four years experience may have a higher rank than another doctor with only one year of experience because they have more knowledge and expertise. However, other occupations, like mayors, For example, may be ranked be based on income. The way the exemplary system has codified rank is based on a level of income and provide are various different delineations, for example, white collar and blue collar, to use generic terms. This distinction is based on whether or not the person has attended post-secondary education. Someone with a four-year degree gets an “O” code based on the military's code for officer. Someone without a degree is considered “enlisted” and given a code of “E.”

Though there are further skill identifiers that are unique to each occupation, these need not be defined within the exemplary system. Using further skill identifiers could entail very specific and detailed definitions that may not be feasible. Thus, decisions need not be made based on skill identifiers within the exemplary engine.

Unit. Finally, policy need not just apply to the user, but also to the organization to which the user belongs. The exemplary system may only want to give a person access based on his affiliation with a particular organization or unit. Within a unit there are different billets or predetermined roles. In a company, one person is in charge and the exemplary system calls him the commander. The exemplary system also assumes that there is an information management officer, that is, a person who assists in making the decisions as to whether or not a person gets access to information that may be included on the network and who can certify the identity of users. These are just example of two of the billets in a given organization; there are many other billets within organizations.

Security Patterns: How the Guard Works

The guard in the exemplary system makes decisions, based on policy and the coding above, about whether or not a requesting entity is allowed access to a given resource. The process is not unique. The algorithm, however, is uniquely related to the database engine. It is based on the concept that there is a policy in effect for both a billet and for the resource. The guard looks at the checklist and determines if the requesting entity meets the criteria to allow the entity to pass through. The exemplary algorithm and engine compare the items in the Billet Policy Table to the items in the Tool Policy Table. Here are two examples of how this comparison might work. If a user of any nation could use a particular tool, then the field for “Nation” in Tool Policy Table can be blank. This blank would indicate that there is no requirement of nationality for a user to have access to that tool. If the tool only allows users with training to use the tool, then the field for “Technical” in the Tool Policy Table can have a value of two. This too can indicate that only users with this technical level can have access to that tool. Now, suppose a customer whose billet is codified with a similar codec to ours and who is authenticated makes a request. As the requester comes in to get the tool, the guard checks the credentials of the user, both his billet and personal attributes, and compares them to the policy on the tool to which the customer wants access. If those are satisfied, if they match up, then the person is allowed access to the tool.

In broad terms, this process is very straightforward in how it is administered, but the exemplary engine is unique in that it can go through multiple levels of policy and then make an additional determination to enhance flexibility and use the tool more effectively. This flexibility is provided in several ways. First, the exemplary engine can determine, based on a list of trusted resources, that a particular tool can only be accessed from a certain range of internet addresses. In other words, the exemplary engine gives provisions that a certain location, such as an internet café, may not be secure enough for using the tool. Second, the exemplary engine can also restrict access in such a way that allows the people who need a resource the most to have the best access to it. If a tool is a heavily used resource, the exemplary engine can give the people who use the tool to make life or death decisions the best access to it. Determining who these people are is based on data included in the database schema. Thus, the exemplary system throttles or controls who gets access not based only on policy but also on the current condition of that tool. Finally, the location of the user may be aided to provide that throttling or provisioning or control so that there is a quality of service factor to those users currently using the tool. This is very unique and is something that other policy engines are not able to administer. As the guard, the exemplary engine makes decisions about access to the network not only based on authentication through the use of passwords and keys, but also on the basis of the conditions and advice of the network and on the location of the users.

Security Patterns: Authentication Advice

One thing that is unique to the exemplary SAML message is the authentication device. This device involves unique methods of authentication as well as network quality advice. Refer to FIG. 10 for a description of the methods of authentication, numbered 0 through 9. For Method 0, there is no authentication; there is no password; there is no way of knowing that a person is who they say they are. Then, one can start becoming more and more specific. Method 1 employs a weak password or a pin number. Weak indicates that the password need not employ capital and lowercase characters or punctuation marks. A weak password may even be a word like, for example, the user's mother's maiden name. Method 2 employs a strong password. Method 3 of authentication, referred to as primary, employs a strong password that has been confirmed through e-mail. That is, the user's identity has been confirmed with a domain controller. Method 4 employs an electronic key, such as a magnetic card or a device with a key on board. Method 5 is better because it not only employs a key, but also a pin and/or a password. Method 6 employs a changing PIN in combination with the key. This means that every time authentication is required the user has to change the password or PIN. This requirement is based on time or a predetermined series of codes. Method 7 employs biometric data, that is, a thumbprint, voice recognition, or a retina scan. Method 8 employs a combination of biometric information with a PIN or a password or a combination of the three. Finally, method 9 employs biometric information, with a key and with a PIN or password.

The next portion of authentication, refer to FIG. 10 again, is the network quality advice based on the location from which the person is trying to gain access, that is, the advice is based on a description of the user's network. Number 13 is the weakest, least secure location. For example, the person is logging in from a Starbucks, an open wireless network (e.g., Wi-Fi) hotspot. The exemplary system need not know who the person is; they may be an untrained contractor and anyone may be looking over their shoulder. That is, they may be a non-agent, which indicates that they are not necessarily trained on how to secure their information. There is no Wired Equivalent Privacy (WEP); that is there is no protection or security on this Wi-Fi. A Number 12 location is identical to Number 13 except that the hotspot does provide a level of security and controlled visibility. Number 11 does have public visibility, but there is a physical layer of security. The user is at least inside of a building that has some amount of controlled access. The person is logging in from a known location, but there is no encryption on the wireless network; there is no WEP. One example might be the media or the Red Cross logging in from their location. There are two Number 11 locations; both provide a single physical layer of security. There is no guard in either, but users do have to enter a physical building. Visibility is controlled in that it is not visible to the public. However, the wireless is open so a hotel room is a good example of a lack of web encryption. A Number 10 location has controlled visibility, no physical security, and has WEP. An example of a Number 10 location can be a user in a Starbucks who is an agent; they are trained in how to secure information and adhere to public security protocol. In this example, the agent may be sitting against a wall and protecting visibility by not allowing others to see his screen. More specifically, encrypted data, such as wireless wall, has point to point encryption of the data stream. They are using software encrypted from their laptop all the way back to where they are trying to get through. Number 9 locations are like Number 11 locations in that they have a single layer of physical security and no guard. However, Number 9 locations do, in fact, have WEP wireless. With a Number 8 location, there is very controlled visibility. It is a building with no windows. There is multi-layered physical security; that is, the parking lot may be secured; there is a guard in the vestibule; any access to the network is tightly controlled through WEP. A tactical operations center (TOC) on an incident site is a good example of Number 8, because one has a guard providing physical security. A Number 7 is identical to a Number 8 except there is no guard, but there is an additional layer of physical security, like being locked in a room and there is no WEP. Number 6 is essentially the same as a Number 7 location. A Number 5 location is the same as Number 8, but is wired rather than wireless. Number 5 is the last non-tempest location. A tempest is a magnetically shielded building meaning that there is no way of even being able to pick up any stray radio signals. Locations 4 to 0 are tempest locations with increasingly tight security. Number 4 has no windows, a single layer of physical security, and no guard. Number 3 has no windows, multiple layers of physical security, and a guard. Number 2 is a secret location, with no windows and multiple layers of physical security. Number 1 is mission impossible. Number 0 is unknown.

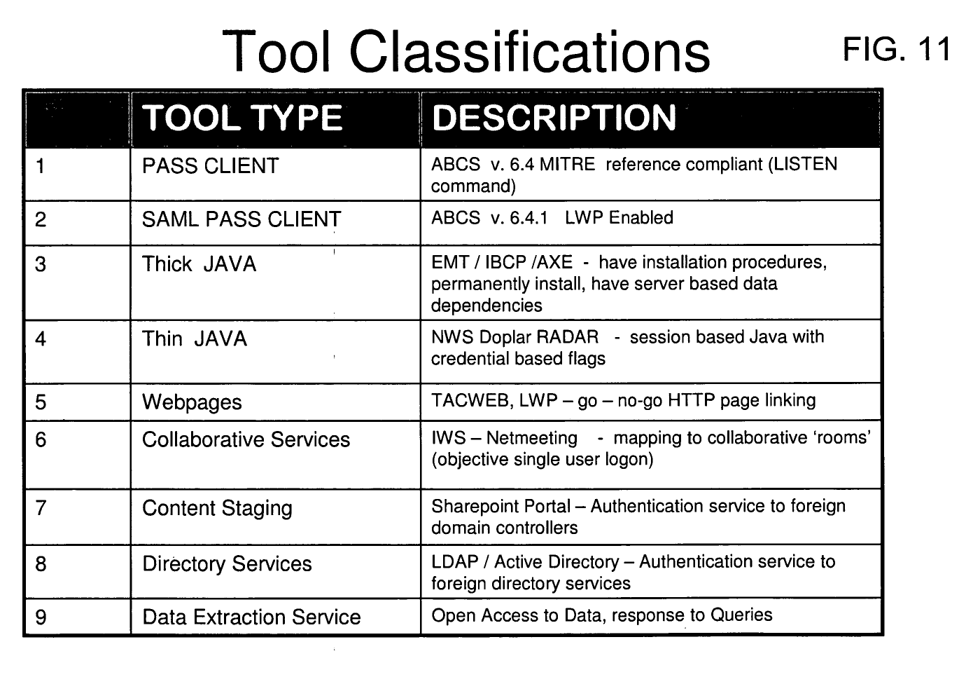

Security Patterns: Tool Types and Information Pages (FIG. 11).

This section describes the tools and their classifications. The first classification is the pass client which means that this particular tool is going to get into the actionable data, into a data stream. There is not too much restriction on this type of tool. This can be called a Number 1 type tool. Number 2 type tools are SAML aware or LandWAR portal or SPASAM conversant. Number 3 tools are Thick JAVA tools which imply that they are applications, they reside on the client, they can be downloaded but they do need to be installed. Number 4 tools on the other hand are Thin JAVA which runs in java run-time environment. Java run-time environment needs to be installed but it need only run for each session. In other words, once the computer is shut off, a Number 4 tool goes away, but a Number 3 tool does not. Number 5 tools are just web pages, whether protected or not. They can have active content, but it can be assumed there is nothing really to install on that web page. Number 6 tools are the Community of Interest chat rooms just described. A Number 7 tool, content staging, is an LDAP controlled resource. It includes folders which hold categories of various types of content. The Number 8 tool type, directory services, is very similar, but is LDAP driven. Content staging could be more of a model similar to the downloading of ring tones done in the music industry. There are protected folders and resources, but building user accounts is not necessary. Rather, access and retrieving content is based on the use of a key with a limited life-span, an expiration date. A Number 9 tool, a data extraction service, is going to respond to a web service. Users can send the tool a request and the tool can answer a question for them. These different tool categories help to define and locate different resources within the exemplary system.

The SPASAM Data Elements refer to how the exemplary system administers policy through different types of pages. The exemplary system categorizes the information so that it knows what page holds what types of data. This provides an additional layer of security (FIG. 9).

People content pages. Those that will change the attributes of a person or their billet. One is sensitive to the notion that only these types of pages, as they are signed, are given access to change the values within the tables or database that relate to the billet or person.

Infrastructure pages. Only IT professionals have access to them. Hold information that is going to change the way the transport mechanisms or servers are configured.

Tool management pages. Similar to IT infrastructure, but these pages are solely on configuration or specialization of how a tool is accessed. Hold information more about how tools are used rather than tool security.

User preferences pages. Can be accessed by just about anyone. Hold users' own preferences about whether they want to get e-mail, how they want alerts delivered, etc.

User navigation/display. Holds information about the look and feel of the pages.

Permission changes. Holds modifications of the policy itself.

Assignment changes. Relates to the billets. Has information about how people are moved in and out of a billet or how to make a person operationally controlled by another unit.

COI content pages. Hold information dealing with the chat rooms and this particular domain.

Alerts content pages. House information about how alerts are displayed and who they are going to.

Tools content pages. Show information about the content of the tools rather than information about the management of those tools. This is particularly detailed for those tools being housed on SPASAM servers.

Username/password pages. Hold very sensitive information on how passwords get changed or administered.

SQL statements. Queries that are going to respond to the types of tools like Number 9 tools.

Location (e.g., lat/long) pages. Store information from any suitable source that might have information about where a particular resource unit or person is.

‘Whois’ pages. Hold personal information and things that are going to perform queries and display information about other users.

Password/Biometric/Card. Information about the administration of these items and authentication that goes with their use.

Automated routine pages. Hold information regarding the initiation of an agent or starting a routine. This kind of page is constantly looking at changing data and making decisions and can start another portion of a routine based on the data that it finds.

The importance of these categories pages is that they help to satisfy security requirements. One is wary of anything that is touching any of these policy type tables, because these are the more sensitive areas that a hacker or intruder would want to gain access to. So in describing these pages, provided is an indication of why one would want that data to be changed.

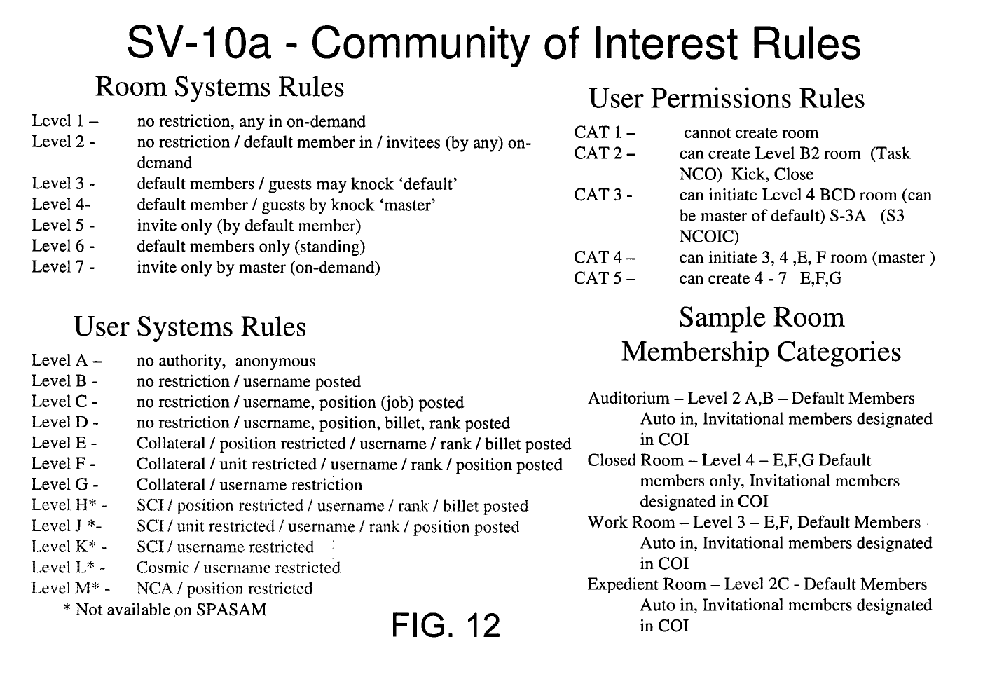

Security Patterns: COI Rules (FIG. 12).

The next section provides a description of a specific tool, the Community of Interest (COI), which are essentially chat rooms. Please refer to FIG. 12. There are four different categories of chat rooms: Typical IRC Open Chat Room, Doctrinal, Mission, and Ad Hoc/Mission. Typical rooms are like public auditoriums where anyone has access. Doctrinal rooms for example are rooms that exist for any suitable client. They are rooms that have existed on the server from the start and have been enabled by SPASAM. One knows that doctors need to chat with doctors and mayors with mayors and so chat rooms for these types of communication are doctrinal. A mission, however, typically may last several months, but has a finite end. At the end of the mission, the mission chat room is no longer needed. A mission chat room is created by SPASAM with usernames. This gives a lot of flexibility and helps describe the purpose for this particular tool, this chat room. An ad-hoc chat room, which may be a subtask of a mission, is quickly created to solve a particular problem. SPASAM creates accounts for the room, which is restricted. Once solved, the room can go away. As an example, this type of room is one that cannot be planned because one cannot predict all the circumstances under which all the various users will need to communicate. However, the ad-hoc chat room allows the exemplary engine to give users in a mission the ability to handle small situations within the mission very quickly. For example, a mission may be hurricane relief efforts. An ad-hoc chat room may be created to facilitate the delivery of ice to the people who need it. So the exemplary system has the ability to establish a chat room for the people who need access and then invite them to the chat room. Once the people who need ice get it, the chat room can be removed.

Clearly, one should further categorize the users in those chat rooms. A Category 1 user is a basic level person. They cannot create a room; they are essentially a “guest user”. Category 2 users are basically “registered users” who are allowed to create ad-hoc rooms, described as a B2, which means there is no restriction; however, usernames are posted. This allows for flexibility. A Category 2 person can make this type of room.

A Category 3 user can initiate a mission type of a room and is considered a “normal user”. This requires a higher-level user because such a room may need a little more organization. In the hurricane example, there may be a citywide area that may be affected by the hurricane and relief to that area would be its own mission. These are user-permission rooms. The room systems rules are based on levels 1 through 7 and user systems rules are levels A through M.

Level A is the lowest level of user rules. In this level, the users have no authority; they may be anonymous. This Level may apply to a room that is like a general public auditorium. Anyone can have access to the room and the information presented there is not sensitive, but the user may just be in the room to get a sense of what information may be available to him. Level B user rules also have no restrictions on who is allowed access. However, usernames are posted so that the users know who is communicating. Level C rules require postings of user names and positions (e.g., jobs). In addition to Level C requirements, Level D rooms also post the ranks and billets of users. Level E has all the requirements of Level D, but also begins to require levels of security. In Level E, users should have at least Security Level 2, which means there has been a background investigation on them. Level E has position restrictions, but username, rank, and billet are posted. Level F, additionally, has unit restrictions and Level G has username restrictions. Though the rooms are restricted, the exemplary system can still apply different qualities about that room based on who has access: This is where the different levels of room rules become advantageous, as described below.

The room rules describe how the room is going to be populated. Level 1 is the least restrictive room anyone can get in and enter of his own will. In Level 2 rooms, default members are included and they can invite others at any suitable time and these invitees are allowed in on demand. Level 3 rooms have default members, guests may request entrance to the room, and it is a searchable COI. Guests can ask the room master/moderator for access and do not need to be invited, but anyone in the room can let them in. The difference for Level 4 rooms is that only the moderator can let in a guest who wants access. Level 5 rooms have members by invitation only. So they are private rooms and are not advertised. However, default members can invite someone else. Thus there is some sort of token, password, or pin that indicates that they guests have been invited. Level 6 rooms have default members only; that is, these members are not allowed to invite others in. It is very restrictive and only default members have access. Finally, Level 7 rooms are invitation only. Only the master can invite users into the room.

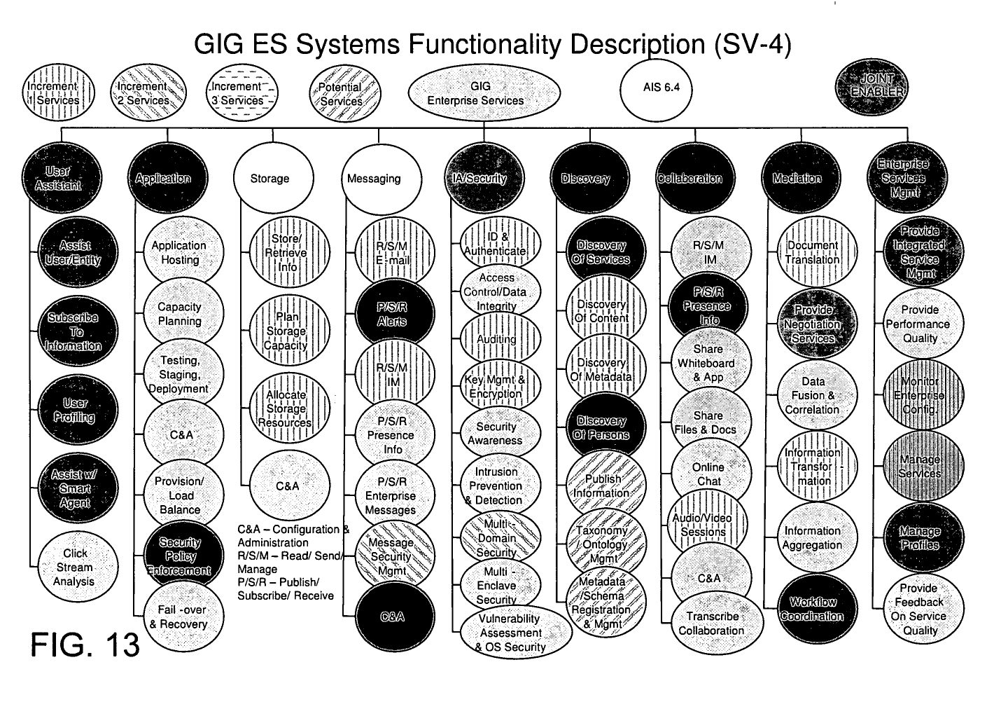

### System: GIG Enterprise (FIG. 13).

The following explains the Global Information Grid (GIG) and Enterprise Services (ES) Systems Functionality Description or the Systems View 4 (SV-4) as described by the Department of Defense. The Enterprise Services (e.g., there are nine listed), are those that are particularly being addressed.

Information assurance and security. The exemplary system provides an absolute access control to all the suitable information resources. It provides a log of where every user goes. This is part of the exemplary audit capability. The exemplary system participates in key management and encryption, but need not be an area of focus. Rather, the exemplary system participates in other people's prescriptions of key management and encryption. The exemplary intrusion prevention and detection is done based on authentication that is being done throughout the network.

Enterprise services management. This allows Information Management Officers and IT personnel to work together to provide integrated service management and to monitor the enterprise and manage the tools and their access. It is the enterprise configuration that allows them to monitor and manage those services. Enterprise configuration can be shown in yellow because it employs compliance. Enterprise configuration can be done using XACML (Extensible Access Mark-up Language). To manage services, the exemplary system can make assertions about a user using SAML (Security Assertion Mark-up Language). The exemplary system can be compliant and participate in the enterprise as the middleman. Thus, it manages the profiles or billets and manages how the user is joined to those billets.

User assistant. The exemplary system is involved in almost every aspect of user assistance. It assists the user by providing a sort of tailored dashboard of where the user wants to enter. The exemplary system can help them subscribe their applications to those data streams or information that they want to have access to. It has an extensive user profiling capability. Based on their billet, the exemplary coding structure is an excellent way to describe each billet and the user based on their profile. The exemplary system also assists with the smart agent. The smart agent is a routine running in the background which is either subscribing someone to information based on their location or other attributes. The exemplary system can provide assistance with the routine by taking the human out of the loop and allowing a routine, a smart agent, to make the decisions. The exemplary system has the capability to provide a click stream analysis. It knows where users are going and can track what pages a user views to gather data.

Application and security policy enforcement. The exemplary system serves as the decision point. The exemplary guard function can deny further access to a user. It can decide not to subscribe a person to data, not to make an assertion, and not to even reveal where the protected resources are on the network. This is an exemplary way that the exemplary system enforces policy. The exemplary system also does some provisioning or load balancing based on the ability to throttle.

Storage. The exemplary system need not be involved in the storage of information. The intent need not be to store data, but rather to point to and provide a registry of where data might be stored. This registry is either in the form of a content staging portal, where individual content is not registered or as in the ring tone example where each data item is listed as a tool.

Messaging. On the other hand, the exemplary system is involved in alerts. There is a web-based alert system where a red button indicates the presence of an alert. The alert system also operates in the public Internet by sending alerts through e-mail. This is how the short text messaging service (e.g., SMS) works. The exemplary system re-uses other relevant art, such as email, SMS messaging, and CAP alerting systems. However, the exemplary system does have an extensive amount of tools for the configuration and administration of those alerts.

Discovery. Through discovery, the exemplary system allows users to register those tools or services that they need. Then users can perform searches for tools or registered services that are out there. However, the exemplary system need not serve as a spider or a bot that crawls through the network or enterprise looking for additional services. The exemplary system also allows registered users to search for other registered users or billets within the enterprise. Again, the intent is not to crawl through other LDAPs. Rather these billets can be searched because they are in the form of a registry.

Collaboration. The intent is not to provide the chat rooms. Although, TTG has its own specific version of a chat room. The exemplary system publishes chat rooms and subscribes users to chat rooms. The exemplary system also allows users the ability to create their own chat rooms and establish the presence information. In other words, a user can determine the existence of a chat room and can determine which users populate that chat room.

Mediation. The SPASAM engine is the intermediary that allows for the federation of two separate domains; it provides the negotiation services. This is done primarily through SAML, which makes the assertions based on the trust that comes in the form of contracts and business rules that someone else has established. Workflow coordination is achieved mostly through the exemplary alert system. The exemplary system attempts to establish a request so that there can be delegated administration of both the users' profiles and their access to resources.

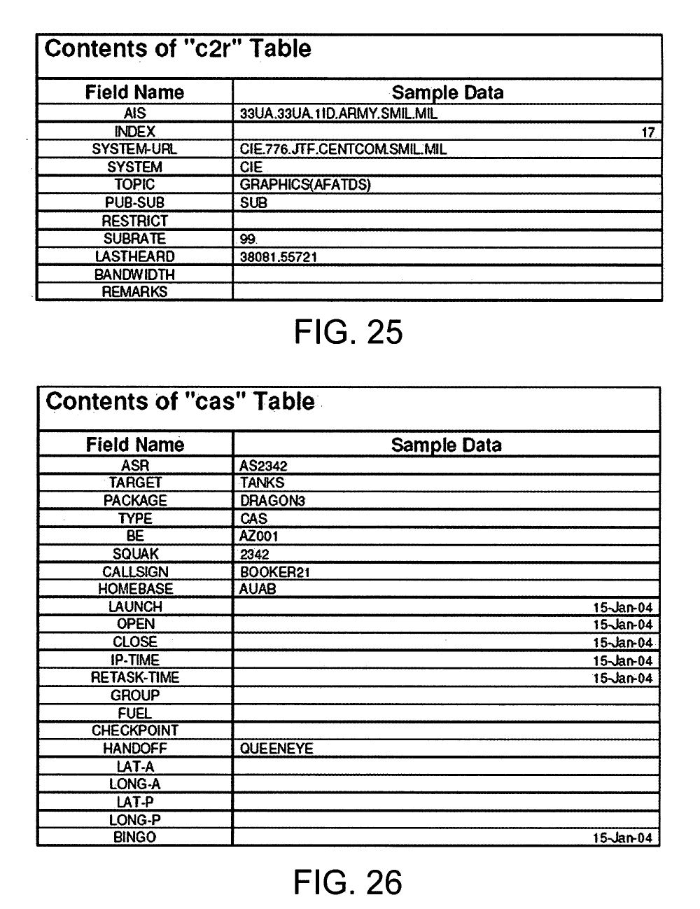

FIG. 25 illustrates an exemplary table of the contents of the “c2r” table, according to the exemplary embodiments of the present invention. To adapt the J-SPASAM engine's federated identity capability into architectures that include applicable technologies, adaptations can occasionally be incorporated to accomplish this integration. FIG. 25 is a representative table that allow for the import of data from traditional architectures. This table is case specific to a particular architecture and the applications that need to be integrated (e.g., in this case, U.S. Army address book data tables).

FIG. 26 illustrates an exemplary table of the contents of the “cas” table, according to the exemplary embodiments of the present invention. FIG. 26 is representative of a table that stores data imported from outside data providers. The CAS table is then used to populate a representative web-based tool that collects data from various sources (e.g., each based on the credentials of the user/billet) and presents them in a way specific to the needs at that particular instant.

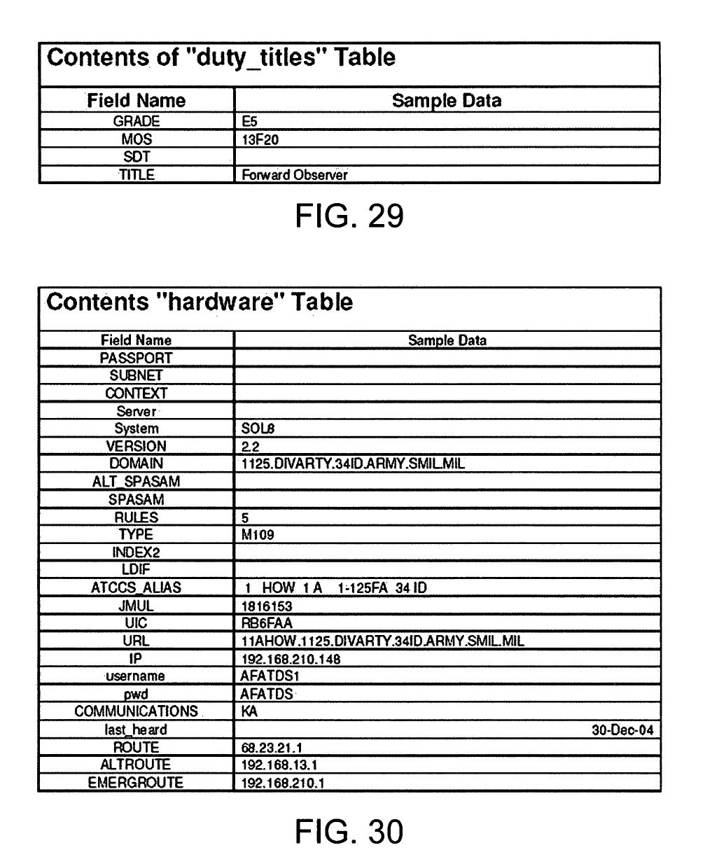

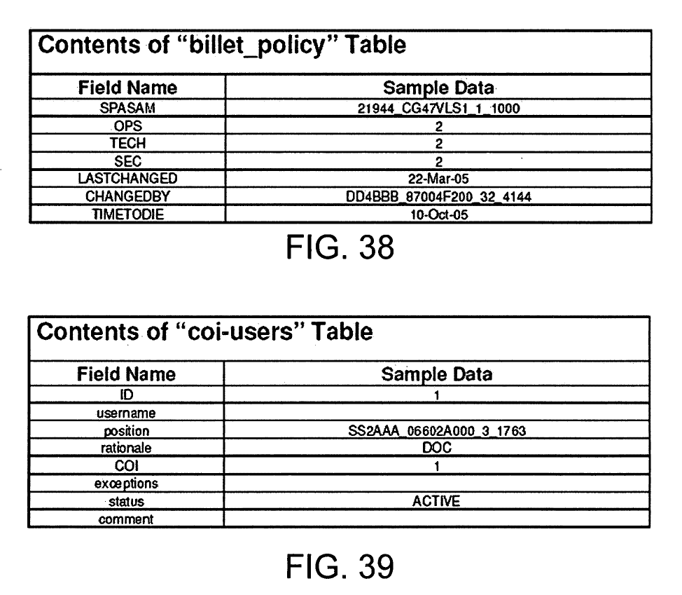

In further exemplary embodiments, FIG. 28 illustrates an exemplary table of the contents of the “department” table. FIG. 29 illustrates an exemplary table of the contents of the “duty_titles” table. FIG. 30 illustrates an exemplary table of the contents of the “hardware” table. FIG. 31 illustrates an exemplary table of the contents of the “my_groups” table. FIG. 32 illustrates an exemplary table of the contents of the “my_subscriptions” table. FIG. 33 illustrates an exemplary table of the contents of the “groups” table. FIG. 34 illustrates an exemplary table of the contents of the “group_list” table. FIG. 35 illustrates an exemplary table of the contents of the “group_type” table. FIG. 38 illustrates an exemplary table of the contents of the “billet-policy” table. FIG. 49 illustrates an exemplary table of the contents of the “billet_subscriptions” table.

The above-described devices and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

The following terms are defined in the context of the present invention:

Assertion—statements in which one confirms the attributes of a particular user, establish what is known about the user, and state that the assertions are valid for the next period of time.

Authentication—the process by which a computer, computer program, or another user attempts to confirm that the computer, computer program, or user from whom the second party has received some communication is, or is not, the claimed first party.

Box—user's device; e.g., a computer.

Certificate—digital registration; proof of authentication.

COI—Community of Interest; e.g., a chat room.

Entity—anything on the network; e.g., a human user, a computer, a tool or resource.

Federation—the joining of separate entities that can stand on their own individually; the consolidation of local identities into a single (or at least reduced) Federated Identity.

IMO—Information Management Officers—different from an Information Technology (IT) specialist in that they have more of a managerial/operational role; they manage the infrastructure in which the IT community works. In essence, IMO's decide which people should have which access, while IT professionals make that access technically possible.

LDAP—Lightweight Directory Access Protocol—the way all computer systems today store their users and put them into groups to determine the provision of resources; an Internet protocol that email and other programs use to look up information from a server.

PKI—Public Key Infrastructure—enable users to be authenticated to each other, and to use the information in identity certificates to encrypt and decrypt messages traveling to and fro. In general, a PKI includes client software, server software such as a certificate authority, hardware (e.g., smart cards) and operational procedures. A user may digitally sign messages using his private key, and another user can check that signature (using the public key included in that user's certificate issued by a certificate authority within the PKI). This enables two (or more) communicating parties to establish confidentiality, message integrity and user authentication without having to exchange any secret information in advance.

Policy—a set of codified “rules” that says what users and resources have access to what.

Resources—tools; applications and services.

SAML—Security Assertion Markup Language—an XML-based framework for exchanging security information. This security information is expressed in the form of assertions about subjects, where a subject is an entity (either human or computer) that has an identity in some security domain.

SOAP—Simple Object Access Protocol—a lightweight protocol for exchange of information in a decentralized, distributed environment. It is an XML based protocol that includes three parts: an envelope that defines a framework for describing what is in a message and how to process it, a set of encoding rules for expressing instances of application-defined datatypes, and a convention for representing remote procedure calls and responses.

Throttling—the controlling of access; provisioning.

Trust—the basis of forming a federation; established through a business relationship, legal contracts, key management, and assertions.

XACML—Extensible Access Control Markup Language—enables the use of arbitrary attributes in policies, role-based access control, security labels, time/date-based policies, indexable policies, ‘deny’ policies, and dynamic policies—all without requiring changes to the applications that use XACML.

XML—Extensible Markup Language—an extremely simple dialect or ‘subset’ of Standard Generalized Markup Language (SGML) the goal of which is to enable generic SGML to be served, received, and processed on the Web in the way that is now possible with HTML for which reason XML has been designed for ease of implementation, and for interoperability with both SGML and HTML.

While the present inventions have been described in connection with a number of exemplary embodiments, and implementations, the present inventions are not so limited, but rather cover various modifications, and equivalent arrangements, which fall within the purview of prospective claims.

What is claimed is:

1. A system for enterprise network access control and management for Government and Corporate entities, the system comprising at least one of:
means for interagency identity management, including least one of:
means for providing attributes definition, including least one of means for providing occupation parameters, means for providing translation between agencies, including least one of Army, Navy, USAF, USCG, and Department of Labor agencies, means for providing duty positions including least one of standard duty title code translation for allowing duty titles to be codified and/or translated, and means for providing nationality, seniority, location, and associations, including least one of department, agency, unit, and billet parameters,
means for providing policy enforcement of IIME attributes, including on the fly policy enforcement, and
means for providing a resource map, including recognition of relations and flexibly managing the relations on an enterprise scale;
means for providing connectors and controls, including least one of:
means for providing interagency management control, including least one of batches means, corporate history recorder means, and corporate learning means,
means for providing a track injector, including from military location providers association of tracks with units versus “Tillman”,
a subscription by proxy means,
a publish by proxy means, and
an enterprise configuration by proxy means;
means for providing an interagency directory services transformation service;
means for providing a user/duty position resolving service;
means for providing role-based encryption key management;
means for providing role-based business process modeling; and
means for providing proximity-based access control enabled by user-role-track association.

2. A method corresponding to one or more of the means of the system of claim 1.

3. A computer program product corresponding to one or more of the means of the system of claim 1.
